(19) United States
(12) Patent Application Publication
(10) Pub. No.: US 2009/0066887 A1
(43) Pub. Date: Mar. 12, 2009

(54) Polymer Film, Polarizing Plate Protective Film, Polarizing Plate and Liquid Crystal Display Device

(75) Inventors: Nobutaka Fukagawa, Kanagawa (JP); Eiichiro Aminaka, Kanagawa (JP); Hajime Nakayama, Kanagawa (JP); Hirofumi Toyama, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/282,531

(22) PCT Filed: Mar. 29, 2007
(86) PCT No.: PCT/JP2007/057605

§ 371 Date: Sep. 11, 2008

(30) Foreign Application Priority Data
Mar. 29, 2006 (JP) 2006-092082
Dec. 19, 2006 (JP) 2006-341723

(51) Int. Cl. G02F 1/1335; G02B 1/08

(52) U.S. Cl. 349/96; 359/500

(57) ABSTRACT

A polymer film satisfying the following formulae (1) to (3):

20 nm≦Rth(548)<100 nm (1)

1.0<Rth(446)/Rth(548)<4.0 (2)

0.5<Rth(628)/Rth(548)<1.0 (3)

wherein Rth(λ) represents the value of Rth that is measured at a wavelength of λ nm.

### FIELD OF THE INVENTION

The present invention relates to a liquid crystal display device, and, in particular, to VA mode liquid crystal display devices excellent in the viewing angle property and a polymer film etc. for use in the display device.

### BACKGROUND ART

Liquid crystal display devices increase the application thereof year by year as an electric power saving and space saving image display device. Heretofore, liquid crystal display devices have such large defect as large viewing angle dependency of images. However, in these years, a wide viewing angle liquid crystal mode is in practical use to lead to a rush for liquid crystal display devices also in such a market as televisions for which high grade images are demanded.

VA mode liquid crystal display devices have such benefit as high contrast, in general, as compared with devices having other liquid crystal display modes, but there is such problem that the change of contrast and hue is large depending on the viewing angle.

In order to solve the problem, there are proposed optical compensatory films having various optical properties and methods for combining these. For example, JP-A-2003-294944 discloses such a method as disposing two biaxial films on both sides of a liquid crystal cell. Further, JP-A-2003-344856 discloses such a method as disposing a biaxial film having large retardation on only one side of a liquid crystal cell.

However, although these methods exerts a certain degree of improvement effect, the contrast and hue change depending on the viewing angle are still large. Thus, further improvement is desired.

### SUMMARY OF THE INVENTION

The present invention aims to provide a polymer film and the like capable of providing liquid crystal display devices that have low viewing angle dependency of hue.

As the result of hard works, the present inventors found that the hue change of liquid crystal display devices depending on the viewing angle can be reduced significantly by using a polarizing plate protective film having such undermentioned property that Rth thereof is greater at a shorter wavelength (hereinafter, occasionally referred to as “forward wavelength dispersion property”), to complete the invention.

That is, the above-described problem was solved by the following means.

(1) A polymer film having Rth that satisfies the following formulae (1) to (3):

20 nm≦Rth(548)<100 nm (1)

1.0<Rth(446)/Rth(548)<4.0 (2)

0.5<Rth(628)/Rth(548)<1.0 (3)

wherein Rth(λ) represents the value of Rth that is measured at a wavelength of λ nm.
(2) The polymer film as described in item (1), comprising mainly cellulose acylate.
(3) The polymer film as described in item (1) or (2), comprising a wavelength dispersion-controlling agent having the absorption maximum within a wavelength range of 250 nm to 400 nm in 1% by mass to 30% by mass.
(4) The polymer film as described in any one of items (1) to (3), comprising at least one compound represented by the following formula (B):

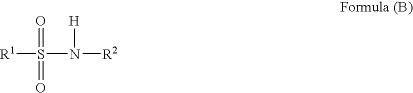

wherein R¹ and R² each independently represents an alkyl group or an aryl group.
(5) The polymer film as described in any one of items (1) to (4), comprising mainly cellulose acylate having an acetyl substitution degree of 2.90 to 3.00.
(6) The polymer film as described in any one of items (1) to (4), comprising mainly mixed aliphatic acid ester having a total acyl substitution degree of 2.70 to 3.00.
(7) A polarizing plate protective film comprising the polymer film as described in any one of items (1) to (6).
(8) A polarizing plate comprising a polarizer and a protective film that is disposed on at least one side of the polarizer, wherein the protective film is the polarizing plate protective film as described in item (7).
(9) A liquid crystal display device comprising a liquid crystal cell and the polarizing plate as described in (8).
(10) A liquid crystal display device comprising a liquid crystal cell, two polarizing plates that are disposed on both sides of the liquid crystal cell and an optical compensatory film that is interposed at least one of the interfaces between the polarizing plate and the liquid crystal cell, wherein:

the polarizing plate is composed of a polarizer and two protective films that are disposed on both sides thereof; at least one of the protective films lying on the nearer side to the liquid crystal cell is the protective film as described in any one of items (1) to (6); and the optical compensatory film satisfies the following formulae (4) and (5):

20 nm≦Re(548)≦150 nm (4)

100 nm≦Rth(548)≦400 nm (5)

(11) The liquid crystal display device as described in item (10), wherein the optical compensatory film that satisfies the above formulae (4) and (5) satisfies the following formulae (6) and (7):

0.5<Re(446)/Re(548)<1.0 (6)

1.0<Re(628)/Re(548)<2.0 (7)

(12) The liquid crystal display device as described in item (10) or (11), wherein the optical compensatory film that satisfies above formulae (4) and (5) comprises at least one of cellulose acylate-based resin, polycarbonate-based resin, polyimide-based resin, polyether ketone-based resin, polycycloolefin-based resin and polyvinyl acetal-based resin.
(13) The liquid crystal display device as described in any one of items (9) to (12), wherein the liquid crystal cell is of the VA mode.

According to the invention, it is possible to provide liquid crystal display devices having low viewing angle dependency of hue.

### BRIEF DESCRIPTION OF THE DRAWING

FIG. 1 is an outline view that shows an example of the liquid crystal display device of the present invention. 1 is the upper polarizing plate, 2 is the direction of the absorption axis of the tipper polarizing plate, 5 is the upper electrode substrate of the liquid crystal cell, 6 is the alignment control direction of the upper substrate, 7 is the liquid crystal layer, 8 is the lower electrode substrate of the liquid crystal cell, 9 is the alignment control direction of the lower substrate, 10 is the liquid crystal display device, 12 is the lower polarizing plate, and 13 is the direction of the absorption axis of the lower polarizing plate.

### DETAILED DESCRIPTION OF THE INVENTION

Hereinafter, the content of the present invention is described in detail. Incidentally, “n¹ to n²” herein is used in the sense of including numerals n¹ and n² as the lower limit and the upper limit, respectively.

The polymer film of the invention has such Rth at the wavelength of 548 nm that lies within a specified range, and forward wavelength dispersion property. Firstly, the polymer film of the invention is described in detail.

### <<Polymer Film>>

### [Retardation of Film]

The polymer film of the invention satisfies the following formulae (1) to (3).

20 nm≦Rth(548)<100 nm (1)

1.0<Rth(446)/Rth(548)<4.0 (2)

0.5<Rth(628)/Rth(548)<1.0 (3)

In the formula (1), Rth(548) is preferably 25 nm to 100 nm, more preferably 30 nm to 100 nm.

In the formula (2), Rth(446)/Rth(548) is preferably 1.1 to 3.0, more preferably 1.2 to 2.0.

In the formula (3), Rth(628)/Rth(548) is preferably form 0.7 to 0.98, more preferably 0.8 to 0.95.

Re(λ) and Rth(λ) represent, herein, the retardation in the plane and the retardation in the thickness direction, respectively, at a wavelength of λ. Re(λ) is measured with KOBRA 21ADH or WR (by Oji Scientific Instruments) while allowing light having the wavelength of λ nm to enter in the normal direction of a film.

In case where the film to be measured is a film that is represented by a uniaxial or biaxial indicatrix, Rth(λ) is computed by the following method.

That is, respective Re(λ)s are measured at total six points in the normal direction of the film relative to the film surface and in directions inclined every 100 up to 50° on one side from the normal line around an in-plane slow axis (determined by KOBURA 21AD or WR) as an inclination axis (rotation axis) (in case where no slow axis exists, any direction in the plane of the film is defined as a rotation axis) for an incoming light of a wavelength of λ nm, and KOBRA 21ADH or WR computes the Rth(λ) on the basis of the measured retardation, an assumed value of an average refraction index and an input thickness.

In the above instance, in case where a film has a direction in which the retardation becomes zero at a certain inclination angle from the normal line relative to the film surface around the in-plane slow axis direction (rotation axis), the retardation at an inclination angle greater than the inclination angle is computed by KOBRA 21ADH or WR after changing the sign thereof to negative.

Further, it is also possible to compute Rth according to the following formulae (1) and (2) by measuring the retardation in two arbitrarily inclined directions around the slow axis as the inclination axis (rotation axis) (in case where no slow axis exists, any direction in the plane of the film is defined as a rotation axis), and basing on the measured value, an assumed value on an average refraction index and an input thickness value.

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad ( 1 )$$

### Note:

The above Re(θ) represents the retardation in a direction that inclines in the degree of θ from the normal direction. In the formula (1), nx represents the refraction index in the slow axis direction in the plane, ny represents the refraction index in the direction perpendicular to nx in the plane, and nz represents the refraction index in the direction perpendicular to the directions of nx and ny.

Rth=((nx+ny)/2−nz)×d (2)

In case where the film to be measured is a film that can not be expressed by a uniaxial or biaxial indicatrix, that is, a so-called film having no optic axis, Rth(λ) is computed according to the following method.

Rth(λ) is computed from the retardation that is obtained by measuring the Re(λ) at total eleven points in directions inclined every 10° from −50° up to +50° from the normal line relative to the film surface around an in-plane slow axis (determined by KOBURA 21AD or WR) as an inclination axis (rotation axis) for an incoming light of a wavelength of λ nm entering from each of the directions of inclination, an assumed value of an average refraction index and input thickness with KOBRA 21ADH or WR.

In the above measurement, the assumed value of the average refraction index may be obtained from Polymer Handbook (JOHN WILEY & SONS, INC) and catalogs for various optical films. Polymers for which the average refraction index is unknown, the index can be measured with an Abbe refractometer. The average refraction indices of principal optical films are exemplified below: cellulose acylate (1.48), cycloolefin polymer (1.52), polycarbonate (1.59), polymethyl methacrylate (1.49), polystyrene (1.59). By inputting the assumed value of these average refraction indices and thickness, KOBRA 21ADH or WR computes nx, ny, nz. From the computed nx, ny, nz, Nz=(nx−nz)/(nx−ny) is computed further.

For the forward wavelength dispersion polymer film of the invention, various polymer films are usable, and, of these, a cellulose acylate film containing mainly cellulose acylate is especially preferred from the viewpoint of the low cost of raw materials and the processability of a polarizing plate.

The term “contain mainly cellulose acylate” means that cellulose acylate is contained in, for example, 70% by mass or more relative to the total weight of the film, preferably 80% by mass or more. Hereinafter, the term “contain mainly cellulose acylate” herein means the same sense.

### [Cellulose Acylate]

Next, cellulose acylate that can be employed for the invention is described.

The substitution degree of cellulose acylate means the percentage of acylation of three hydroxyl groups existing in the constitutional unit ((β)1,4-glycosidically-bound glucose) of cellulose. The substitution degree (acylation degree) can be calculated by measuring the amount of binding aliphatic acid per constitutional unit mass of cellulose. The measurement is carried out according to “ASTM D817-91.”

The cellulose acylate in the invention has the acetyl substitution degree of preferably from 2.90 to 3.00, further preferably from 2.93 to 2.97.

Another preferred cellulose acylate in the invention is mixed aliphatic acid ester having the total acyl substitution degree of from 2.70 to 3.00. Further preferred is mixed aliphatic acid ester having the total acyl substitution degree of from 2.80 to 3.00 and an acyl group having from 3 to 4 carbon atoms. The acyl substitution degree of the mixed aliphatic acid ester is further preferably from 2.85 to 2.97. The substitution degree with an acyl group having from 3 to 4 carbon atoms is preferably from 0.1 to 2.0, further preferably from 0.3 to 1.5.

The cellulose acylate for use in the invention has the mass average polymerization degree of preferably from 300 to 800, further preferably from 300 to 600. The cellulose acylate for use in the invention has the number average molecular weight of preferably from 70,000 to 230,000, further preferably from 75,000 to 230,000, most preferably from 78,000 to 120,000.

The cellulose acylate for use in the invention can be synthesized using acid anhydride or acid chloride as an acylating agent. In case where the acylating agent is acid anhydride, as a reaction solvent, organic acid (e.g., acetic acid) or methylene chloride is used. As a catalyst, such a protonic catalyst as sulfuric acid can be used. When the acylating agent is acid chloride, a basic compound can be used as the catalyst. In the most common industrial synthetic method, cellulose is esterified with a mixed organic acid component containing an organic acid (acetic acid, propionic acid, butyric acid) or anhydride thereof (acetic anhydride, propionic anhydride, butyric anhydride) corresponding to an acetyl group or other acyl groups to synthesize cellulose ester.

In this method, such cellulose as cotton linter and wood pulp is often esterified using a mixed liquid including the above-described organic acid components in the presence of a sulfuric acid catalyst after activation treatment with such organic acid as acetic acid. The organic acid anhydride component is used, generally, in an excess amount relative to the amount of hydroxyl groups existing in cellulose. In the esterification treatment, in addition to the esterification reaction, hydrolysis reaction (depolymerization reaction) of the cellulose main chain ((β)1,4-glycoside bond) proceeds. When the hydrolysis reaction of the main chain proceeds, the polymerization degree of cellulose ester lowers to degrade the physical properties of the cellulose ester film to be produced. Accordingly, such reaction condition as reaction temperature is preferably determined while taking the polymerization degree and molecular weight of cellulose ester to be obtained into consideration.

In order to obtain a cellulose ester having a high polymerization degree (large molecular weight), it is important to adjust the highest temperature during the esterification process at 50° C. or lower. The highest temperature is adjusted at preferably from 35 to 50° C., further preferably from 37 to 47° C. The reaction temperature of 35° C. or higher allows the esterification reaction to proceed smoothly, which is preferred. On the other hand, the reaction temperature of 50° C. or lower does not result in such a disadvantage as the lowering of the polymerization degree of the cellulose ester, which is preferred.

After the esterification reaction, by terminating the reaction while inhibiting the temperature rise, it is possible to inhibit further the lowering of the polymerization degree and to synthesize a cellulose ester having a high polymerization degree. That is, by the addition of a reaction terminating agent (e.g., water, acetic acid) after the end of the reaction, an excess acid anhydride that has not been engaged in the esterification reaction is hydrolyzed to produce the corresponding organic acid as a by-product. This hydrolysis reaction is accompanied with heavy heat generation to raise the temperature in the reaction apparatus. In case where the addition rate of the reaction terminating agent is not too great, there occurs no such problem that heat generates rapidly over the cooling capacity of the reaction apparatus to lead to significant proceeding of the hydrolysis reaction of the cellulose main chain, and that the polymerization degree of the cellulose ester to be obtained is lowered. A part of the catalyst is bonded to the cellulose during the esterification reaction, and most of these are dissociated from the cellulose during the addition of the reaction terminating agent. At this time, when the addition rate of the reaction terminating agent is not too great, a sufficient reaction time is assured for the dissociation of the catalyst, thereby hardly allowing such a problem to occur that a part of the catalyst remains in the bonded state to the cellulose. Cellulose ester to which a catalyst of strong acid is bonded partially has a very low stability, and decomposes easily with heat at drying the product to lower the polymerization degree. From these reasons, after esterification reaction, it is desirable to add a reaction terminating agent over preferably 4 minutes or more, further preferably from 4 to 30 minutes to terminate the reaction. Incidentally, the time of 30 minutes or less for adding the reaction terminating agent does not result in such a problem as the lowering of the industrial productivity, which is preferred.

As the reaction terminating agent, generally, water or alcohol capable that decomposes acid anhydride is employed. But, in the invention, in order not to allow triester having low solubility for various organic solvents to precipitate, a mixture of water and organic acid is employed preferably as a reaction terminating agent. By carrying out esterification reaction under the aforementioned conditions, it is easy to synthesize such a high molecular weight cellulose ester as the mass average polymerization degree of 500 or more.

### [Wavelength Dispersion-controlling Agent]

The cellulose acylate film in the invention contains preferably a wavelength dispersion-controlling agent. A “wavelength dispersion-controlling agent” herein means a compound for adjusting the wavelength dispersion of the retardation of a film.

The wavelength dispersion-controlling agent in the invention has the absorption maximum within the wavelength range of preferably 250 nm to 400 nm, further preferably 270 nm to 380 nm.

In the invention, the absorption maximum of the wavelength dispersion-controlling agent is represented by a value that is obtained by dissolving the agent in methylene chloride, methanol or tetrahydrofuran in a concentration of 0.01 g/L to 0.1 g/L, and by measuring the absorption spectrum with a spectral photometer UV-3500 by SHIMADZIJ, etc.

Specific examples of the preferred wavelength dispersion-controlling agent for use in the invention are preferably compounds that are represented by formulae (III) to (VI), more preferably compounds that are represented by the formula (III).

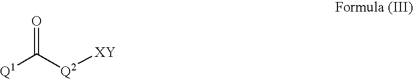

wherein Q¹ and Q² each represents an aromatic ring. X represents a substituent, Y represents an oxygen atom, a sulfur atom or a nitrogen atom. XY may be a hydrogen atom.

Q¹ and Q² each may have a substituent other than the “XY.” Q¹ and Q² each may be a monocyclic or condensed ring. A monocyclic ring is preferred. Compounds that are represented by the formula (III) are preferably benzophenone-based compounds.

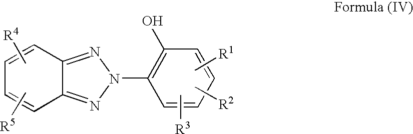

wherein R¹, R², R³, R⁴ and R⁵ each represents a monovalent organic group, and at least one of R¹, R² and R³ is an unsubstituted branched or linear alkyl group having the total carbon atoms of 10 to 20.

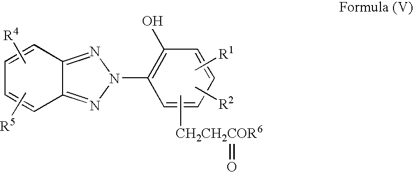

wherein R¹, R², R⁴ and R⁵ each represents a monovalent organic group, and R⁶ represents a branched alkyl group.

In addition, as described in JP-A-2003-315549, compounds that are represented by formula (VI) can be also used preferably.

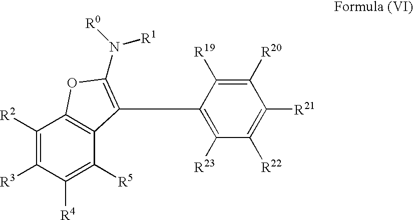

wherein R⁰ and R¹ each independently represents a hydrogen atom, an alkyl group having 1 to 25 carbon atoms, a phenylalkyl group having 7 to 9 carbon atoms, an unsubstituted or an alkyl group having 1 to 4 carbon atoms-substituted phenyl group, a substituted or unsubstituted oxycarbonyl group, or a substituted or unsubstituted aminocarbonyl group. R² to R⁵ and R¹⁹ to R²³ each independently represents a hydrogen atom or a substituted or unsubstituted alkyl group having 2 to 20 carbon atoms.

Furthermore, for example, oxybenzophenone-based compounds, benzotriazole-based compounds, salicylic acid ester-based compounds, cyanoacrylate-based compounds, and nickel complex-based compounds can be referred to as preferred examples.

Examples of the preferred benzotriazole-based wavelength dispersion-controlling agent include 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidomethyl)-5′-methylphenyl)benzotriazole, 2,2-methylenebis(4-(1,1,3,3-tetramethylbutyl)-6-(2H-benzotriazole-2-yl)phenol), 2-(2′-hydroxy-3′-tert-butyl-5′-methylphenyl)-5-chlorobenzotriazole, 2,4-dihydroxy-1-benzophenone, 2,2′-dihydroxy-4-methoxybenzophenone, 2-hydroxy-4-methoxy-5-sulfobenzophenone, bis(2-methoxy-4-hydroxy-5-benzoylphenylmethane), (2,4-bis(n-octylthio)-6-(4-hydroxy-3,5-di-tert-butylanilino)-1,3,5-triazine, 2(2′-hydroxy-3′,5′-di-tert-butylphenyl)-5-chlorobenzotriazole, (2(2′-hydroxy-3′,5′-di-tert-amylphenyl)-5-chlorobenzotriazole, 2,6-di-tert-butyl-p-cresol, pentaerythrityl-tetrakis[3-(3,5-di-tert-butyl-4-hydroxyphenyl)propionate], triethylene glycol-bis[3-(3-tert-butyl-5-methyl-4-hydroxyphenyl)propionate], 1,6-hexanediol-bis[3-(3,5-di-tert-butyl-4-hydroxyphenyl)propionate], 2,4-bis(n-octylthio)-6-(4-hydroxy-3,5-di-tert-butylanilino)-1,3,5-triazine, 2,2-thio-diethylenebis[3-(3,5-di-tert-butyl-4-hydroxyphenyl)propionate], octadecyl-3-(3,5-di-tert-butyl-4-hydroxyphenyl)propionate, N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, and tris(3,5-di-tert-butyl-4-hydroxybenzyl)-isocyanurate. In particular, preferred are (2,4-bis(n-octylthio)-6-(4-hydroxy-3,5-di-tert-butylanilino)-1,3,5-triazine, 2(2′-hydroxy-3′,5′-di-tert-butylphenyl)-5-chlorobenzotriazole, (2(2′-hydroxy-3′,5′-di-tert-amylphenyl)-5-chlorobenzotriazole, 2,6-di-tert-butyl-p-cresol, pentaerythrityl-tetrakis[3-(3,5-di-tert-butyl-4-hydroxyphenyl)propionate], and triethylene glycol bis[3-(3-tert-butyl-5-methyl-4-hydroxyphenyl)propionate].

Further, for example, such a hydrazine-based metal deactivator as N,N′-bis[3-(3,5-di-tert-butyl-4-hydroxyphenyl)propionyl]hydrazine and such a phosphorous-based processing stabilizer as tris(2,4-di-tert-butylphenyl) phosphite may be used in combination. The addition amount of these compounds is preferably 1 ppm to 1.0% by mass relative to cellulose acylate, further preferably 10 to 1000 ppm.

Next, the wavelength dispersion-controlling agent that is represented by the following formula (VII) is described in detail.

Q¹-Q²-OH Formula (VII)

wherein Q¹ represents a 1,3,5-triazine ring, and Q² represents an aromatic ring.

Among these compounds that are represented by the formula (VII), further preferred are compounds that are represented by the following formula (VII-A).

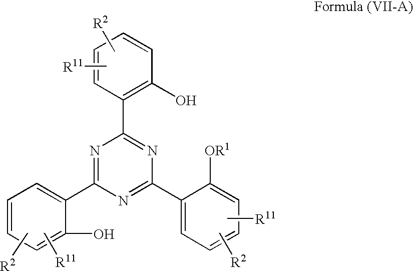

wherein R¹¹ represents a hydrogen atom; an alkyl group having 1 to 18 carbon atoms; a cycloalkyl group having 5 to 12 carbon atoms; an alkenyl group having 3 to 18 carbon atoms; a phenyl group; an alkyl group having 1 to 18 carbon atoms substituted with a phenoxy group, an alkoxy group having 1 to 4 carbon atoms substituted with a phenyl group, a bicycloalkoxy group having 6 to 15 carbon atoms, a bicycloalkylalkoxy group having 6 to 15 carbon atoms, a bicycloalkenylalkoxy group having 6 to 15 carbon atoms, substituted with or a tricycloalkoxy group having 6 to 15 carbon atoms, that are substituted with a substituent selected from the substituent group consisting of a phenyl group, —OH, an alkoxy group having 1 to 18 carbon atoms, a cycloalkoxy group having 5 to 12 carbon atoms, an alkenyloxy group having 3 to 18 carbon atoms, a halogen atom, —COOH, —COOR⁴, —O—CO—R⁵, —O—CO—O—R⁶, —CO—NH₂, —CO—NHR⁷, —CO—N(R⁷)(R⁸), —CN, —NH₂, —NHR⁷, —N(R⁷)(R⁸), —NH—CO—R⁵, a phenoxy group and an alkyl group having 1 to 18 carbon atoms; a cycloalkyl group having 5 to 12 carbon atoms being substituted with a substituent selected from the substituent group consisting of —OH, an alkyl group having 1 to 4 carbon atoms, an alkenyl group having 2 to 6 carbon atoms and —O—CO—R⁵; a glycidyl group; —CO—R⁹; —SO₂—R¹⁰; an alkyl group having 3 to 50 carbon atoms that is intermitted with one or more oxygen atoms and/or substituted with a substituent selected from the substituent group consisting of —OH, a phenoxy group and an alkylphenoxy group having 7 to 18 carbon atoms; -A (wherein A represents —CO—CR⁶═CH—R¹⁷); —CH₂—CH(XA)-CH₂—O—R¹²; —CR¹³R′¹³—(CH₂)ₘ—X-A; —CH₂—CH(OA)—R¹⁴; —CH₂—CH(OH)—CH₂—XA;

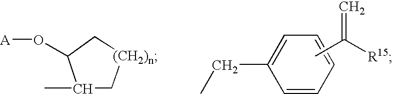

—CR¹⁵R′¹⁵—C(═CH₂)—R″¹⁵; —CR¹³R′¹³—(CH₂)ₘ—CO—X-A; —CR¹³R′¹³—(CH₂)ₘ—CO—O—CR¹⁵R′¹⁵—C(═CH₂)—R″¹⁵; or —CO—O—CR¹⁵R′¹⁵—C(═CH₂)—R″¹⁵.

R² represents an alkyl group having 6 to 18 carbon atoms; an alkenyl group having 2 to 6 carbon atoms; a phenyl group; a phenylalkyl group having 7 to 11 carbon atoms; —COOR⁴; —CN; —NH—CO—R⁵; a halogen atom; a trifluoromethyl group; or —O—R³ (R³ has the same meaning as the above R¹).

R⁴ represents an alkyl group having 1 to 18 carbon atoms; an alkenyl group having 3 to 18 carbon atoms; a phenyl group; a phenylalkyl group having 7 to 11 carbon atoms; a cycloalkyl group having 5 to 12 carbon atoms; or an alkyl group having 3 to 50 carbon atoms that may be substituted with a substituent selected from the substituent group consisting of —OH that is intermitted with one or more of —O—, —NH—, —NR⁷— and —S—, a phenoxy group and an alkylphenoxy group having 7 to 18 carbon atoms.

R⁵ represents a hydrogen atom; an alkyl group having 1 to 18 carbon atoms; an alkenyl group having 2 to 18 carbon atoms; a cycloalkyl group having 5 to 12 carbon atoms; a phenyl group; a phenylalkyl group having 7 to 11 carbon atoms; a bicycloalkyl group having 6 to 15 carbon atoms; a bicycloalkenyl group having 6 to 15 carbon atoms; or a tricycloalkyl group having 6 to 15 carbon atoms.

R⁶ represents a hydrogen atom; an alkyl group having 1 to 18 carbon atoms; an alkenyl group having 3 to 18 carbon atoms; a phenyl group; a phenylalkyl group having 7 to 11 carbon atoms; or a cycloalkyl group having 5 to 12 carbon atoms.

R⁷ and R⁸ each independently represents an alkyl group having 1 to 12 carbon atoms; an alkoxyalkyl group having 3 to 12 carbon atoms; a dialkylaminoalkyl group having 4 to 16 carbon atoms; or a cycloalkyl group having 5 to 12 carbon atoms, or R⁷ and R⁸ join to represent alkylene group having 3 to 9 carbon atoms, an oxaalkylene group having 3 to 9 carbon atoms or an azaalkylene group having 3 to 9 carbon atoms.

R⁹ represents an alkyl group having 1 to 18 carbon atoms; an alkenyl group having 2 to 18 carbon atoms; a phenyl group; a cycloalkyl group having 5 to 12 carbon atoms; a phenylalkyl group having 7 to 11 carbon atoms; a bicycloalkyl group having 6 to 15 carbon atoms; a bicycloalkylalkyl group having 6 to 15 carbon atoms; a bicycloalkenyl group having 6 to 15 carbon atoms; or a tricycloalkyl group having 6 to 15 carbon atoms.

R¹⁰ represents an alkyl group having 1 to 12 carbon atoms; a phenyl group; a naphthyl group; or an alkylphenyl group having 7 to 14 carbon atoms.

R¹² represents an alkyl group having 1 to 18 carbon atoms; an alkenyl group having 3 to 18 carbon atoms; a phenyl group; a phenyl group being substituted with a substituent selected from the substituent group consisting of an alkyl group having 1 to 8 carbon atoms, an alkoxy group having 1 to 8 carbon atoms, an alkenoxy group having 3 to 8 carbon atoms, a halogen atom and trifluoromethyl group; a phenylalkyl group having 7 to 11 carbon atoms; a cycloalkyl group having 5 to 12 carbon atoms; a tricycloalkyl group having 6 to 15 carbon atoms; a bicycloalkyl group having 6 to 15 carbon atoms; a bicycloalkylalkyl group having 6 to 15 carbon atoms; a bicycloalkenylalkyl group having 6 to 15 carbon atoms; —CO—R⁵; an alkyl group having 3 to 50 carbon atoms that is intermitted with any one or more of —O—, —NH—, —NR⁷— and —S— and may be substituted with —OH, a phenoxy group or an alkylphenoxy group having 7 to 18 carbon atoms.

R¹³ and R′¹³ each independently represents a hydrogen atom; an alkyl group having 1 to 18 carbon atoms; or a phenyl group.

R¹⁴ represents an alkyl group having 1 to 18 carbon atoms; an alkoxyalkyl group having 3 to 12 carbon atoms; a phenyl group; or an alkyl group having 1 to 4 carbon atoms that is substituted with a phenyl group.

R¹⁵, R′¹⁵ and R″¹⁵ each independently represents a hydrogen atom or —CH₃.

R¹⁶ represents a hydrogen atom; —CH₂—COO—R⁴; an alkyl group having 1 to 4 carbon atoms; or —CN.

R¹⁷ represents a hydrogen atom; —COOR⁴; an alkyl group having 1 to 17 carbon atoms; or a phenyl group.

X represents —NH—; —NR⁷—; —O—; —NH— (CH₂)ₚ—NH—; or —O— (CH₂)_{q}—NH—.

m represents 0 or an integer of 1 to 19; n represents an integer of 1 to 8; p represents 0 or an integer of 1 to 4; q represents 2, 3 or 4. But, in the formula (VII-A), at least one of R¹, R² and R¹¹ contains 2 or more carbon atoms.

The compound that is represented by the formula (VII-A) is described further.

Each of groups R¹¹, R² to R¹⁰, R¹² to R¹⁴, R¹⁶ and R¹⁷ as an alkyl group is preferably an unbranched or branched alkyl group, including, for example, a methyl group, ethyl group, propyl group, isopropyl group, n-butyl-group, secondary butyl group, isobutyl group, tertiary butyl group, 2-ethylbutyl group, n-pentyl group, isopentyl group, 1-methylpentyl group, 1,3-dimethylbutyl group, n-hexyl group, 1-methylhexyl group, n-heptyl group, isoheptyl group, 1,1,3,3-tetramethylbutyl group, 1-methylheptyl group, 3-methylheptyl group, n-octyl group, 2-ethylhexyl group, 1,1,3-trimethylhexyl group, 1,1,3,3-tetramethylpentyl group, nonyl group, decyl group, undecyl group, 1-methylundecyl group, dodecyl group, 1,1,3,3,5,5-hexamethylhexyl group, tridecyl group, tetradecyl group, pentadecyl group, hexadecyl group, heptadecyl group or octadecyl group.

Each of R¹¹, R³ to R⁹ and R¹² as a cycloalkyl group having 5 to 12 carbon atoms is, for example, a cyclopentyl group, cyclohexyl group, cycloheptyl group, cyclooctyl group, cyclononyl group, cyclodecyl group, cycloundecyl group, or cyclododecyl group. Preferred are a cyclopentyl group, cyclohexyl group, cyclooctyl group and cyclododecyl group.

As more preferred examples, each of R⁶, R⁹, R¹¹ and R¹² as an alkenyl group include an allyl group, isopropenyl group, 2-butenyl group, 3-butenyl group, isobutenyl group, n-penta-2,4-diethyl group, 3-methyl-bute-2-enyl group, n-octe-2-enyl group, n-dodece-2-enyl group, isododecenyl group, n-dodece-2-enyl group and n-octadece-4-enyl group.

A substituted alkyl group, cycloalkyl group or phenyl group has the number of the substituent of preferably one or more, can have a substituent on a bonded carbon atom (on an α-site) or on another carbon atom, has a substituent preferably on a site other than the α-site when the substituent is bonded with a hetero atom (e.g., an alkoxy group), and the substituted alkyl group has preferably at least two carbon atoms, more preferably at least three or more. Two or more substituents are bonded preferably to different carbon atoms.

An alkyl group that is intermitted with one or more of —O—, —NH—, —NR⁷— and —S— may be intermitted with two or more thereof. In case where it is intermitted with two or more of these groups, there is exemplified such an instance that hetero atom-hetero atom bonds, for example, O—O, S—S and NH—NH do not occur.

In case where an intermitted alkyl group has a substituent, there is exemplified such an embodiment that the substituent does not exist on the α-site relative to the hetero atom. In case where two or more intermitting groups having the type of —O—, —NH—, —NR⁷—, —S— occur in one group, an embodiment in which the groups are the same is exemplified.

The aryl group is preferably an aromatic hydrocarbon group, including, for example, a phenyl group, biphenylyl group and naphthyl group, more preferably a phenyl group and biphenylyl group. The aralkyl group is preferably an alkyl group being substituted with an aryl group, in particular phenyl group. The aralkyl group having 7 to 20 carbon atoms includes, for example, a benzyl group, α-methylbenzyl group, phenylethyl group, phenylpropyl group, phenylbutyl group, phenylpentyl group and phenylhexyl group. The phenylalkyl group having 7 to 11 carbon atoms includes preferably a benzyl group, α-methylbenzyl group and α,α-dimethylbenzyl group.

An alkylphenyl group and an alkylphenoxy group are a phenyl group and a phenoxy group being substituted with an alkyl group, respectively.

The halogen atom to be a halogen substituent is a fluorine atom, chlorine atom, bromine atom, or iodine atom, more preferably a fluorine atom and chlorine atom, especially preferably a chlorine atom.

The alkylene group having 1 to 20 carbon atoms includes, for example, a methylene group, ethylene group, propylene group, butylene group, pentylene group and hexylene group. Here, the alkyl chain may be branched, and is, for example, an isopropylene group.

The cycloalkenyl group having 4 to 12 carbon atoms includes, for example, a 2-cyclobuteny-2-yl group, 2-cyclopenteny-1-yl group, 2,4-cyclopentadieny-1-yl group, 2-cyclohexeny-1-yl group, 2-cyclohepteny-1-yl group and 2-cycloocteny-1-yl group.

The bicycloalkyl group having 6 to 15 carbon atoms includes, for example, a bornyl group, norbornyl group and [2.2.2]bicyclooctyl group. A bornyl group and norbornyl group, especially a bornyl group and norborny-2-yl group are preferred.

The bicycloalkoxy group having 6 to 15 carbon atoms includes, for example, a bornyloxy group and norborny-2-yloxy group.

The bicycloalkyl-alkyl or -alkoxy group having 6 to 15 carbon atoms is an alkyl group or an alkoxy group having the total carbon atoms of 6 to 15 being substituted with a bicycloalkyl group, wherein preferred are a norbornane-2-methyl group and norbornyl-2-methoxy group.

The bicycloalkenyl group having 6 to 15 carbon atoms includes, for example, a norbornenyl group and norbornadienyl group. Preferred is a norbornenyl group, especially norborne-5-ene group.

The bicycloalkenylalkoxy group having 6 to 15 carbon atoms is an alkoxy group having the total carbon atoms of 6 to 15 being substituted with a bicycloalkenyl group, wherein preferred is a norborne-5-ene-2-methoxy group.

The tricycloalkyl group having 6 to 15 carbon atoms includes, for example, a 1-adamantyl group and 2-adamantyl group. Preferred is a 1-adamantyl group.

The tricycloalkoxy group having 6 to 15 carbon atoms includes, for example, an adamantyloxy group. The heteroaryl group having 3 to 12 carbon atoms is preferably a pyridinyl group, pyrimidinyl group, triazynyl group, pyrrolyl group, furanyl group, thiophenyl group and quinolinyl group.

The compound that is represented by the formula (VII-A) is further preferred in the following instance.

R¹¹ represents one of groups that are defined by an alkyl group having 1 to 18 carbon atoms; a cycloalkyl group having 5 to 12 carbon atoms; an alkenyl group having 3 to 12 carbon atoms; a phenyl group; an alkyl group having 1 to 18 carbon atoms substituted with a phenoxy group, an alkoxy group having 1 to 4 carbon atoms being substituted with a phenyl group, bornyloxy group, norborny-2-yloxy group, norbornyl-2-methoxy group, norborne-5-ene-2-methoxy group, or an adamantyloxy group, that have been substituted with a substituent selected from the substituent group consisting of a phenyl group, —OH, alkoxy group having 1 to 18 carbon atoms, cycloalkoxy group having 5 to 12 carbon atoms, alkenyloxy group having 3 to 18 carbon atoms, halogen atom, —COOH, —COOR⁴, —O—CO—R⁵, —O—CO—O—R^{B}, —CO—NH₂, —CO—NHR⁷, —CO—N(R⁷)(R⁸), —CN, —NH₂, —NHR⁷, —N(R⁷) (R^{o}), —NH—CO—R⁵, a phenoxy group and an alkyl group having 1 to 18 carbon atoms; a cycloalkyl group having 5 to 12 carbon atoms being substituted with a substituent selected from the substituent group consisting of —OH, an alkyl group having 1 to 4 carbon atoms, alkenyl group having 2 to 6 carbon atoms and —O—CO—R⁵; a glycidyl group; —CO—R⁹ or —SO₂—R¹⁰; an alkyl group having 3 to 50 carbon atoms that is intermitted with one or more oxygen atoms and/or substituted with a substituent selected from the substituent group consisting of —OH, a phenoxy group and alkylphenoxy group having 7 to 18 carbon atoms; -A; —CH₂—CH(XA)-CH₂—O—R¹²; —CR¹³R′¹³—(CH₂)ₘ—X-A; —CH₂—CH(OA)-R¹⁴, —CH₂—CH(OH)—CH₂—XA;

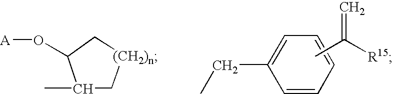

—CR¹⁵R′¹⁵—C(═CH₂)—R″¹⁵; —CR¹³R′¹³—(CH₂)ₘ—CO—X-A; —CR¹³R′¹³—(CH₂)ₘ—CO—O—CR¹⁵R′¹⁵—C(═CH₂)—R″¹⁵ or —CO—O—CR¹⁵R′¹⁵—C(═CH₂)—R″¹⁵ (wherein A represents —CO—CR¹⁶═CH—R¹⁷).

R² represents an alkyl group having 6 to 18 carbon atoms; an alkenyl group having 2 to 6 carbon atoms; a phenyl group; —O—R³ or —NH—CO—R⁵.

R⁴ represents an alkyl group having 1 to 18 carbon atoms; an alkenyl group having 3 to 18 carbon atoms; a phenyl group; a phenylalkyl group having 7 to 11 carbon atoms; a cycloalkyl group having 5 to 12 carbon atoms; or an alkyl group having 3 to 50 carbon atoms that may be intermitted with one or more of —O—, —NH—, —NR⁷— and —S—, and substituted with a substituent selected from the substituent group consisting of —OH, a phenoxy group and alkylphenoxy group having 7 to 18 carbon atoms.

R⁵ represents a hydrogen atom; an alkyl group having 1 to 18 carbon atoms; an alkenyl group having 2 to 18 carbon atoms; a cycloalkyl group having 5 to 12 carbon atoms; a phenyl group; a phenylalkyl group having 7 to 11 carbon atoms; a norborny-2-yl group; a norborne-5-eny-2-yl group; or an adamantyl group.

R⁶ represents a hydrogen atom; an alkyl group having 1 to 18 carbon atoms; an alkenyl group having 3 to 18 carbon atoms; a phenyl group; a phenylalkyl group having 7 to 11 carbon atoms; or a cycloalkyl group having 5 to 12 carbon atoms.

R⁷ and R⁸ each independently represents an alkyl group having 1 to 12 carbon atoms; an alkoxyalkyl group having 3 to 12 carbon atoms; a dialkylaminoalkyl group having 4 to 16 carbon atoms; a cycloalkyl group having 5 to 12 carbon atoms; or an alkylene group having 3 to 9 carbon atoms, an oxaalkylene group having 3 to 9 carbon atoms, an azaalkylene group having 3 to 9 carbon atoms that are formed by bonding R⁷ with R⁸.

R⁹ represents an alkyl group having 1 to 18 carbon atoms; an alkenyl group having 2 to 18 carbon atoms; a phenyl group; a cycloalkyl group having 5 to 12 carbon atoms; a phenylalkyl group having 7 to 11 carbon atoms; a norborny-2-yl group; a norborne-5-eny-2-yl group; or an adamantyl group.

R¹⁰ represents an alkyl group having 1 to 12 carbon atoms; a phenyl group; a naphthyl group; or an alkylphenyl group having 7 to 14 carbon atoms.

R¹¹ represents a hydrogen atom; an alkyl group having 1 to 18 carbon atoms; or a phenylalkyl group having 7 to 11 carbon atoms.

R¹² represents an alkyl group having 1 to 18 carbon atoms; an alkenyl group having 3 to 18 carbon atoms; a phenyl group; a phenyl group that is substituted with a substituent selected from the substituent group consisting of an alkyl group having 1 to 8 carbon atoms, alkoxy group having 1 to 8 carbon atoms, alkenoxy group having 3 to 8 carbon atoms, halogen atom and trifluoromethyl group; a phenylalkyl group having 7 to 11 carbon atoms; a cycloalkyl group having 5 to 12 carbon atoms; a 1-adamantyl group; a 2-adamantyl group; a norbornyl group; a norbornane-2-methyl-; —CO—R⁵; an alkyl group having 3 to 50 carbon atoms that may be intermitted with one or more of —O—, —NH—, —NR⁷— and —S—, and substituted with a substituent selected from the substituent group consisting of —OH, a phenoxy group and alkylphenoxy group having 7 to 18 carbon atoms.

R¹⁷ represents a hydrogen atom; —COOR⁴; an alkyl group having 1 to 17 carbon atoms; or a phenyl group.

The compounds that are represented by formulae (VII) or (VII-A) can be produced by a publicly known method. For example, they can be obtained similar to publicly known compounds, according to such methods that are represented by EP Patent No. 434608 or H. Brunetti and C. E. Luthi, Helv. Chim. Acta 55, 1566 (1972), by Friedel-Kraft addition of halotriazine to the corresponding phenol.

Next, preferred examples of the compounds that are represented by formulae (VII) or (VII-A) are shown below, but compounds that can be used in the invention are not limited to these specific examples.

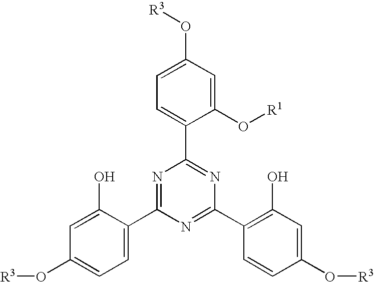

| Compound | | |
|---|---|---|
| No. | R³ | R¹ |
| UV-1 | —CH₂CH(OH)CH₂OC₄H₉-n | —CH₃ |
| UV-2 | —CH₂CH(OH)CH₂OC₄H₉-n | —C₂H₅ |
| UV-3 | R³ = R¹ = —CH₂CH(OH)CH₂OC₄H₉-n | |
| UV-4 | —CH(CH₃)—CO—O—C₂H₅ | —C₂H₅ |
| UV-5 | R³ = R¹ = —CH(CH₃)—CO—O—C₂H₅ | |
| UV-6 | —C₂H₅ | —C₂H₅ |
| UV-7 | —CH₂CH(OH)CH₂OC₄H₉-n | —CH(CH₃)₂ |
| UV-8 | —CH₂CH(OH)CH₂OC₄H₉-n | —CH(CH₃)—C₂H₅ |
| UV-9 | R³ = R¹ = —CH₂CH(C₂H₅)—C₄H₉-n | |
| UV-10 | —C₈H₁₇-n | —C₈H₁₇-n |
| UV-11 | —C₃H₇-n | —CH₃ |
| UV-12 | —C₃H₇-n | —C₂H₅ |
| UV-13 | —C₃H₇-n | —C₃H₇-n |
| UV-14 | —C₃H₇-iso | —CH₃ |
| UV-15 | —C₃H₇-iso | —C₂H₅ |
| UV-16 | —C₃H₇-iso | —C₃H₇-iso |
| UV-17 | —C₄H₉-n | —CH₃ |
| UV-18 | —C₄H₉-n | —C₂H₅ |
| UV-19 | —C₄H₉-n | —C₄H₉-n |
| UV-20 | —CH₂CH(CH₃)₂ | —CH₃ |
| UV-21 | —CH₂CH(CH₃)₂ | —C₂H₅ |
| UV-22 | —CH₂CH(CH₃)₂ | —CH₂CH(CH₃)₂ |
| UV-23 | n-hexyl | —CH₃ |
| UV-24 | n-hexyl | —C₂H₅ |
| UV-25 | n-hexyl | n-hexyl |
| UV-26 | —C₇H₁₅-n | —CH₃ |
| UV-27 | —C₇H₁₅-n | —C₂H₅ |
| UV-28 | —C₇H₁₅-n | —C₇H₁₅-n |
| UV-29 | —C₈H₁₇-n | —CH₃ |
| UV-30 | —C₈H₁₇-n | —C₂H₅ |
| UV-31 | —CH₂CHCH(CH₃)₂ | —CH₂CHCH(CH₃)₂ |
| UV-32 | —C₅H₁₁-n | —C₅H₁₁-n |
| UV-33 | —C₁₂H₂₅-n | —C₁₂H₂₅-n |
| UV-34 | —C₁₆H₃₃-n | —C₂H₅ |
| UV-35 | —CH₂—CO—O—C₂H₅ | —CH₂—CO—O—C₂H₅ |

In addition, photostabilizers that are shown in the catalog of “Adecastab,” the outline of additives for plastic by Asahi Denka, can be also used. Photostabilizers and UV-absorbers that are described in a guide for TINUVIN products, by Chiba Specialty Chemicals, can be also used. SEESORB, SEENOX and SEETEC that are shown in the catalog of SHIPROKASEI KAISYA can be also used. UV-absorbers and oxidation inhibitors from Johoku Chemical can be also used. VIOSORB from Kyodo Yakuhin, and UV-absorbers from Yoshitomi Pharmaceutical Co., Ltd. can be also used.

Further, for the wavelength dispersion-controlling agent of the invention, disk-shaped compounds as described in JP-A-2001-166144 and JP-A-2003-3446556 can be also used preferably.

The wavelength dispersion-controlling agent of the invention may be added previously when a mixed solution of cellulose acylate is formed, or may be added to a dope of cellulose acylate that has been formed previously at any time until the casting. In the latter case, in order to carry out an in-line addition and mixing of a dope solution that is formed by dissolving cellulose acylate in a solvent and a solution that is formed by dissolving the wavelength dispersion-controlling agent and a small amount of cellulose acylate, for example, preferably used is such an in-line mixer as a static mixer (by Toray Engineering) and SWJ (Hi-Mixer, a static intratubular mixer by Toray). To the wavelength dispersion-controlling agent that is added subsequently, a matting agent may be mixed at the same time, or such an additive as a retardation controlling agent, a plasticizer, a degradation inhibiter or a peeling enhancer may be mixed. In case where an in-line mixer is used, concentrating dissolution under a high pressure is preferred, wherein the type of a pressurizable vessel is not particularly limited, but a vessel capable of enduring a predetermined pressure and carrying out heating and stirring under pressure suffices for the purpose. The pressurizable vessel is arranged arbitrarily with such measuring meters as a pressure gauge and thermometer. The pressurization may be carried out by such a method as injecting an inert gas such as nitrogen gas or heating to raise the vapor pressure of a solvent. The heating is carried out preferably from the outside. For example, the use of a heater of a jacket type is preferred because the temperature control is easy. When a solvent is added, the heating temperature is preferably within such a range that is at least the boiling point of the solvent to be used and does not allow the solvent to boil. It is suitable to preset the temperature, for example, within a range of 30 to 150° C. The pressure is so controlled that the solvent does not boil at the preset temperature. After the dissolution, the resultant is taken out of the vessel with cooling, or extracted from the vessel with a pump etc. to be cooled with a heat exchanger, which is provided for film forming. At this time, the resultant may be cooled down to ordinary temperature, but, more preferably, it is cooled down to a temperature lower than the boiling point of the solvent by 5 to 10° C. to be provided directly for casting at the temperature, because the dope viscosity can be reduced.

The wavelength dispersion-controlling agent in the invention may be used either singly or in a mixture of two or more types. The addition amount of the wavelength dispersion-controlling agent in the invention is preferably 1.0 to 20% by mass relative to 100 parts by mass of cellulose acylate, further preferably 1.5 to 15% by mass, most preferably 2.0 to 10% by mass.

Regarding the method for adding the wavelength dispersion-controlling agent in the invention, the wavelength dispersion-controlling agent may be dissolved in such an organic solvent as alcohol, methylene chloride or dioxolan and then added to the cellulose acylate solution (dope), or may be added directly to the dope composition.

### (Retardation Reducing Agent)

In case where the polymer film that is adopted in the invention is a low retardation cellulose acylate film, the incorporation of a compound having a high compatibility with a cellulose acylate film is preferred as a retardation reducing agent.

For the retardation reducing agent in the invention, compounds that are represented by the following formula (A) or (B) are preferred, because they exert a large retardation-reducing effect.

Hereinafter, the compounds that are represented by formula (A) is described in detail.

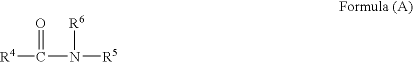

wherein R⁴, R⁵ and R⁶ each independently represents a substituted or unsubstituted alkyl group.

In the formula (A), R⁴, R⁵ and R⁶ each independently represents a substituted or unsubstituted alkyl group. The alkyl group may be linear, branched or cyclic. The alkyl group has preferably 1 to 20 carbon atoms, more preferably 1 to 15, further preferably 1 to 12. As a cyclic alkyl group, especially preferred is a cyclohexyl group.

The alkyl group in the formula (A) may have a substituent. As the substituent, a halogen atom (e.g., a chlorine, bromine, fluorine or iodine atom), alkyl group, alkoxy group, acyl group, alkoxycarbonyl group, acyloxy group, sulfonylamino group, hydroxyl group, cyano group, amino group and acylamino group are preferred, a halogen atom, alkyl group, alkoxy group, sulfonylamino group and acylamino group are more preferred, and an alkyl group, sulfonylamino group and acylamino group are especially preferred.

Next, preferred examples of compounds that are represented by formula (A) are shown below, but the invention is not limited to these specific examples.

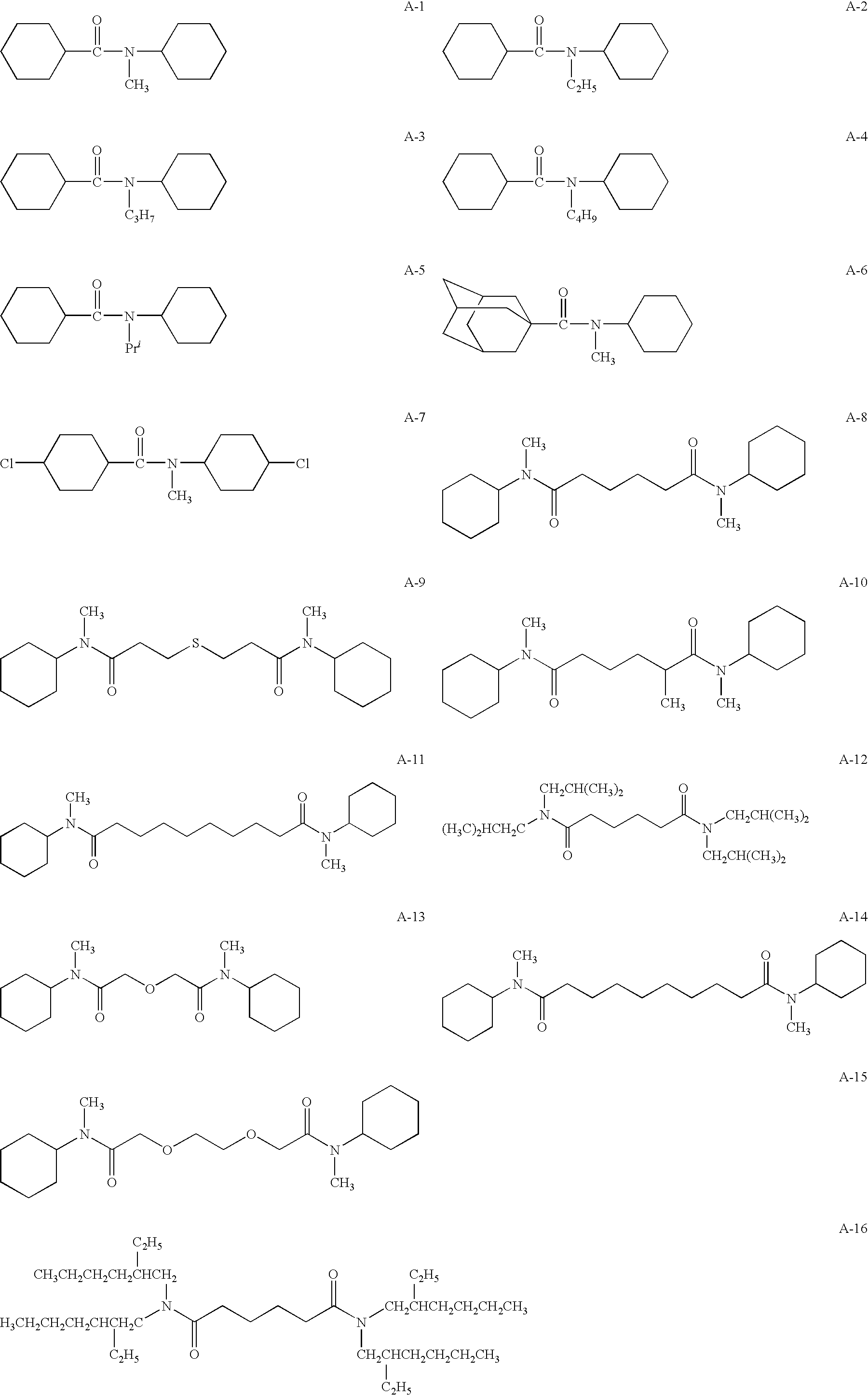

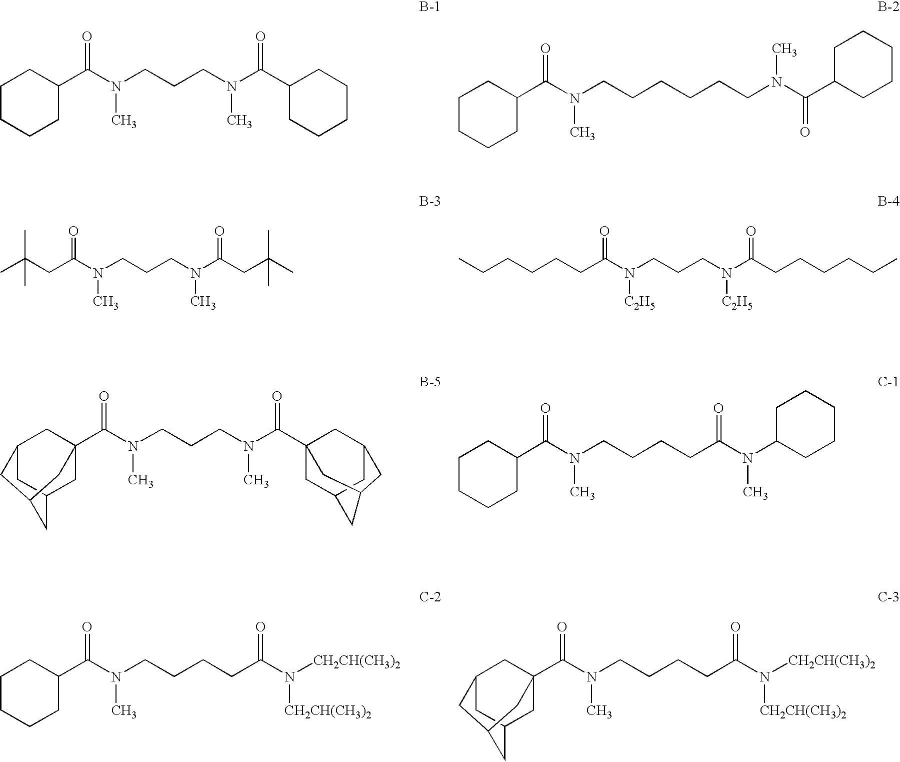

Each of the above-described compounds can be produced by a known method. That is, the compound that is represented by the formula (A) can be obtained by a dehydration condensation reaction between carboxylic acids and amines using a condensation agent (e.g., dicyclohexyl carbodiimide (DCC)), or a substitution reaction between carboxylic acid chloride derivatives and amine derivatives.

Next, the compound that is represented by the following formula (B) is described.

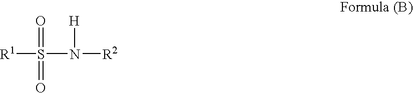

wherein R¹ and R² each independently represents an alkyl group or an aryl group.

Especially preferably the total carbon atoms of R¹ and R² is 10 or more. As a substituent thereof, a fluorine atom, alkyl group, aryl group, alkoxy group, sulfon group and sulfonamide group are preferred, and an alkyl group, aryl group, alkoxy group, sulfon group and a sulfonamide group are especially preferred. The alkyl group may be linear, branched or cyclic, and has carbon atoms of preferably 1 to 25, more preferably 6 to 25, especially preferably 6 to 20 (e.g., a methyl group, ethyl group, propyl group, isopropyl group, butyl group, isobutyl group, tert-butyl group, amyl group, isoamyl group, tert-amyl group, hexyl group, cyclohexyl group, heptyl group, octyl group, bicyclooctyl group, nonyl group, adamantyl group, decyl group, tert-octyl group, undecyl group, dodecyl group, tridecyl group, tetradecyl group, pentadecyl group, hexadecyl group, heptadecyl group, octadecyl group, nonadecyl group, didecyl group).

The aryl group has carbon atoms of preferably 6 to 30, especially preferably 6 to 24 (e.g., a phenyl group, biphenyl group, terphenyl group, naphthyl group, binaphthyl group, triphenylphenyl group).

Preferred examples of the compound that is represented by the formula (B) are shown below, but the invention is not limited to these specific examples. Here, Prⁱ represents an isopropyl group.

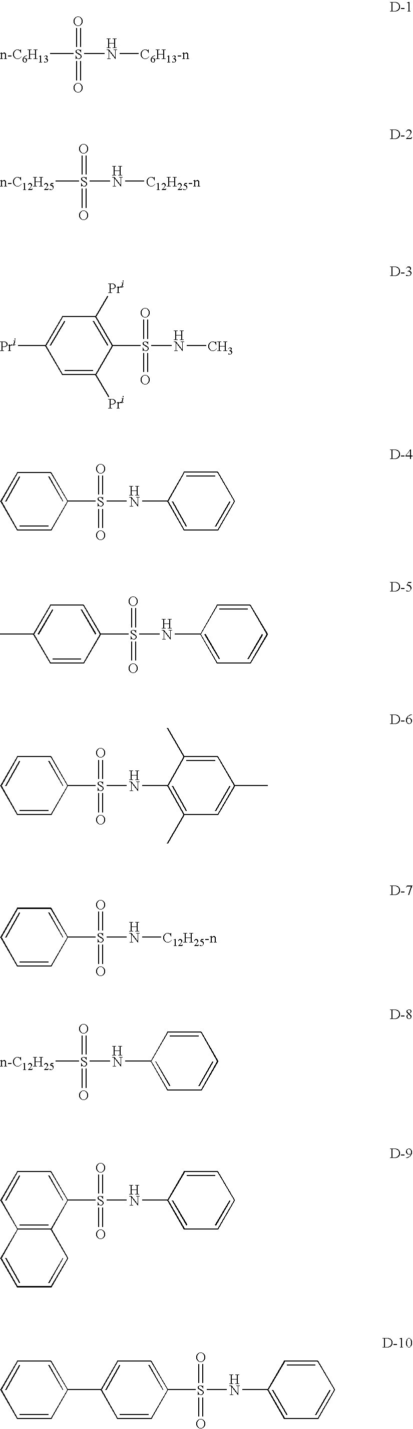

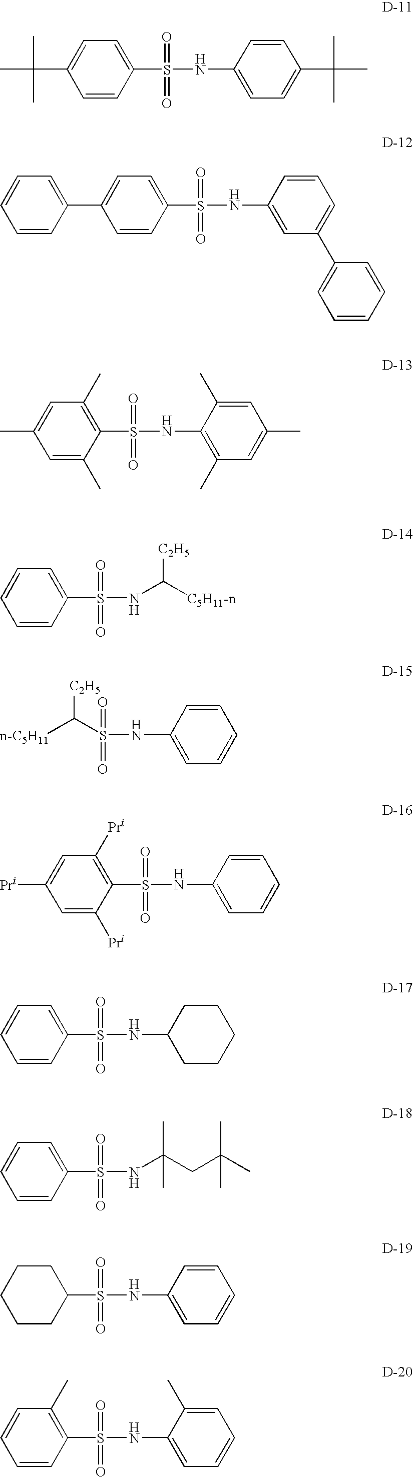

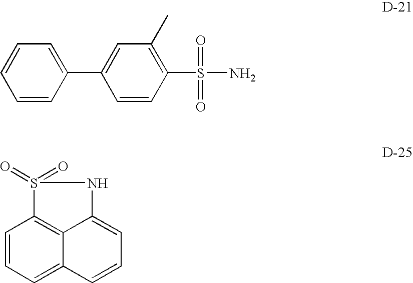

In the invention, the addition amount of the retardation reducing agent is preferably 1 to 30% by mass relative to cellulose acylate, more preferably 2 to 30% by mass, further preferably 3 to 25% by mass, most preferably 5% to 20% by mass.

The retardation reducing agent to be adopted in the invention can be used, for example, by dissolving it in such an organic solvent as alcohol, methylene chloride or dioxolan and adding the solution to a cellulose acetate solution (dope), or by adding the agent directly to a dope composition.

### [Production of Forward Wavelength Dispersion Cellulose Acylate Film]

The cellulose acylate film in the invention can be produced by a solvent casting method. In a solvent casting method, a solution of cellulose acylate dissolved in an organic solvent (dope) is used for producing a film.

The organic solvent includes preferably a solvent that is selected from ether having 3 to 12 carbon atoms, ketone having 3 to 12 carbon atoms, ester having 3 to 12 carbon atoms and halogenated hydrocarbon having 1 to 6 carbon atoms.

The ether, ketone and ester may have a cyclic structure. Also usable are such compounds that have two or more of any of the functional groups of ether, ketone and ester (that is, —O—, —CO— and —COO—) as the organic solvent. The organic solvent may have another functional group such as an alcoholic hydroxyl group. In the case of an organic solvent having two types or more functional groups, preferably it has carbon atoms within a range of the above-described preferred carbon atoms of the solvent having any one of the functional groups.

Examples of the ether having 3 to 12 carbon atoms include diisopropyl ether, dimethoxymethane, dimethoxyethane, 1,4-dioxane, 1,3-dioxolan, tetrahydrofuran, anisole and phenetole.

Examples of the ketone having 3 to 12 carbon atoms include acetone, methyl ethyl ketone, diethyl ketone, diisobutyl ketone, cyclohexanone and methylcyclohexanone.

Examples of the ester having 3 to 12 carbon atoms include ethyl formate, propyl formate, pentyl formate, methyl acetate, ethyl acetate and pentyl acetate.

Examples of the organic solvent having two types or more functional groups include 2-ethoxyethyl acetate, 2-methoxyethanol and 2-butoxy ethanol.

Among the halogenated hydrocarbon having 1 to 6 carbon atoms, the number of carbon atoms is preferably 1 or 2, more preferably 1. The halogen of the halogenated hydrocarbon is preferably chlorine. In the halogenated hydrocarbon, the ratio of substituted hydrogen atoms with a halogen is preferably 25 to 75% by mol, more preferably 30 to 70% by mol, further preferably 35 to 65% by mol, most preferably 40 to 60% by mol. Methylene chloride is the representative halogenated hydrocarbon.

Two types or more organic solvents may be used in a mixture.

The cellulose acylate solution (dope) can be prepared by such a common method including treatment at a temperature of 0° C. or higher (ordinary temperature or high temperatures). The preparation of the cellulose acylate solution can be carried out using a method and apparatus for preparing a dope in a usual solvent casting method. In a common method, the use of halogenated hydrocarbon (especially methylene chloride) is preferred as an organic solvent.

The amount of cellulose acylate in the cellulose acylate solution is adjusted so as to be contained in 10 to 40% by mass in the solution to be obtained. The amount of cellulose acylate is further preferably 10 to 30% by mass. In the organic solvent (main solvent), any of after-mentioned additives may have been added.

The cellulose acylate solution can be prepared, for example, by stirring cellulose acylate and an organic solvent at ordinary temperature (0 to 40° C.). A solution having a high concentration may be stirred under pressurized and heated conditions. Specifically, cellulose acylate and an organic solvent are put and sealed in a pressurizable vessel, which are stirred under pressure with heating within a temperature range from the boiling point of the solvent under ordinary pressure to a temperature that does not boil the solvent. The heating temperature is usually 40° C. or higher, preferably 60 to 200° C., more preferably 80 to 110° C.

Respective components may be put in the vessel after having been roughly mixed. Or, they may be put in the vessel sequentially. The vessel must be constituted so that the components can be stirred. The vessel can be pressurized by injecting an inert gas such as nitrogen gas. Further, vapor pressure rising of the solvent caused by heating may be utilized. Or, after sealing the vessel, respective components may be added under pressure.

When carrying out heating, heating from the outside of the vessel is preferred. For example, a heating apparatus of a jacket type can be used. Or, by arranging a plate heater outside the vessel and arranging a pipe to circulate liquid, the heating of the whole vessel is also possible.

The stirring is preferably carried out by arranging stirring blades inside the vessel and use the same to stir. The stirring blades preferably have a length that reaches near the wall of the vessel. It is preferable to arrange a scraping blade at the end of the stirring blades in order to renew a liquid film on the wall of the vessel.

The vessel may be provided with gauges such as a pressure gauge and a thermometer. In the vessel, respective components are dissolved in the solvent. The prepared dope is taken out of the vessel after cooling, or is cooled using a heat exchanger or the like after being taken out of the vessel.

The cellulose acylate solution can be also prepared by a cooling dissolution method. In a cooling dissolution method, cellulose acylate can be also dissolved in an organic solvent in which dissolving the cellulose acylate is difficult by an ordinary dissolution method. In this connection, there is such an advantage that even a solvent capable of dissolving cellulose acylate by an ordinary dissolution method can give a homogeneous solution rapidly by a cooling dissolution method.

In a cooling dissolution method, first, cellulose acylate is gradually added into an organic solvent with stirring at room temperature. The amount of the cellulose acylate is adjusted preferably to give a concentration of 10 to 40% by mass in the mixture. The amount of the cellulose acylate is more preferably 10 to 30% by mass. Further, to the mixture, after-mentioned any additives may have been added.

Next, the mixture is cooled to, for example, −100 to −10° C. (preferably −80 to −10° C., further preferably −50 to −20° C., most preferably −50 to −30° C.). The cooling can be carried out in, for example, a dry ice/methanol bath (−75° C.) or a cooled diethylene glycol solution (−30 to −20° C.) By cooling, the mixture of the cellulose acylate and the organic solvent solidifies.

The cooling rate is preferably 4° C./min or greater, more preferably 8° C./min or greater, further preferably 12° C./min or greater. A greater cooling rate is more preferred, but 10000° C./sec is the theoretical upper limit, 1000° C./sec is the technical upper limit, and 100° C./sec is the practical upper limit. The cooling rate is a value obtained by dividing the difference between a temperature at the beginning of the cooling and a finally cooled temperature by the time period from the beginning of the cooling up to the achievement of a finally cooled temperature.

Further, when the cooled mixture is heated to, for example, 0 to 200° C. (preferably 0 to 150° C., further preferably 0 to 120° C., most preferably 0 to 50° C.), the cellulose acylate dissolves in the organic solvent. The mixture may be only left at room temperature or heated in a warm bath, to rise the temperature. The rate of temperature rise is preferably 4° C./min or greater, further preferably 8° C./min or greater, and most preferably 12° C./min or greater. A greater rate of temperature rise is more preferred, but 10000° C./sec is the theoretical upper limit, 1000° C./sec is the technical upper limit, and 100° C./sec is the practical upper limit. The rate of temperature rise is a value obtained by dividing the difference between a temperature at the beginning of the temperature rise and a finally risen temperature by the time period from the beginning of temperature rise up to achievement of a finally risen temperature.

In the above-described way, a homogeneous cellulose acylate solution is obtained. When dissolution is insufficient, the operation of the cooling and the heating may be repeated. Whether or not the dissolution is sufficient can be determined only by observing visually the appearance of the solution.

In the cooling dissolution method, in order to avoid the interfusion of water that is caused by dew formation at cooling, the use of a sealable vessel is desirable. Moreover, such a cooling/heating operation as cooling while adding the pressure and heating while reducing the pressure can shorten the dissolution time. In order to practice adding/reducing the pressure, the use of a pressure-resistant vessel is desirable.

Incidentally, a solution of 20% by mass that is prepared by dissolving cellulose acetate (acetylation degree: 60.9%, viscosity average molecular weight: 299) in methyl acetate by a cooling dissolution method has a pseudo-phase transition point for a sol state and a gel state at around 33° C., according to measurement with a differential scanning calorimeter (DSC), and shows a homogeneous gel state at the temperature or lower. Accordingly, it is preferred to store the solution at the pseudo-phase transition point or higher, more preferably a temperature around a gel phase transition temperature+10° C. In this connection, the pseudo-phase transition point varies depending on the acetylation degree or the viscosity average polymerization degree of cellulose acylate, the concentration of the solution, and an organic solvent to be used.

From the prepared cellulose acylate solution (dope), a cellulose acylate film is produced by a solvent casting method. The dope is cast on a drum or a band, from which the solvent is evaporated to form a film. The concentration of the dope before casting is preferably adjusted to give a solid content of 18 to 35%. The surface of the drum or the band has been preferably finished in a mirror-like condition. The dope is preferably cast on a drum or a band having a surface temperature of 10° C. or lower.

For the drying method in a solvent casting method, there are descriptions in U.S. Pat. Nos. 2,336,310, 2,367,603, 2,492,078, 2,492,977, 2,492,978, 2,607,704, 2,739,069 and 2,739,070, GB Patent Nos. 640731 and 736892, JP-B-45-4554, JP-B-49-5614, JP-A-60-176834, JP-A-60-203430 and JP-A-62-115035. The drying on a band or a drum can be carried out by blowing air or such an inert gas as nitrogen.

The obtained film can be peeled off from the drum or band and dried further by a high temperature air whose temperature is gradually altered from 100 to 160° C. to evaporate the residual solvent. The method is described in JP-B-5-17844. According to the method, it is possible to shorten the time from the casting to the peeling off. In order to practice the method, the gelation of the dope at the surface temperature of the drum or band at casting is necessary.

Prepared cellulose acylate solution (dope) may be used for casting two or more layers to form a film. In this case, it is preferred to form a cellulose acylate film by a solvent casting method. The dope is cast on a drum or a band, from which the solvent is evaporated to form a film. The concentration of the dope before the casting is adjusted preferably to have a solid content within the range of 10 to 40% by mass. The surface of the drum or the band has been preferably finished in a mirror-like condition.

When casting plural cellulose acylate liquids for two or more layers, casting of plural cellulose acylate solutions is possible. A film may be formed by casting and laminating respective solutions including cellulose acylate from plural casting openings that are disposed in the traveling direction of a support with intervals. Methods described in, for example, JP-A-61-158414, JP-A-1-122419 and JP-A-11-198285 can be employed. A film may be also formed by casting cellulose acylate solutions from two casting openings. This can be practiced according to methods described in, for example, JP-B-60-27562, JP-A-61-94724, JP-A-61-947245, JP-A-61-104813, JP-A-61-158413 and JP-A-6-134933. Further, a casting method of cellulose acylate film described in JP-A-56-162617, in which flow of a cellulose acylate solution with a high viscosity is encompassed by a cellulose acylate solution with a low viscosity and the cellulose acylate solutions with a high/low viscosity are extruded at the same time, may be employed.

Further, a film may be formed using two casting openings, wherein a film is formed on a support by a first casting opening and peeled off, followed by carrying out a second casting on the side of the film having contacted with the support face. This is the method described in, for example, JP-B-44-20235.

For the cellulose acylate solutions to be cast, the same type solutions may be used, or two or more different types of cellulose acylate solutions may be used. In order to give respective functions to plural cellulose acylate layers, each of cellulose acylate solutions corresponding to the functions may be extruded from respective casting openings. Furthermore, the cellulose acylate solution in the invention can be simultaneously cast with other functional layers (e.g., an adhesive layer, dye layer, antistatic layer, antihalation layer, UV absorbing layer, polarizer).

In the case of a conventional liquid for a single layer, it was necessary to extrude a cellulose acylate solution with a high concentration and a high viscosity in order to give a necessary film thickness, which often resulted in such problem that the cellulose acylate solution had a poor stability to generate a solid material, thereby leading to fisheye failure or bad flat surface property. In order to solve the problem, by casting plural cellulose acylate solutions from casting openings, solutions with a high viscosity can be simultaneously extruded on a support, thereby making it possible to form a film having an improved flat surface property and excellent surface conditions, as well as to achieve lowering in drying load by the use of concentrated cellulose acylate solutions, and to increase production speed of the film.

To the cellulose acylate film, a degradation inhibitor (e.g., an oxidation inhibitor, peroxide decomposition agent, radical inhibitor, metal inactivator, acid trapping agent, amine) may be added. About the degradation inhibitor, there are descriptions in JP-A-3-199201, JP-A-5-1907073, JP-A-5-194789, JP-A-5-271471, JP-A-6-107854. The addition amount of the degradation inhibitor is preferably 0.01 to 1% by mass of the solution (dope) to be prepared, further preferably 0.01 to 0.2% by mass. The addition amount of 0.01% by mass or more allows the degradation inhibitor to exert the effect sufficiently, which is preferred. The addition amount of 1% by mass or less hardly allows the degradation inhibitor to bleed out (weep) to the film surface, which is preferred. Examples of the especially preferred degradation inhibitor include butylated hydroxytoluene (BHT) and tribenzylamine (TBA).

These steps of from the casting to the post-drying may be carried out under either air atmosphere or inert gas atmosphere such as of nitrogen gas. A winding machine used for producing the cellulose acylate film in the invention may be one that is used commonly. The film can be wound by such a winding method as a constant tension method, a constant torque method, a tapered tension method, or a programmed tension controlling method of constant internal stress.

### [Thickness of Polymer Film]

The thickness of the polymer film of the invention is preferably 10 μm to 200 μm, more preferably 20 μm to 150 μm, further preferably 30 μm to 100 μm.

### [Saponification]

The polymer film of the invention may be subjected to an alkali saponification treatment, thereby improving the adhesion to a polarizer material such as a polyvinyl alcohol, to be uses as the polarizing plate protective films.

The alkali saponification treatment of the polymer films is preferably such that a film surface is soaked in an alkali solution, neutralized by an acidic solution, washed with water, and dried. The alkali solution may be a potassium hydroxide solution or a sodium hydroxide solution, and the hydroxide ion concentration thereof is preferably 0.1 to 5.0 mol/L, more preferably 0.5 to 4.0 mol/L. The temperature of the alkali solution is preferably within a range of room temperature to 90° C., more preferably within a range of 40 to 70° C.

### <Production of Polarizing Plate>

### (Polarizer)

A polarizer used in a polarizing plate in the invention is described below.

In the invention, the polarizer is preferably composed of a polyvinyl alcohol (PVA) and a dichroic molecule, and may be a polyvinylene polarizer prepared by subjecting a PVA or polyvinyl chloride to dehydration or dechlorination and by aligning the generated polyene structure as described in JP-A-11-248937.

The PVA is preferably a polymer material obtained by saponifying a polyvinyl acetate, and may contain a component capable of copolymerizing with vinyl acetate, such as an unsaturated carboxylic acid, an unsaturated sulfonic acid, an olefin, or a vinyl ether. Further, modified PVAs having an acetoacetyl group, sulfonic acid group, carboxyl group, oxyalkylene group, etc. may be used in the invention.

The saponification degree of the PVA is not particularly limited, and is preferably 80 to 100 mol %, particularly preferably 90 to 100 mol %, from the viewpoint of solubility, etc. The polymerization degree of the PVA is not particularly limited, preferably 1,000 to 10,000, particularly preferably 1,500 to 5,000.

It is preferred that the syndiotacticity of the PVA is 55% or more in view of improving the durability as described in Japanese Patent No. 2978219. It is also preferred that the syndiotacticity is 45 to 52.5% as described in Japanese Patent No. 3317494.

It is preferred that the PVA is formed into a film and then a dichroic molecule is introduced to prepare the polarizer. Generally the PVA film is preferably produced by casting a liquid prepared by dissolving a PVA-based resin in water or an organic solvent. The polyvinyl alcohol-based resin concentration of the liquid is generally 5 to 20% by mass, and a 10 to 200-μm-thick PVA film may be formed by casting the liquid. The PVA film can be produced with reference to Japanese Patent No. 3342516, JP-A-09-328593, JP-A-2001-302817, JP-A-2002-144401, etc.

The crystallinity degree of the PVA film is not particularly limited. The average crystallinity degree (Xc) may be 50 to 75% by mass as described in Japanese Patent No. 3251073, and the crystallinity degree may be 38% or less to reduce the in-plane hue unevenness as described in JP-A-2002-236214.

The PVA film preferably has a small birefringence (Δn), and the birefringence is preferably 1.0×10⁻³ or less as described in Japanese Patent No. 3342516. The birefringence of the PVA film may be 0.002 to 0.01 to obtain a high polarization degree while preventing breakage of the PVA film in the stretching step as described in JP-A-2002-228835. Further, the value of (nx+ny)/2−nz may be 0.0003 to 0.01 as described in JP-A-2002-060505. The Re(1090) of the PVA film is preferably 0 to 100 nm, further preferably 0 to 50 nm. Further, the Rth(1090) of the PVA film is preferably 0 to 500 nm, further preferably 0 to 300 nm.

Additionally, a PVA film having a bonding 1,2-glycol amount of 1.5 mol % or less described in Japanese Patent No. 3021494, a PVA film having 500 or less optically foreign substances of 5 μm or more in size per 100 cm² described in JP-A-2001-316492, a PVA film having a hot water breaking temperature of 1.5° C. or lower in the TD direction described in JP-A-2002-030163, and a PVA film prepared from a solution containing 1 to 100 parts by mass of 3 to 6-polyvalent alcohol such as glycerin or 15% by mass or more of a plasticizer described in JP-A-06-289225 can be preferably used for the polarizing plate in the invention.

The film thickness of the unstretched PVA film is not particularly limited, preferably 1 μm to 1 mm, particularly preferably 20 to 200 μm from the viewpoint of the film stability and uniform stretching. Such a thin PVA film that 10 N or less of stress is generated in the stretching in water at a ratio of 4 to 6 times may be used as described in JP-A-2002-236212.

The dichroic molecule may be a higher iodine ion such as I₃⁻ or I₅⁻, or a dichroic dye. The higher iodine ion is particularly preferably used in the invention. The higher iodine ion can be generated such that the PVA is soaked in a liquid prepared by dissolving iodine in an aqueous potassium iodide solution and/or an aqueous boric acid solution to adsorb the iodine to the PVA as described in Henkoban no Oyo, Ryo Nagata, CMC and Kogyo Zairyo, Vol. 28, No. 7, Page 39 to 45.

In the case of using the dichroic dye as the dichroic molecule, the dichroic dye is preferably an azo dye, particularly preferably a bisazo or trisazo dye. The dichroic dye is preferably water-soluble, and thus a hydrophilic substituent such as a sulfonic acid group, an amino group, or a hydroxyl group is preferably introduced to a dichroic molecule, to generate a free acid, an alkaline metal salt, an ammonium salt, or an amine salt.

Specific examples of the dichroic dyes include benzidine dyes such as C.I. Direct Red 37, Congo Red (C.I. Direct Red 28), C.I. Direct Violet 12, C.I. Direct Blue 90, C.I. Direct Blue 22, C.I. Direct Blue 1, C.I. Direct Blue 151, and C.I. Direct Green 1; diphenylurea dyes such as C.I. Direct Yellow 44, C.I. Direct Red 23, and C.I. Direct Red 79; stilbene dyes such as C.I. Direct Yellow 12; dinaphtylamine dyes such as C.I. Direct Red 31; J acid dyes such as C.I. Direct Red 81, C.I. Direct Violet 9, and C.I. Direct Blue 78.

In addition, the dichroic dyes preferably used in the invention include C.I. Direct Yellow 8, C.I. Direct Yellow 28, C.I. Direct Yellow 86, C.I. Direct Yellow 87, C.I. Direct Yellow 142, C.I. Direct Orange 26, C.I. Direct Orange 39, C.I. Direct Orange 72, C.I. Direct Orange 106, C.I. Direct Orange 107, C.I. Direct Red 2, C.I. Direct Red 39, C.I. Direct Red 83, C.I. Direct Red 89, C.I. Direct Red 240, C.I. Direct Red 242, C.I. Direct Red 247, C.I. Direct Violet 48, C.I. Direct Violet 51, C.I. Direct Violet 98, C.I. Direct Blue 15, C.I. Direct Blue 67, C.I. Direct Blue 71, C.I. Direct Blue 98, C.I. Direct Blue 168, C.I. Direct Blue 202, C.I. Direct Blue 236, C.I. Direct Blue 249, C.I. Direct Blue 270, C.I. Direct Green 59, C.I. Direct Green 85, C.I. Direct Brown 44, C.I. Direct Brown 106, C.I. Direct Brown 195, C.I. Direct Brown 210, C.I. Direct Brown 223, C.I. Direct Brown 224, C.I. Direct Black 1, C.I. Direct Black 17, C.I. Direct Black 19, C.I. Direct Black 54, and dyes described in JP-A-62-70802, JP-A-1-161202, JP-A-1-172906, JP-A-1-172907, JP-A-1-183602, JP-A-1-248105, JP-A-1-265205, and JP-A-7-261024. Two or more dichroic dyes may be used in combination to obtain various hues. In the case of using the dichroic dye, the adsorption thickness may be 4 μm or more as described in JP-A-2002-082222.

The ratio of the dichroic molecule to the film matrix of the polyvinyl alcohol-based polymer is generally controlled within a range of 0.01 to 5% by mass. Too low dichroic molecule content results in reduction of polarization degree, and excessively high dichroic molecule content results in reduction of the single-plate transmittance.

The thickness of the polarizer is preferably 5 to 40 μm, more preferably 10 to 30 μm. Further, it is preferred that the thickness ratio of the polarizer to the protective film satisfies the condition of 0.01≦A (Polarizer thickness)/B (Protective film thickness)≦0.16 as described in JP-A-2002-174727.

Further, the crossing angle between the slow axis of the protective film and the absorption axis of the polarizer may be any one, and it is preferred that the axes are parallel or the crossing angle is an azimuthal angle of 45±200.

### <Production of Polarizing Plate>

Processes for producing the polarizing plate in the invention are described below.

In the invention, the polarizing plate is preferably produced by a method having a swelling step, dyeing step, hardening step, stretching step, drying step, protective film attaching step, and attached film drying step. The order of the dyeing, hardening, and stretching steps may be changed, and some steps may be combined and simultaneously carried out. It is preferred that the film is water-washed after the hardening step as described in Japanese Patent No. 3331615.

In the invention, the swelling, dyeing, hardening, stretching, drying, protective film attaching, and attached film drying steps are particularly preferably carried out in this order. On-line surface evaluation may be carried out in or after the steps.

Though the swelling step is preferably carried out using only water, a polarizing plate matrix may be swelled by an aqueous boric acid solution, thereby controlling the swelling degree to improve the optical performance stability and prevent wrinkling of the matrix in the production line as described in JP-A-10-153709.

The temperature and time of the swelling may be any one, and are preferably 10 to 60° C. and 5 to 2,000 seconds.

The dyeing step may be carried out using a method described in JP-A-2002-86554. The dyeing may be achieved by soaking, application or spraying of an iodine or dye solution, etc. Further, the dyeing may be carried out while controlling the iodine concentration, dyeing bath temperature, and stretch ratio in the bath and while stirring the solution in the bath as described in JP-A-2002-290025.

In the case of using the higher iodine ion as the dichroic molecule, in the dyeing step, a solution prepared by dissolving iodine in an aqueous potassium iodide solution is preferably used to obtain a high-contrast polarizing plate. It is preferred that, in the aqueous iodine-potassium iodide solution, the iodine concentration is 0.05 to 20 g/l, the potassium iodide concentration is 3 to 200 g/l, and the mass ratio of iodine and potassium iodide is 1 to 2,000. The dyeing time is preferably 10 to 1,200 seconds, and the solution temperature is preferably 10 to 60° C. It is more preferred that the iodine concentration is 0.5 to 2 g/l, the potassium iodide concentration is 30 to 120 g/l, the mass ratio of iodine and potassium iodide is 30 to 120, the dyeing time is 30 to 600 seconds, and the solution temperature is 20 to 50° C.

A boron compound such as boric acid or borax may be added to the dyeing solution as described in Japanese Patent No. 3145747.

In the hardening step, the intermediate film is preferably soaked in a crosslinking agent solution or coated with the solution, thereby adding a crosslinking agent to the film. The hardening step may be carried out in several batches as described in JP-A-11-52130.

The crosslinking agent may be an agent described in U.S. Reissue Pat. No. 232,897. Also a boron compound such as boric acid or borax may be used as the crosslinking agent. The crosslinking agent is most preferably a boric acid compound though it may be a polyvalent aldehyde for increasing the dimension stability as described in Japanese Patent No. 3357109. In the case of using boric acid as the crosslinking agent in the hardening step, a metal ion may be added to an aqueous boric acid-potassium iodide solution. A compound containing the metal ion is preferably zinc chloride, and zinc salts including zinc halides such as zinc iodide, zinc sulfate, and zinc acetate may be used instead of zinc chloride as described in JP-A-2000-35512.

In the invention, the PVA film is preferably hardened by soaking the film in an aqueous boric acid-potassium iodide solution containing zinc chloride. It is preferred that the boric acid concentration is 1 to 100 g/l, the potassium iodide concentration is 1 to 120 g/l, the zinc chloride concentration is 0.01 to 10 g/l, the hardening time is 10 to 1,200 seconds, and the solution temperature is 10 to 60° C. It is more preferred that the boric acid concentration is 10 to 80 g/l, the potassium iodide concentration is 5 to 100 g/l, the zinc chloride concentration is 0.02 to 8 g/l, the hardening time is 30 to 600 seconds, and the solution temperature is 20 to 50° C.

In the stretching step, a vertical monoaxial stretching method described in U.S. Pat. No. 2,454,515, etc. and a tentering method described in JP-A-2002-86554 can be preferably used. The stretch ratio is preferably 2 to 12 times, more preferably 3 to 10 times. It is preferred that the stretch ratio, the film thickness, and the polarizer thickness satisfies the condition of (Thickness of protective film-attached polarizer/Thickness of film)×(Total stretch ratio)>0.17 as described in JP-A-2002-040256, and that the width of the polarizer taken from final bath and the width of the polarizer at the time of attaching the protective film satisfies the condition of 0.80≦(Width of polarizer at attaching protective film/Width of polarizer taken from final bath)≦0.95, as described in JP-A-2002-040247.

In the drying step, a known method described in JP-A-2002-86554 may be used, and the drying temperature is preferably 30 to 100° C., and the drying time is preferably 30 seconds to 60 minutes. It is also preferred that a heat treatment for controlling an in-water discoloring temperature at 50° C. or higher is carried out as described in Japanese Patent No. 3148513, and that an aging treatment under controlled temperature and humidity is carried out as described in JP-A-07-325215 and JP-A-07-325218.

In the protective film attaching step, 2 protective films are bonded to both sides of the polarizer after the drying step. It is preferred that an adhesive liquid is applied immediately before the bonding, and the polarizer is sandwiched between and bonded to the protective films by a couple of rollers. It is preferred that the water content of the polarizer is controlled at the time of the bonding, to prevent concavity and convexity like grooves in a record due to the stretching as described in JP-A-2001-296426 and JP-A-2002-86554. In the invention, the water content is preferably 0.1 to 30%.

The adhesive for bonding the polarizer and the protective films is not particularly limited, and examples thereof include PVA-based resins (including PVAs modified with an acetoacetyl group, a sulfonic acid group, a carboxyl group, an oxyalkylene group, etc.) and aqueous boron compound solutions. The adhesive is preferably the PVA-based resin. The thickness of the dried adhesive layer is preferably 0.01 to 5 μm, particularly preferably 0.05 to 3 μm.

It is preferred that, to increase the adhesive strength between the polarizer and the protective films, the protective films are surface-treated to be hydrophilic, and then bonded to the polarizer. The surface treatment is not particularly restricted and may be a known treatment such as a saponification treatment using an alkali solution or a corona treatment. Further, a highly adhesive layer such as a gelatin undercoat layer may be formed after the surface treatment. It is preferred that the contact angle of the protective film surface against water is 50° or less as described in JP-A-2002-267839.

The conditions of drying after the bonding may be those described in JP-A-2002-86554, and the drying temperature is preferably 30 to 100° C. and the drying time is preferably 30 seconds to 60 minutes. Further, it is preferred that an aging treatment under controlled temperature and humidity is carried out as described in JP-A-07-325220.

Each element content of the polarizer is preferably such that the iodine content is 0.1 to 3.0 g/m², the boron content is 0.1 to 5.0 g/m², the potassium content is 0.1 to 2.00 g/m², and the zinc content is 0 to 2.00 g/m². The potassium content may be 0.2% by mass or less as described in JP-A-2001-166143, and the zinc content may be 0.04% to 0.5% by mass as described in JP-A-2000-035512.

An organic titanium compound and/or an organic zirconium compound may be added to the film in any of the dyeing, stretching, and hardening steps, to increase the dimension stability of the polarizing plate, as described in Japanese Patent No. 3323255. Further, a dichroic dye may be added to control the hue of the polarizing plate.

### <Properties of Polarizing Plate>

### (1) Transmittance and Polarization Degree

In the invention, the single-plate transmittance of the polarizing plate is preferably 42.5% to 49.5%, more preferably 42.8% to 49.0%. The polarization degree defined by the following Equation 4 is preferably 99.900% to 99.999%, more preferably 99.940% to 99.995%. The parallel transmittance is preferably 36% to 42%, and the perpendicular transmittance is preferably 0.001% to 0.05%.

Polarization degree(%)=√{(Pa−Pe)/(Pa+Pe)} Equation 1

Pa: Parallel transmittance
Pe:Perpendicular transmittance

The transmittance is defined by the following equation in accordance with JIS Z8701.

T=∫S(λ)y(λ)τ(λ)dλ

In the equation, K, S(λ), y(λ), and τ(τ) are as follows.

$$K = \frac{100}{\int S ( λ ) y ( λ ) d λ} \qquad Equation 3$$

S(λ): Spectral distribution of standard light for color display
y(λ): Color matching function in XYZ system
τ(λ): Spectral transmittance

The dichroic ratio defined by the following Equation 5 is preferably 48 to 1215, more preferably 53 to 525.

$$Dichroic ratio ( Rd ) = \frac{log [ \frac{\begin{matrix}Single \text{-} plate \\ transmittance\end{matrix}}{100} ( 1 - \frac{\begin{matrix}Polarization \\ degree\end{matrix}}{100} ) ]}{log [ \frac{\begin{matrix}Single \text{-} plate \\ transmittance\end{matrix}}{100} ( 1 + \frac{\begin{matrix}Polarization \\ degree\end{matrix}}{100} ) ]} \qquad Equation 5$$

The iodine concentration and the single-plate transmittance may be in ranges described in JP-A-2002-258051, Paragraph 0017.

The wavelength dependency of the parallel transmittance may be lower as described in JPA-2001-083328 and JP-A-2002-022950. In the case of placing the polarizing plate in the crossed nicols state, the optical property may be in a range described in JP-A-2001-091736, Paragraph 0007, and the relation between the parallel transmittance and the perpendicular transmittance may be in a range described in JP-A-2002-174728, Paragraph 0006.

As described in JP-A-2002-221618, in a light wavelength range of 420 to 700 nm, the standard deviation of parallel transmittance of every 10 nm may be 3 or less, and the minimum values of (Parallel transmittance/Perpendicular transmittance) of every 10 nm may be 300 or more.

Also it is preferred that the parallel transmittance and the perpendicular transmittance of the polarizing plate at a wavelength of 440 nm, those at a wavelength of 550 nm, and those at a wavelength of 610 nm are within ranges described in JP-A-2002-258042, Paragraph 0012 or JP-A-2002-258043, Paragraph 0012.

### (2) Hue

The hue of the polarizing plate in the invention is preferably evaluated by using a lightness index L* and chromaticness indexes a* and b* of the L*a*b* calorimetric system with a CIE uniform color space.

Definitions of L*, a*, and b* are described in Shikisai Kogaku, Tokyo Denki University Press, etc.

The a* of one polarizing plate is preferably −2.5 to 0.2, more preferably −2.0 to 0. The b* of one polarizing plate is preferably 1.5 to 5, more preferably 2 to 4.5. The a* of a parallel transmitted light in two polarizing plates is preferably −4.0 to 0, more preferably −3.5 to −0.5. The b* of a parallel transmitted light in two polarizing plates is preferably 2.0 to 8, more preferably 2.5 to 7. The a* of a perpendicular transmitted light in two polarizing plates is preferably −0.5 to 1.0, more preferably 0 to 2. The b* of a perpendicular transmitted light in two polarizing plates is preferably −2.0 to 2, more preferably −1.5 to 0.5.

The hue may be evaluated by chromaticity coordinates (x, y) calculated from the above X, Y, and Z. For example, it is preferred that the parallel transmitted light chromaticity (xₚ, yₚ) and the perpendicular transmitted light chromaticity (xₚ, yₚ) of two polarizing plates are within ranges described in JP-A-2002-214436, Paragraph 0017, JP-A-2001-166136, Paragraph 0007, or JP-A-2002-169024, Paragraph 0005 to 0008, and that the relation between the hue and absorbance is within a range described in JP-A-2001-311827, Paragraph 0005 to 0006.

### (3) Viewing Angle Properties

It is preferred that, when the polarizing plate is disposed in the crossed nicols state and a light having a wavelength of 550 nm is injected thereinto, the transmittance ratio and the xy chromaticity differences between a vertically light injection and a light injected from an angle of 45° against the polarizing axis at an angle of 40° against the normal line are within ranges described in JP-A-2001-166135 or JP-A-2001-166137. It is preferred that the ratio T₆₀/T₀, in which T₀ is a light transmittance of a polarizing plate stack placed in the crossed nicols state in the vertically direction and T₆₀ is a light transmittance in the direction at an angle of 60° against the normal line of the stack, is 10,000 or less as described in JP-A-10-068817. It is preferred also that, in a case where a natural light is injected to the polarizing plate from the normal line direction or at an elevation angle of 80° or less, the transmittance difference of transmitted lights is 6% or less in 20 nm within a transmission spectrum wavelength range of 520 to 640 nm as described in JP-A-2002-139625. Further, it is preferred that the brightness difference of the transmitted lights between regions 1 cm away from each other is 30% or less as described in JP-A-08-248201.

### (4) Durability

### (4-1) Temperature and Humidity Durability

When the light transmittance and polarization degree are measured before and after the polarizing plate is left under a temperature of 60° C. and a relative humidity of 95% for 500 hours, the change of the light transmittance and polarization degree are preferably 3% or less based on the absolute values. The change of the light transmittance is particularly preferably 2% or less, and the change of the polarization degree is particularly preferably 1.0% or less, based on the absolute values. Further, it is preferred that the polarizing plate has a polarization degree of 95% or more and a single transmittance of 38% or more after the polarizing plate is left under a temperature of 80° C. and a relative humidity of 90% for 500 hours as described in JP-A-07-077608.

### (4-2) Dry Durability

When the light transmittance and polarization degree are measured before and after the polarizing plate is left under a dry condition at 80° C. for 500 hours, the change of the light transmittance and polarization degree are preferably 3% or less based on the absolute values. The change of the light transmittance is particularly preferably 2% or less, and the change of the polarization degree is particularly preferably 1.0% or less, furthermore preferably 0.1% or less, based on the absolute values.

### (4-3) Other Durability

Further, it is preferred that the shrinkage ratio of the polarizing plate by leaving the polarizing plate at 80° C. for 2 hours is 0.5% or less as described in JP-A-06-167611. Also it is preferred that, when a stack is prepared by disposing the polarizing plates on the both sides of a glass plate in the crossed nicols state and left at 69° C. for 750 hours, x and y values of the stack are within ranges described in JP-A-10-068818 after the leaving. Furthermore, it is preferred that, when the polarizing plate is left at 80° C. under a relative humidity of 90% for 200 hours, the change of spectral intensity ratio between 105 cm⁻¹ and 157 cm⁻¹ obtained by Raman spectroscopy is within a range described in JP-A-08-094834 or JP-A-09-197127.

### (5) Alignment Degree

More excellent polarization performance is achieved as the alignment degree of the PVA is increased. The alignment degree calculated as order parameter values by polarized Raman scattering or polarized FT-IR, etc. is preferably 0.2 to 1.0. Also it is preferred that difference between an alignment coefficient of a high-molecular segment in the entire amorphous region of the polarizer and an alignment coefficient of occupying molecules (0.75 or more) is at least 0.15 as described in JP-A-59-133509. Further, it is preferred that the alignment coefficient of the amorphous region in the polarizer is 0.65 to 0.85 or that the alignment degree of the higher iodine ion such as I₃⁻ and I₅⁻ is 0.8 to 1.0 as an order parameter value as described in JP-A-04204907.

### (6) Other Properties

It is preferred that the shrinkage force per unit width in the absorption axis direction is 4.0 N/cm or less when the polarizing plate is heated at 80° C. for 30 minutes as described in JP-A-2002-006133, that the dimension changes of the polarizing plate in the absorption axis direction and the polarizing axis direction are both within 0.6% when the polarizing plate is heated at 70° C. for 120 hours as described in JP-A-2002-236213, and that the water content of the polarizing plate is 3% by mass or less as described in JP-A-2002-090546. Further, it is preferred that the surface roughness in a direction vertically to the stretching axis is 0.04 μm or less based on the center line average roughness as described in JP-A-2000-249832, that the refractive index no in the transmission axis direction is 1.6 or more as described in JP-A-10-268294, and that the relation between the polarizing plate thickness and the protective film thickness is within a range described in JP-A-10-111411, Paragraph 0004.

### <Functionalization of Polarizing Plate>

The polarizing plate used in the invention may be preferably used as a functionalized polarizing plate by combining with an antireflection film for increasing visibility of the display, a brightness increasing film, or an optical film having a functional layer such as a hard coating layer, a forward scattering layer, or an antiglare (antidazzle) layer.

### (Antireflection Film)

The polarizing plate used in the invention may be used in combination with an antireflection film. The antireflection film may be a film with a reflectivity of about 1.5% composed of a single layer of a low refractive material such as a fluorine polymer, or a film with a reflectivity of about 1% utilizing interference of thin layers. In the invention, it is preferred that a low refractive layer and at least one layer having a refractive index higher than that of the low refractive layer (a high refractive layer or an middle refractive layer) are stacked on a transparent support. Further, also antireflection films described in Nitto Giho, Vol. 38, No. 1, May 2000, Page 26 to 28, JP-A-2002-301783, etc. may be preferably used in the invention.

The refractive indexes of the layers satisfy the following relations.

Refractive index of high refractive layer>Refractive index of middle refractive layer>Refractive index of transparent support>Refractive index of low refractive layer

The transparent support used for the antireflection film may be preferably the above mentioned transparent polymer film for the protective film of the polarizer.

The refractive index of the low refractive layer is preferably 1.20 to 1.55, more preferably 1.30 to 1.50. It is preferred that the low refractive layer is used as the outermost layer having an excoriation resistance and antifouling property. It is also preferred that a silicone-containing compound or a fluorine-containing compound, etc. is used for improving the slipping property of the surface to increase the excoriation resistance.

For example, compounds described in JP-A-9-222503, Paragraph 0018 to 0026, JP-A-11-38202, Paragraph 0019 to 0030, JP-A-2001-40284, Paragraph 0027 to 0028, JP-A-2000-284102, etc. can be preferably used as the fluorine-containing compound.

The silicone-containing compound preferably has a polysiloxane structure. Reactive silicones such as SILAPLANE available from Chisso Corporation and polysiloxanes having silanol end groups described in JP-A-11-258403, etc. can be used as the compound. An organic metal compound such as a silane coupling agent and a silane coupling agent having a particular fluorine-containing hydrocarbon group may be hardened by a condensation reaction in the presence of a catalyst, as described in JP-A-58-142958, JP-A-58-147483, JP-A-58-147484, JP-A-9-157582, JP-A-1′-106704, JP-A-2000-117902, JP-A-2001-48590, JP-A-2002-53804, etc.

The low refractive layer may preferably contain another additive such as a filler (e.g. low refractive inorganic compound having an average primary particle size of 1 to 150 nm composed of silicon dioxide (silica) or a fluorine-containing compound (magnesium fluoride, calcium fluoride, barium fluoride, etc.), a fine organic particle described in JP-A-11-3820, Paragraph 0020 to 0038), a silane coupling agent, a slipping agent, or a surfactant.

The low refractive layer may be formed by a gas phase method such as a vacuum deposition method, a sputtering method, an ion plating method, or a plasma CVD method, and is preferably formed by a coating method advantageous in low costs. Preferred examples of the coating methods include dip coating methods, air-knife coating methods, curtain coating methods, roller coating methods, wire bar coating methods, gravure coating methods, and microgravure coating methods.

The thickness of the low refractive layer is preferably 30 to 200 nm, more preferably 50 to 150 nm, most preferably 60 to 120 nm.

The middle refractive layer and the high refractive layer are preferably such that high refractive inorganic compound ultrafine particles with an average particle size of 100 nm or less are dispersed in a matrix material. The high refractive inorganic compound fine particles are preferably composed of an inorganic compound having a refractive index of 1.65 or more such as an oxide of Ti, Zn, Sb, Sn, Zr, Ce, Ta, La, In, etc. or a multiple oxide containing the metal atom.

The ultrafine particles may be used such that the particle surfaces are treated with a surface treatment agent such as a silane coupling agent described in JP-A-11-295503, JP-A-11-153703, JP-A-2000-9908, etc., or an anionic compound or organic metal coupling agent described in JP-A-2001-310432, etc., such that a core-shell structure is formed by using high refractive particles as cores as described in JP-A-2001-166104, or such that a particular dispersant is used in combination as described in JP-A-11-153703, U.S. Pat. No. 6,210,858B1, JP-A-2002-2776069, etc.

The matrix material may be a known thermoplastic resin or hardening resin coating, etc., and may be a polyfunctional material described in JP-A-2000-47004, JP-A-2001-315242, JP-A-2001-31871, JP-A-2001-296401, etc. or a hardening film derived from a metal alkoxide composition described in JP-A-2001-293818, etc.

The refractive index of the high refractive layer is preferably 1.70 to 2.20. The thickness of the high refractive layer is preferably 5 nm to 10 μm, more preferably 10 nm to 1 μm.

The refractive index of the middle refractive layer is controlled at a value between those of the low refractive layer and the high refractive layer. The refractive index of the middle refractive layer is preferably 1.50 to 1.70.

The haze of the antireflection film is preferably 5% or less, more preferably 3% or less. The strength of the film is preferably H or more, more preferably 2H or more, most preferably 3H or more, in a pencil hardness test in accordance with JIS K5400.

### (Brightness Increasing Film)

In the invention, the polarizing plate may be used in combination with a brightness increasing film. The brightness increasing film has a function of separating a circular polarized light or a linearly polarized light, is placed between the polarizing plate and a backlight, and reflects or scatters a circular polarized light or linearly polarized light backward to the backlight. The light reflected by the backlight is in a partly changed polarization state, and is injected again to the brightness increasing film and the polarizing plate. In this case, a part of the light is transmitted therethrough, whereby the light utilization ratio is increased by repeating the processes to improve the front brightness about 1.4 times. In the invention, the polarizing plate may be used in combination with a known brightness increasing film such as an anisotropy reflection type film or an anisotropy scattering type film.

A known anisotropy reflection type brightness increasing film is such that uniaxially stretched films and unstretched films are stacked to enlarge the refractive index difference in the stretch direction, thereby showing a reflectivity and a transmittance anisotropy. Such brightness increasing films include multilayer films using dielectric mirror described in WO 95/17691, WO 95/17692, and WO 95/17699, and cholesteric liquid crystal films described in EP No. 606940A2 and JP-A-8-271731. In the invention, DBEF-E, DBEF-D, and DBEF-M available from 3M is preferably used as the multilayer brightness increasing film using the dielectric mirror principle, and NIPOCS available from Nitto Denko Corporation is preferably used as the cholesteric liquid crystal brightness increasing film. NIPOCS is described in Nitto Giho, Vol. 38, No. 1, May 2000, Page 19 to 21, etc.

In the invention, also an anisotropy scattering type brightness increasing film prepared by blending a positive intrinsic birefringence polymer and a negative intrinsic birefringence polymer and by uniaxial stretching, described in WO 97/32223, WO 97/32224, WO 97/32225, WO 97/32226, JP-A-9-274108, and JP-A-11-174231, is preferably used in combination. DRPF-H available from 3M is preferably used as the anisotropy scattering type brightness increasing film.

### (Other Functional Optical Film)

In the invention, the polarizing plate is preferably used in combination with a functional optical film having a hard coating layer, a forward scattering layer, an antiglare (antidazzle) layer, a gas barrier layer, a slipping layer, an antistatic layer, an undercoat layer, a protective layer, etc. Further, it is preferred that these functional layers are combined with the antireflection layer of the antireflection film or the optically anisotropic layer in one layer. These functional layers may be formed on one or both of the polarizer side and the opposite side near the air interface.

### [Hard Coating Layer]

The polarizing plate is preferably combined with a functional optical film prepared by forming a hard coating layer on a transparent support to improve the mechanical strength such as excoriation resistance. Particularly in the case of forming the hard coating layer in the above antireflection film, the hard coating layer is preferably formed between the transparent support and the high refractive layer.

The hard coating layer is preferably formed by a crosslinking reaction of a hardening compound by light and/or heat, or a polymerization reaction. A hardening functional group of the compound is preferably a photopolymerizable group, and an organic alkoxysilyl compound is preferably used as a hydrolyzable functional group-containing, organic metal compound. A hard coating layer composition described in JP-A-2002-144913, JP-A-2000-9908, and WO 00/46617, etc. is preferably used in the invention.

The thickness of the hard coating layer is preferably 0.2 to 100 μm.

The strength of the hard coating layer is preferably H or more, more preferably 2H or more, most preferably 3H or more, by a pencil hardness test in accordance with JIS K5400. Further, in a taber test according to JIS K5400, the hard coating layer more preferably has a smaller abrasion.

Compounds having an unsaturated ethylenic group and compounds having a ring opening polymerizable group can be used as materials for the hard coating layer, and the compounds may be used singly or in combination. Preferred examples of the compounds having the unsaturated ethylenic groups include polyol polyacrylates such as ethyleneglycol diacrylate, trimethylolpropane triacrylate, ditrimethylolpropane tetraacrylate, pentaerythritol triacrylate, pentaerythritol tetraacrylate, dipentaerythritol pentaacrylate, and dipentaerythritol hexaacrylate; epoxy acrylates such as diacrylate of bisphenol A diglycidyl ether and diacrylate of hexanediol diglycidyl ether; and urethane acrylates prepared by a reaction of a polyisocyanate and a hydroxyl-containing acrylate such as hydroxyethyl acrylate. Examples of commercially available compounds include EB-600, EB-40, EB-140, EB-1150, EB-1290K, IRR214, EB-2220, TMPTA, and TMPTMA available from Daicel ucb, and UV-6300 and LJV-1700B available from Nippon Synthetic Chemical Industry Co., Ltd.

Preferred examples of the compounds having a ring opening polymerizable group include glycidyl ethers such as ethylene glycol diglycidyl ether, bisphenol A diglycidyl ether, trimethylolethane triglycidyl ether, trimethylolpropane triglycidyl ether, glycerol triglycidyl ether, triglycidyl trishydroxyethyl isocyanurate, sorbitol tetraglycidyl ether, pentaerythritol tetraglycidyl ether, polyglycidyl ethers of cresol novolac resins, and polyglycidyl ethers of phenol novolac resins; alicyclic epoxys such as CELOXIDE 2021P, CELOXIDE 2081, EPOLEAD GT-301, EPOLEAD GT-401, and EHPE3150CE available from Daicel Chemical Industries, Ltd., and polycyclohexyl epoxymethyl ether of phenol novolac resins; oxetanes such as OXT-121, OXT-221, OX-SQ, and PNOX-1009 available from Toagosei Co., Ltd. Further, polymers of glycidyl(meth)acrylate, and copolymers of glycidyl(meth)acrylate and a monomer copolymerizable therewith may be used for the hard coating layer.

It is preferred that fine particles of oxides of silicon, titanium, zirconium, aluminum, etc., crosslinked particles of polyethylenes, polystyrenes, poly(meth)acrylic esters, polydimethylsiloxanes, etc., and organic crosslinked fine particles such as crosslinked rubber particles of SBR, NBR, etc. are added to the hard coating layer to reduce hardening shrinkage of the hard coating layer, increase the adhesion to the substrate, and reduce curling of the hard coating product. The average particle size of these crosslinked fine particles is preferably 1 to 20,000 nm. The shape of the crosslinked fine particles is not particularly limited, and may be a spherical shape, rod-like shape, needle-like shape, tabular shape, etc. The amount of the fine particles is preferably such that the fine particle content of the hardened hard coating layer is 60% or less by volume. The fine particle content is more preferably 40% or less by volume.

In the case of adding the above described inorganic fine particles, which are poor in affinity for binder polymers generally, a surface treatment is preferably carried out using a surface treatment agent having a metal such as silicon, aluminum, or titanium, and a functional group such as an alkoxide group, a carboxylic acid group, a sulfonic acid group, or a phosphonic acid group.

The hard coating layer is hardened preferably by heat or an activation energy ray, and more preferably by an activation energy ray such as a radioactive ray, a gamma ray, an alpha ray, an electron ray, or a ultraviolet ray, and particularly preferably by an electron ray or a ultraviolet ray in view of safeness and productivity. In the case of the heat hardening, the heating temperature is preferably 140° C. or lower, more preferably 100° C. or lower, in view of the heat resistance of the plastic.

### [Forward Scattering Layer]

The forward scattering layer is used for improving the viewing angle properties (the hue and brightness distribution) in the directions of up, down, left, and right, of the liquid crystal display device containing the polarizing plate according to the invention. In the invention, the forward scattering layer is preferably composed of fine particles with different refractive indexes dispersed in a binder. For example, the forward scattering layer may have such a structure that the forward scattering coefficient is particularly controlled as described in JP-A-11-38208, that relative refractive indexes of a transparent resin and fine particles are particularly controlled as described in JP-A-2000-199809, or that the haze is controlled at 40% o more as described in JP-A-2002-107512. Further, it is preferred that the polarizing plate is used in combination with LUMISTY described in Sumitomo Chemical Co., Ltd., Technical Report, Optical functional film, page 31 to 39 to control the haze viewing angle properties.

### [Antiglare Layer]

The antiglare (antidazzle) layer is used for scattering a reflected light to prevent glare. The antiglare function is obtained by forming concavity and convexity on the outermost surface of the liquid crystal display device. The haze of the optical film having the antiglare function is preferably 3 to 30%, more preferably 5 to 20%, most preferably 7 to 20%.

The concavity and convexity is preferably formed on the film surface by a method of adding fine particles (JP-A-2000-271878, etc.), a method of adding a small amount (0.1 to 50% by mass) of relatively large particles having a size of 0.05 to 2 μm (JP-A-2000-281410, JP-A-2000-95893, JP-A-2001-100004, JP-A-2001-281407, etc.), or a method of physically transferring the concavity and convexity to the film surface (such as a embossing method described in JP-A-63-278839, JP-A-11-183710, JP-A-2000-275401, etc.)

### <Liquid Crystal Display Device>

The liquid crystal display device of the invention is described below.

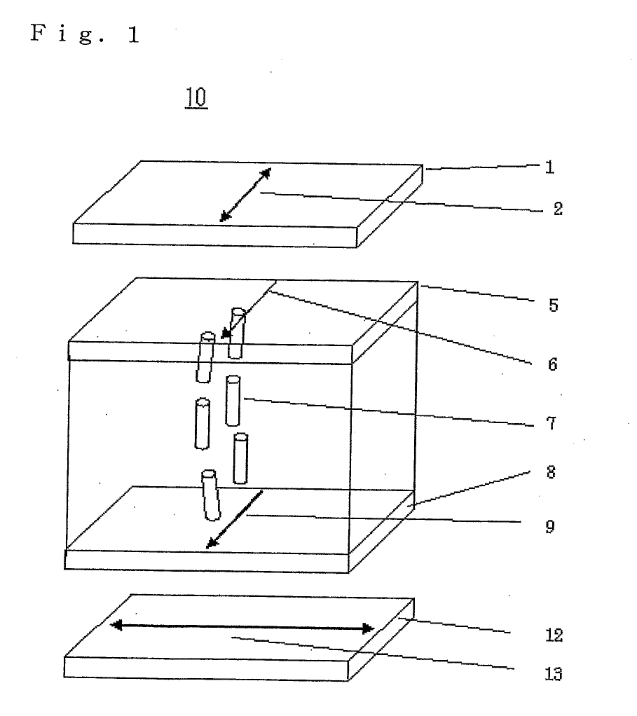

FIG. 1 is a schematic view showing an example of the liquid crystal display device according to the invention. In FIG. 1, a liquid crystal display device 10 has a liquid crystal cell containing a liquid crystal layer 7, and an upper electrode substrate 5 and a lower electrode substrate 8 disposed thereon, and has an upper polarizing plate 1 and a lower polarizing plate 12 disposed on the both sides of the liquid crystal cells. A color filter may be disposed between the liquid crystal cell and the polarizing films. When the liquid crystal display device 10 is a transmission type device, a backlight using a light source such as a cold or hot cathode fluorescent tube, a light emitting diode, a field emission device, or an electroluminescent device is disposed on the back side.

Each of the upside polarizing plate 1 and the downside polarizing plate 12 has such laminated constitution that a polarizer is interposed between two protective films, and, in a liquid crystal display device 10 of the invention, the protective film on the liquid crystal cell side of one of the polarizing plate satisfies the characteristics of the formulae (1) to (3).

The liquid crystal display device 10 includes an image direct-view type, an image projection type and a light modulation type. The invention can be applied effectively to an active matrix liquid crystal display device using such a 3-terminal or 2-terminal semiconductor element as a TFT or a MIM. Of course, an embodiment that is applied to such a passive matrix liquid crystal display device as represented by a STN mode called time division driving is also effective.

In FIG. 1, 2 represents the direction of the upside polarizing plate absorption axis, 6 represents the alignment control direction of the upper substrate, 9 represents the alignment control direction of the lower substrate, 13 represents the direction of the downside polarizing plate absorption axis.

In addition, the liquid crystal display device 10 of the invention has preferably an optical compensatory film that satisfies the following formulae (4) to (5) for the protective film having the characteristics of the above-described formulae (1) to (3) on the opposite side to the liquid crystal cell.

20 nm≦Re(548)≦150 nm (4)

100 nm≦Rth(548)≦400 nm (5)

In the formula (4), Re(548) is further preferably 30 nm to 150 nm, most preferably 40 nm to 150 nm. In the formula (5), Rth(548) is further preferably 100 nm to 300 nm, most preferably 100 nm to 250 nm.

### [Optical Compensatory Film]

Hereinafter, an optical compensatory film that satisfies the formulae (4) and (5) is described in detail. For the optical compensatory film of the invention, one that includes at least one of cellulose acylate-based resin, polycarbonate-based resin, polyimide-based resin, polyetherketone-based resin, polycycloolefin-based resin and polyvinyl acetal-based resin is preferred. Specifically, preferably used are one that has such non-liquid crystalline polymer as polyimide or polyaryletherketone on a substrate as described in JP-A-2003-344856, a stretched cellulose acylate film, and a stretched film of cycloolefin-based polymer. For the cycloolefin-based polymer film, polymer films using ZEONOR by ZEON, ARTON by JSR or APPEAR3000 by PROMERUS can be used preferably. Of these, a stretched cellulose acylate film is especially preferred because it is excellent in processing suitability for a polarizing plate and inexpensive. Hereinafter, the stretched cellulose acylate film for use preferably in the liquid crystal display device of the invention is described in detail.

### [Cellulose Acylate]

The cellulose acylate that is contained mainly in the stretched cellulose acylate film has an acetyl substitution degree of preferably 2.50 to 3.00, more preferably 2.70 to 2.95.

Another cellulose acylate that is preferred in the invention is a mixed aliphatic acid ester having the total acyl substitution degree of 2.00 to 2.90 and an acyl group having 3-4 carbon atoms. The substitution degree of the acyl group having 3 to 4 carbon atoms is preferably 0.1 to 2.0, further preferably 0.3 to 1.5.

The cellulose acylate that can be used for the polymer film of the invention has an average polymerization degree of preferably 250 to 800, further preferably 280 to 600. The cellulose acylate that can be used for the polymer film of the invention has a number average molecular weight of preferably 70,000 to 230,000, more preferably 75,000 to 230,000, further preferably 78,000 to 120,000.

The cellulose acylate that is used for the stretched cellulose acylate film of the invention can be synthesized in the same method as that for the cellulose acylate for use in the forward wavelength dispersion cellulose acylate film.

### [Retardation Developing Agent]

The stretched cellulose acylate film of the invention preferably contains a retardation developing agent. Hereinafter, the retardation developing agent is described.

For the retardation developing agent in the invention, one having at least two aromatic rings is preferred, and the compound that is represented by the following formula (1) is especially preferred. Hereinafter, the compound that is represented by the formula (1) is described in detail.

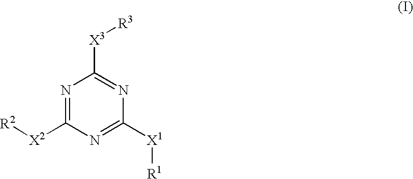

wherein X¹ represents a single bond, —NR⁴—, —O— or —S—; X² represents a single bond, —NR⁵—, —O— or —S—; X³ represents a single bond, —NR⁶—, —O— or —S—; R¹, R² and R³ each independently represents an alkyl group, an alkenyl group, an aryl group or a heterocyclic group; R⁴, R⁵ and R⁶ each independently represents a hydrogen atom, an alkyl group, an alkenyl group, an aryl group or a heterocyclic group.

In the formula (I), R¹, R² and R³ each independently represents an alkyl group, alkenyl group, aromatic group or heterocyclic group, and an aromatic ring or heterocyclic ring is further preferred. An aromatic ring that is represented by each of R¹, R² and R³ is preferably a phenyl ring or naphthyl ring, especially preferably a phenyl ring.

R¹, R² and R³ may have a substituent on an aromatic ring or heterocyclic ring. Examples of the substituent include a halogen atom, hydroxyl group, cyano group, nitro group, carboxyl group, alkyl group, alkenyl group, aryl group, alkoxy group, alkenyloxy group, aryloxy group, acyloxy group, alkoxycarbonyl group, alkenyloxycarbonyl group, aryloxycarbonyl group, sulfamoyl group, alkyl-substituted sulfamoyl group, alkenyl-substituted sulfamoyl group, aryl-substituted sulfamoyl group, sulfonamide group, carbamoyl group, alkyl-substituted carbamoyl group, alkenyl-substituted carbamoyl group, aryl-substituted carbamoyl group, amide group, alkylthio group, alkenylthio group, arylthio group and acyl group.

In case where R¹, R² and R³ represent a heterocyclic group, the heterocyclic ring has preferably aromatic property. A heterocyclic ring having aromatic property means generally an unsaturated heterocyclic ring, preferably a heterocyclic ring having the largest number of double bonds. The heterocyclic ring is preferably a 5-membered, 6-membered or 7-membered ring, further preferably a 5-membered or 6-membered ring, most preferably a 6-membered ring. The hetero atom of the heterocyclic ring is preferably a nitrogen atom, a sulfur atom or an oxygen atom, especially preferably a nitrogen atom. For a heterocyclic ring having aromatic property, a pyridine ring (for a heterocyclic group, 2-pyridyl or 4-pyridyl) is especially preferred. The heterocyclic group may have a substituent. Examples of the substituent of the heterocyclic group is the same as the aforementioned examples for the substituent. These substituents may have been substituted further with the above-described substituent.

In the formula (1), X¹ represents a single bond, —NR⁴—, —O— or —S—; X² represents a single bond, NR⁵—, —O— or —S—; X³ represents a single bond, —NR⁶—, —O— or —S—. R⁴, R⁵ and R⁶ each independently represents a hydrogen atom, an alkyl group, an alkenyl group, an aryl group or a heterocyclic group.

The alkyl group that is represented by each of R⁴, R⁵ and R⁶ may be a cyclic alkyl group or chain-like alkyl group, wherein a chain-like alkyl group is preferred, and a linear chain-like alkyl group is preferred to a branched chain-like alkyl group. The alkyl group has carbon atoms of preferably 1 to 30, more preferably 1 to 20, further preferably 1 to 10, furthermore preferably 1 to 8, most preferably 1 to 6. The alkyl group may have a substituent. Examples of the substituent include a halogen atom, alkoxy group (e.g., methoxy group, ethoxy group) and acyloxy group (e.g., acryloyloxy group, methacryloyloxy group).

The alkenyl group that is represented by each of R⁴, R⁵ and R⁶ may be a cyclic alkenyl group or chain-like alkenyl group, wherein a chain-like alkenyl group is preferred, and a linear chain-like alkenyl group is preferred to a branched chain-like alkenyl group. The alkenyl group has carbon atoms of preferably 2 to 30, more preferably 2 to 20, further preferably 2 to 10, furthermore preferably 2 to 8, most preferably 2 to 6. The alkenyl group may have a substituent. Examples of the substituent are the same as that of the substituent for the alkyl group.

The aromatic ring group (aryl group) and the heterocyclic group that are represented by each of R⁴, R⁵ and R⁶ are the same as the aromatic ring and the heterocyclic ring, respectively, that are represented by each of R¹, R² and R³ and the preferred range thereof are also the same. The aromatic ring group and the heterocyclic group may have further a substituent. Examples of the substituent are the same as those for the aromatic ring and the heterocyclic ring that are represented by R¹, R² and R³.

Preferred examples of compounds that are represented by the formula (1) in the invention are shown below, but the invention is not limited to these specific examples.

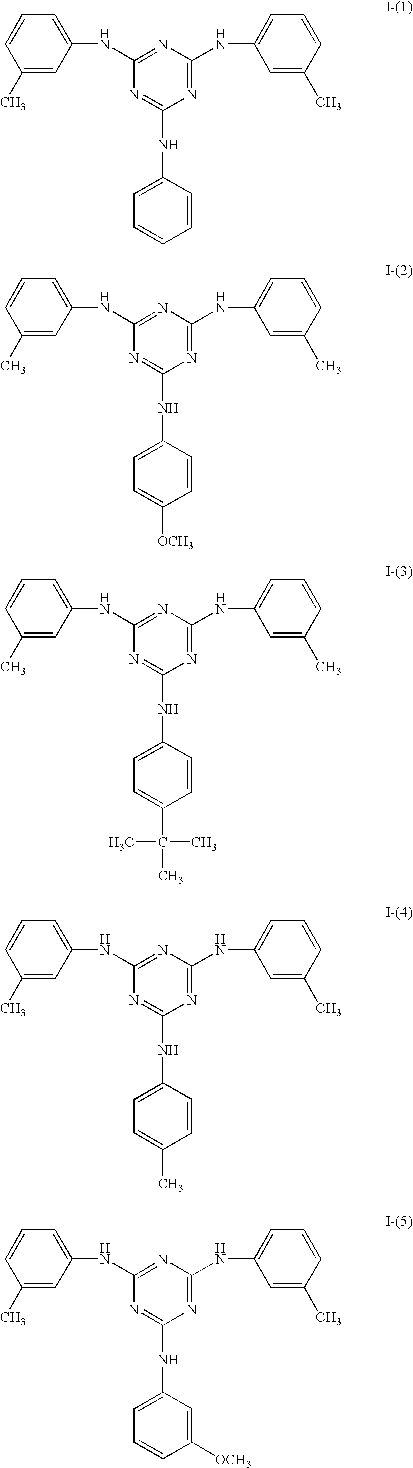

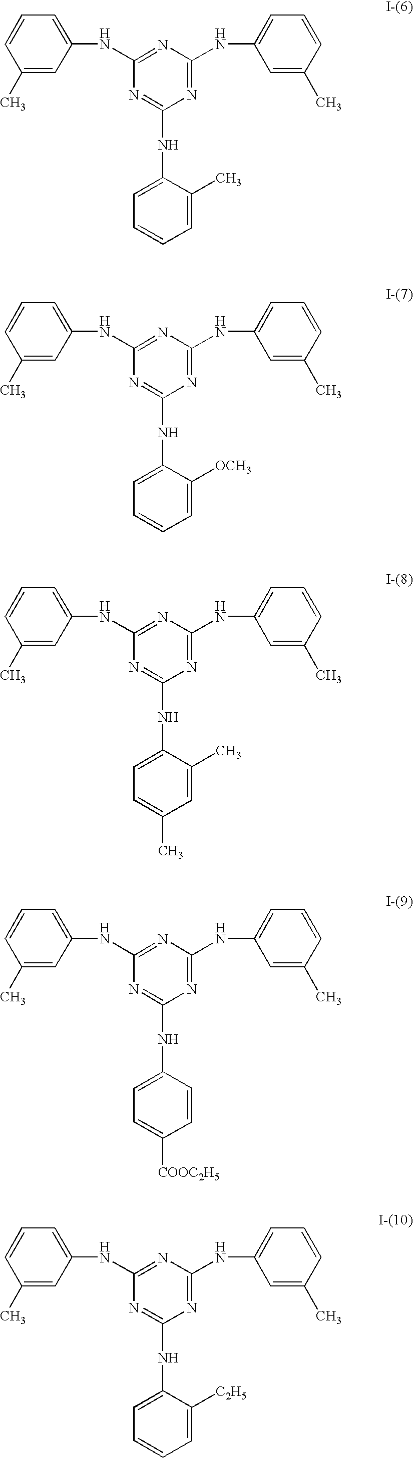

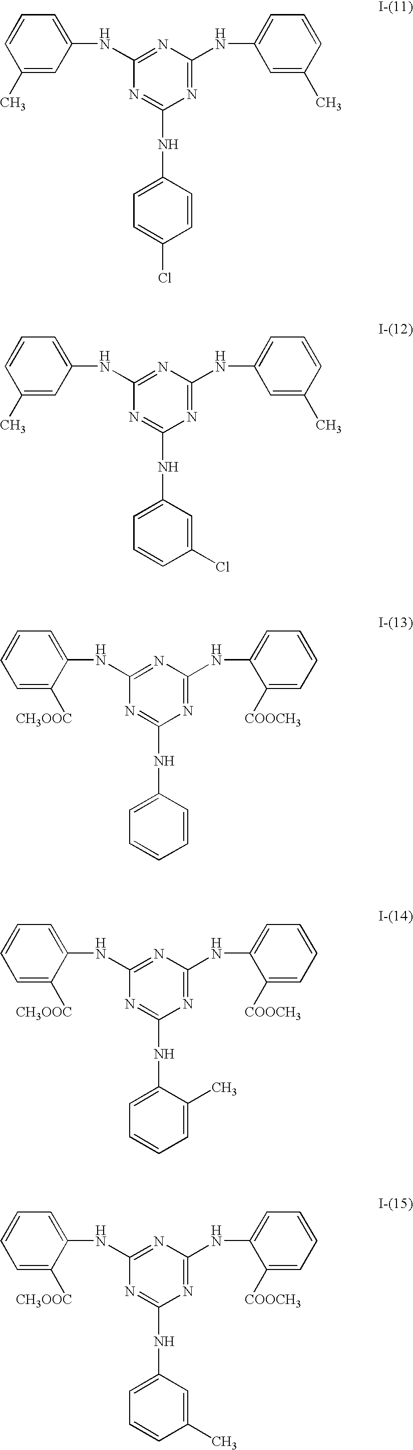

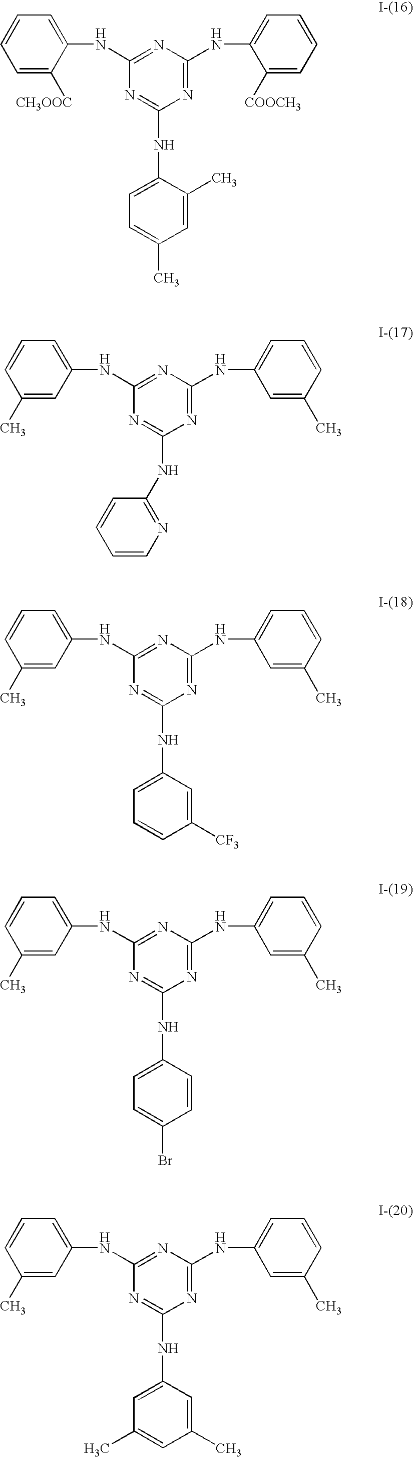

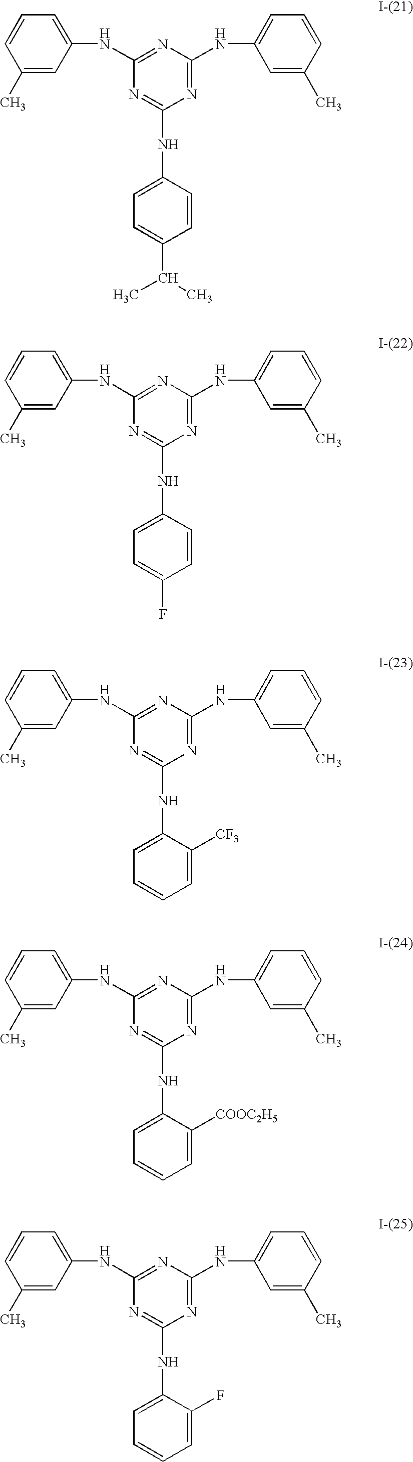

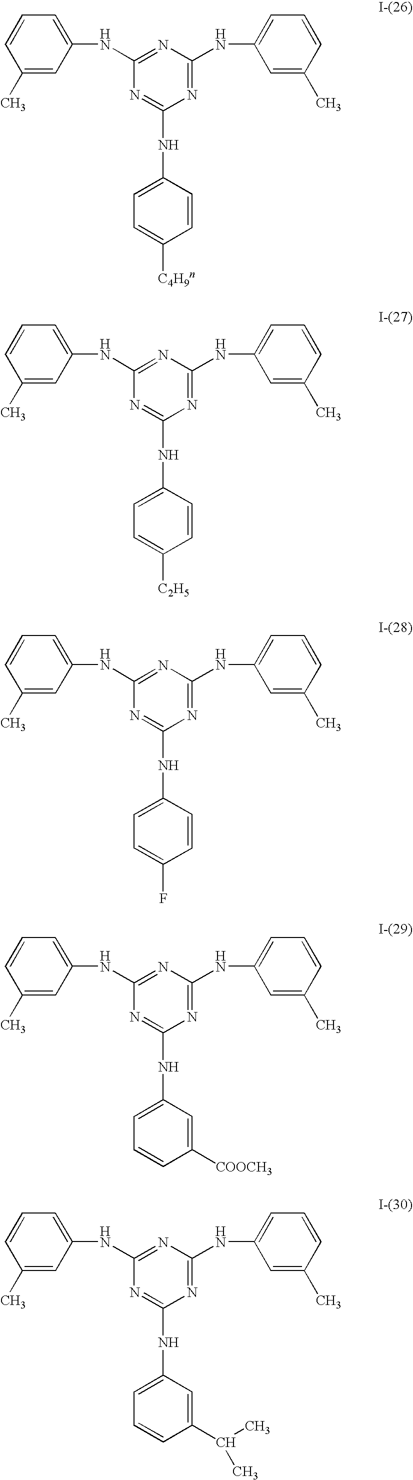

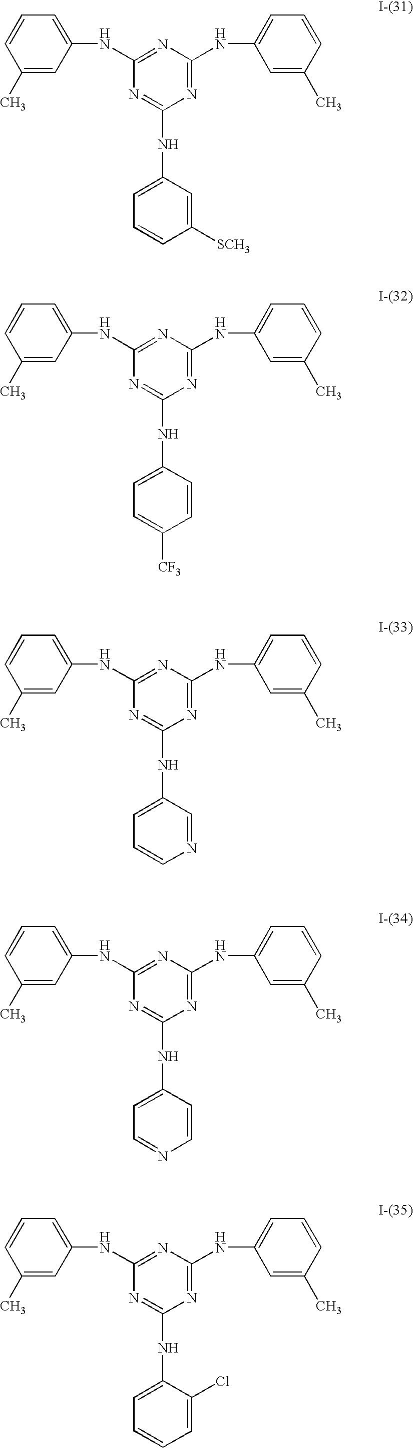

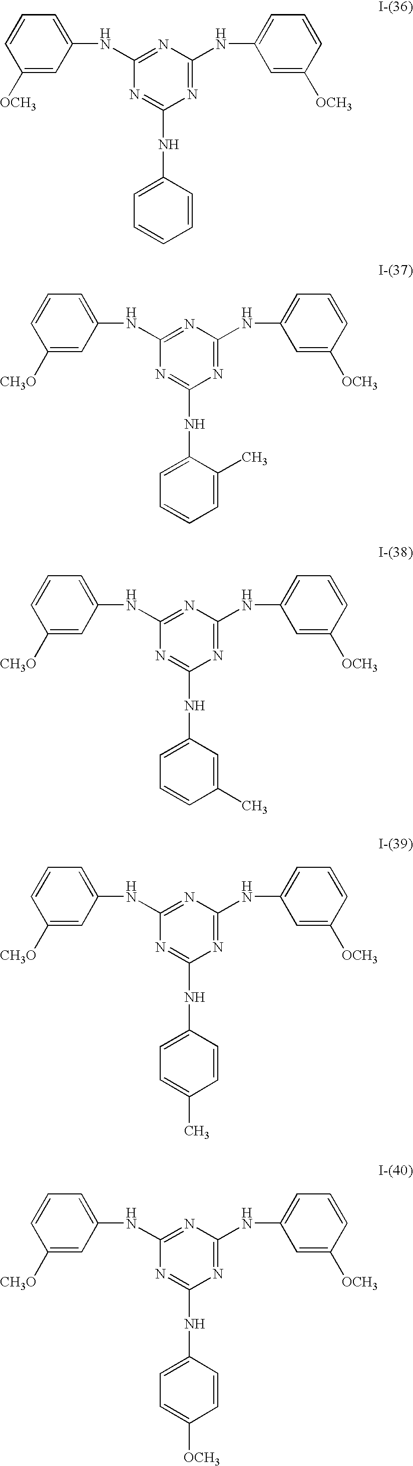

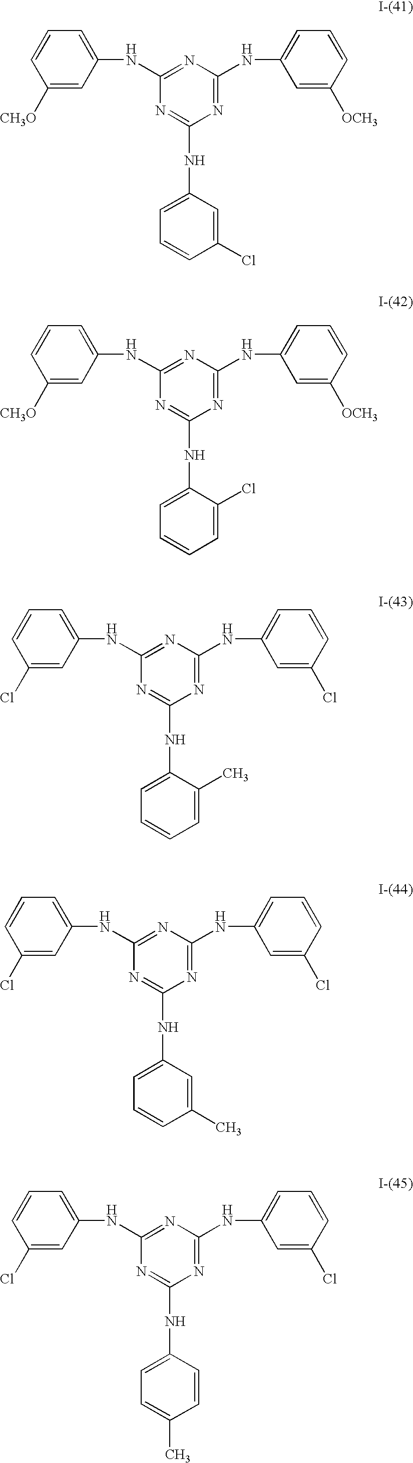

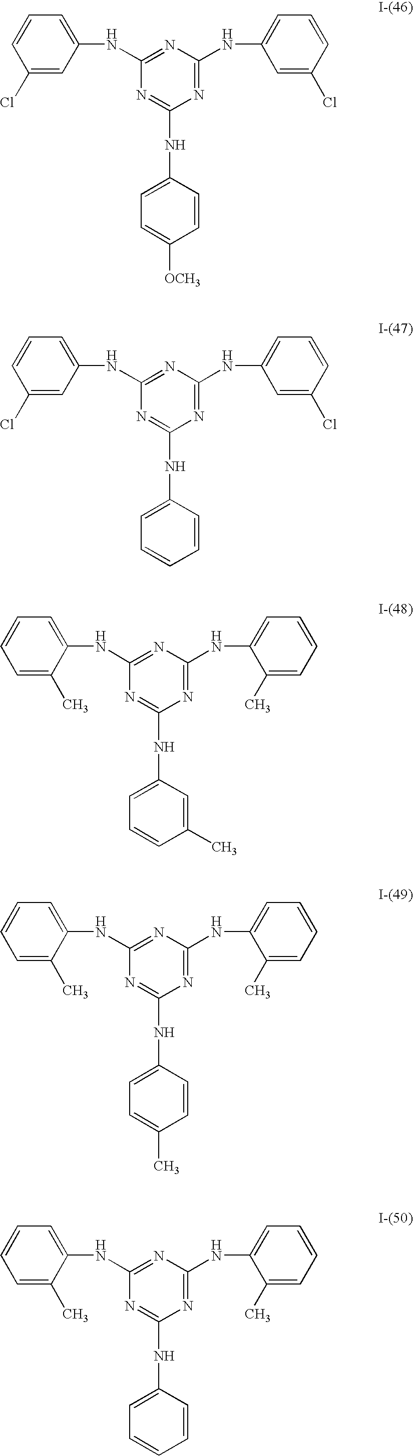

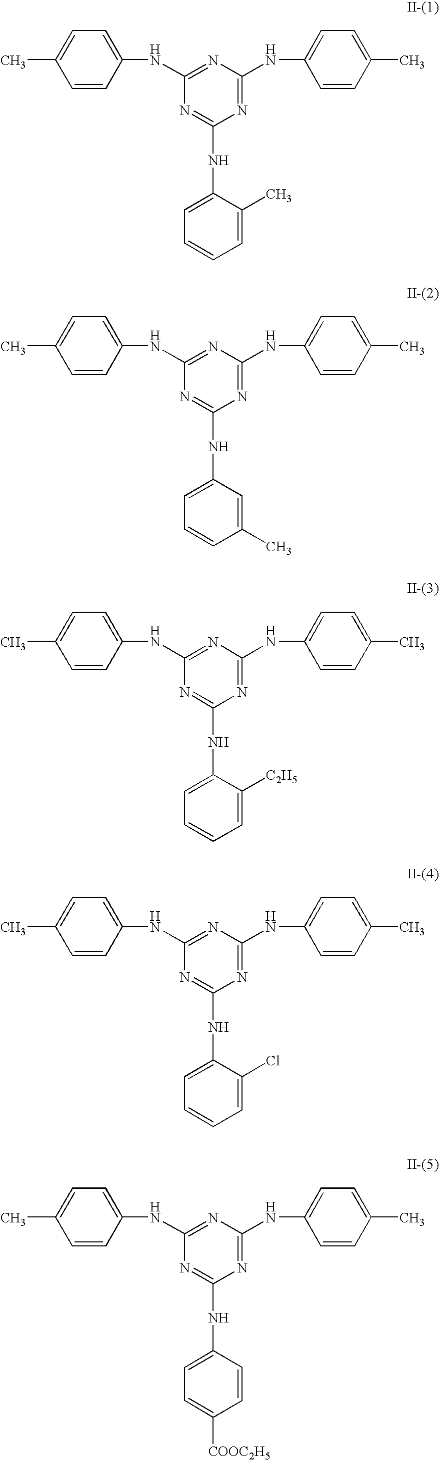

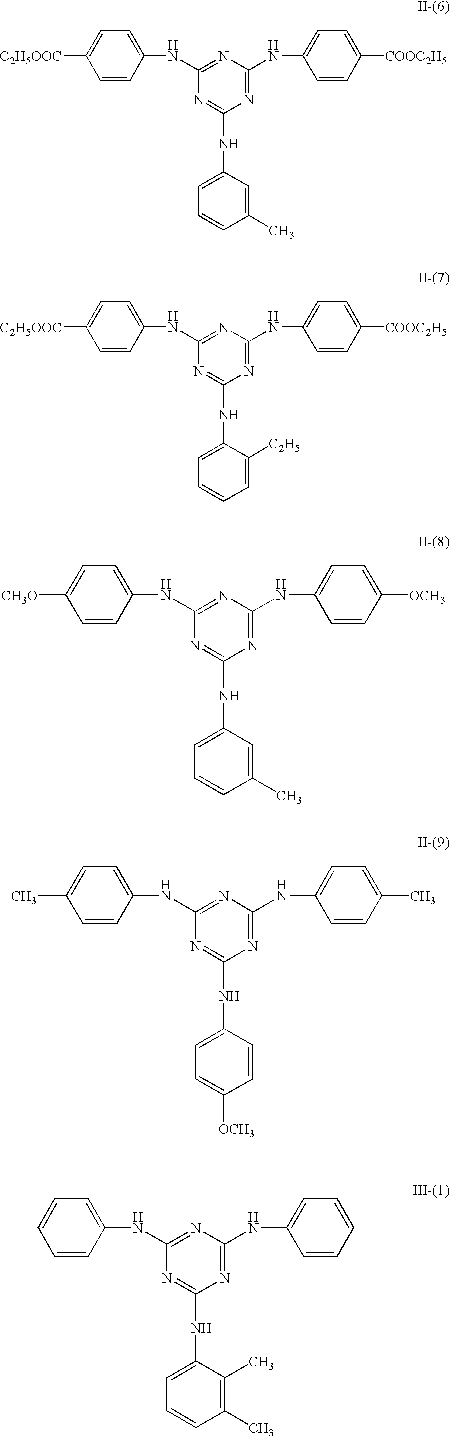

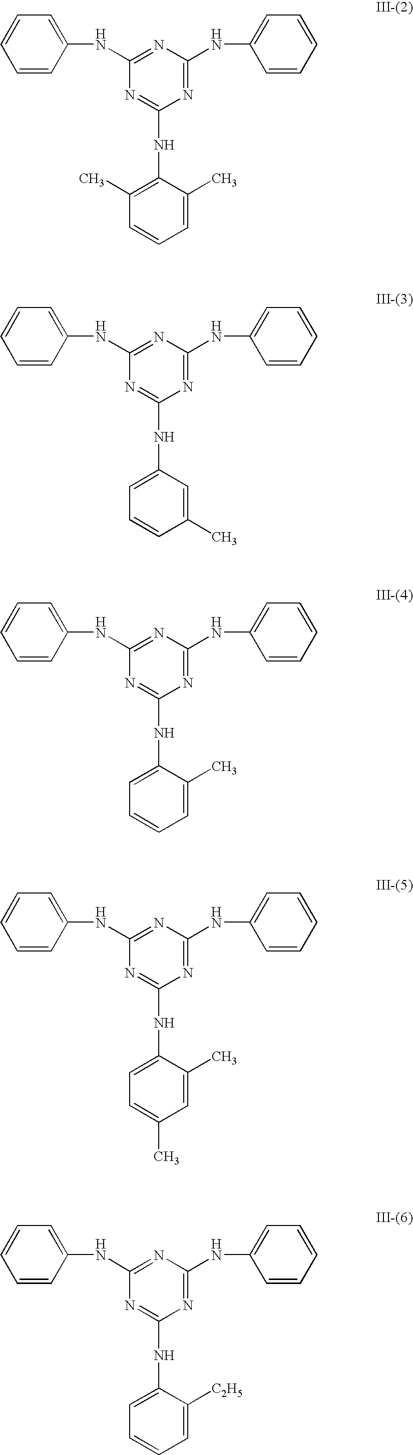

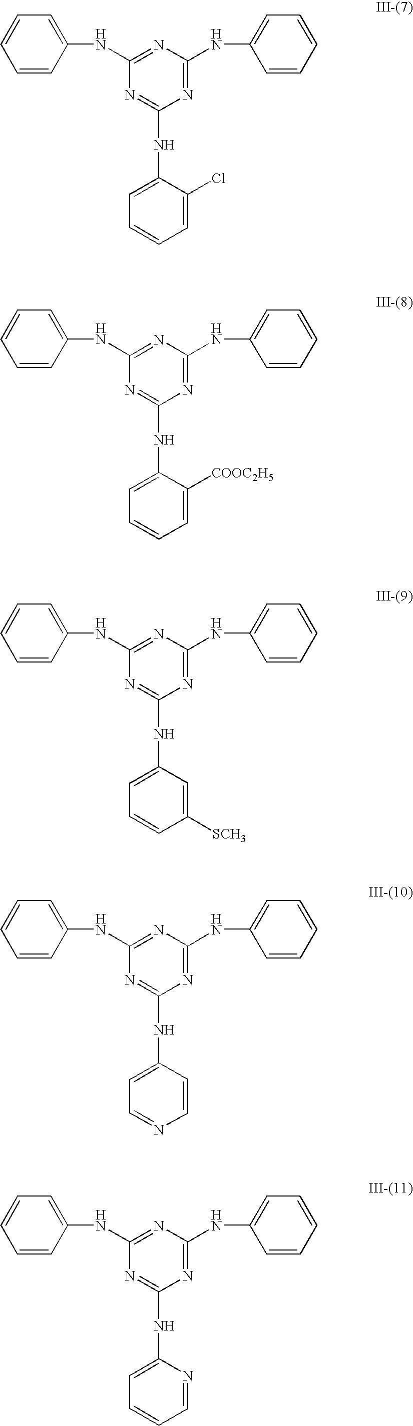

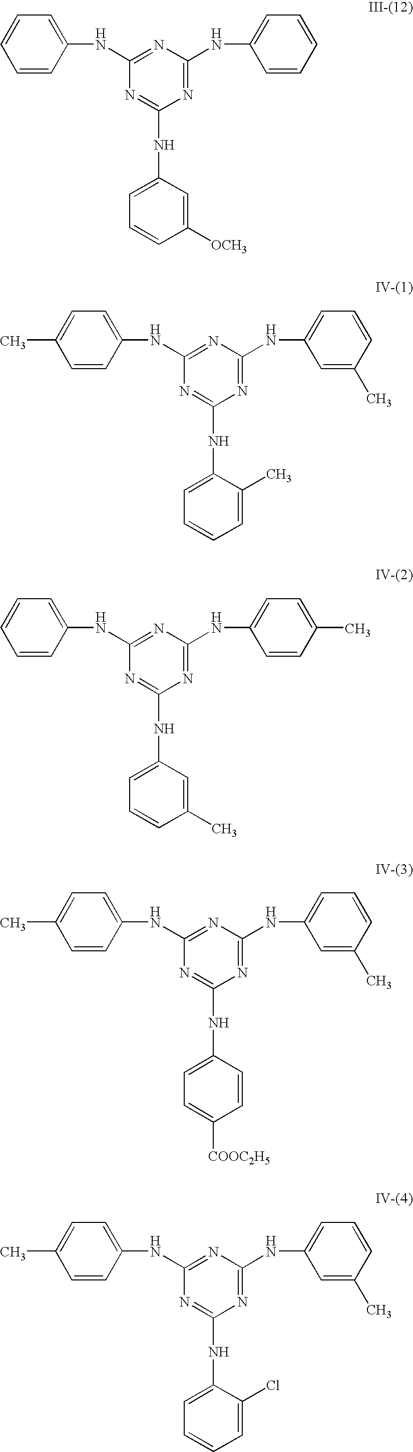

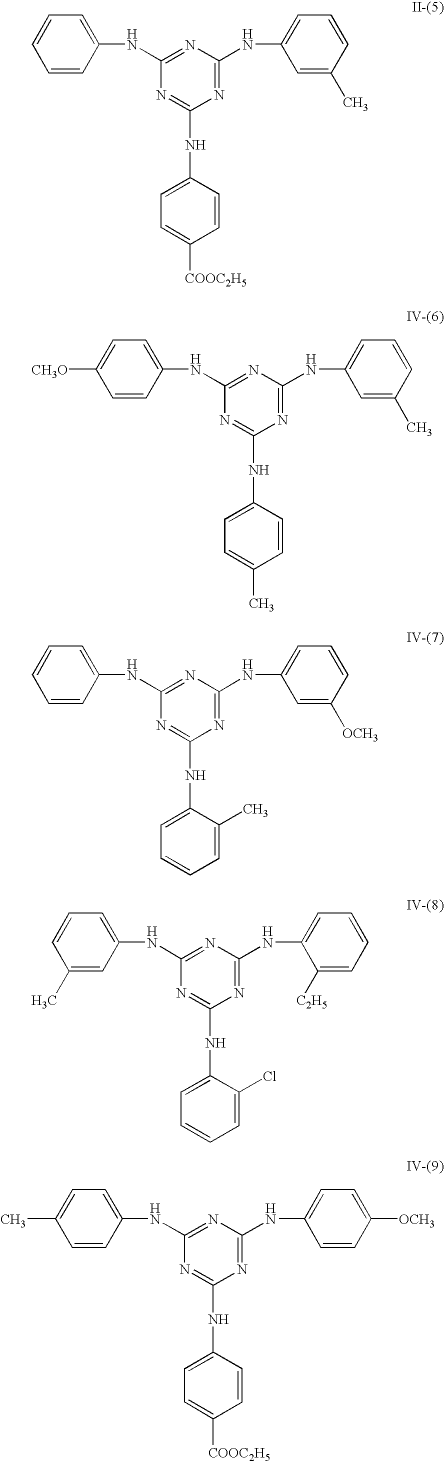

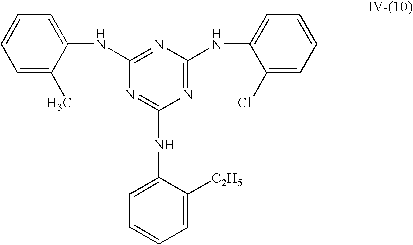

In the invention, the addition amount of the compound that is represented by the formula (1) is preferably 0.1 to 20% by mass relative to cellulose acylate, more preferably 1 to 15% by mass, further preferably 2 to 12% by mass, most preferably 3 to 10% by mass.

In order to form a cellulose acylate film of the invention that satisfies the formulae (4) to (5), the addition of the compound that is represented by the following formula (V) and/or the compound that is represented by the following formula (VI) is preferred, and the addition of the compound that is represented by the following formula (VI) is further preferred.

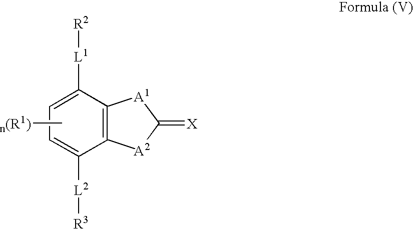

wherein L¹ and L² each independently represents a single bond or a divalent linking group. A¹ and A² each independently represents a group that is selected from the group consisting of —O—, —NR— (R represents a hydrogen atom or a substituent), —S— and —CO—. R¹, R² and R³ each independently represents a substituent. X represents a nonmetal atom of 14 to 16 groups (here, X may be a nonmetal atom of 14 to 16 group that is bonded with a hydrogen atom or a substituent). n represents 0 or an integer of 1 to 2.

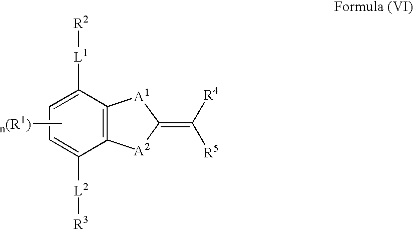

wherein L¹ and L² each independently represents a single bond or a divalent linking group. A¹ and A² each independently represents a group that is selected from the group consisting of —O—, —NR— (R represents a hydrogen atom or a substituent), —S— and —CO—. R¹, R²R³, R⁴ and R⁵ each independently represents a substituent. n represents 0 or an integer of 1 to 2.

In the formula (V) or (VI), preferred divalent linking groups that are represented by L¹ and L² include the following examples.

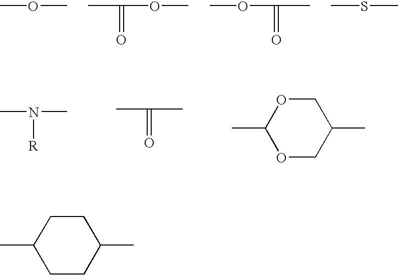

Further preferred are —O—, —COO— and —OCO—.

In the formula (V) or (VI), R¹ represents a substituent, and, in case where plural R's exist, they may be the same with or different from each other, or form a ring. Examples of the substituent include a halogen atom (e.g., fluorine atom, chlorine atom, bromine atom, iodine atom), an alkyl group (preferably an alkyl group having 1 to 30 carbon atoms such as a methyl group, ethyl group, n-propyl group, isopropyl group, tert-butyl group, n-octyl group, 2-ethylhexyl group), a cycloalkyl group (preferably a substituted or unsubstituted cycloalkyl group having 3 to 30 carbon atoms such as a cyclohexyl group, cyclopentyl group, 4-n-dodecylcyclohexyl group), a bicycloalkyl group (preferably a substituted or unsubstituted bicycloalkyl group having 5 to 30 carbon atoms, that is, a monovalent group that is formed by removing one hydrogen atom from bicycloalkane having 5 to 30 carbon atoms; such as a bicyclo[1,2,2]heptane-2-yl group, bicyclo[2,2,2]octane-3-yl group), an alkenyl group (preferably a substituted or unsubstituted alkenyl group having 2 to 30 carbon atoms such as a vinyl group, allyl group), a cycloalkenyl group (preferably a substituted or unsubstituted cycloalkenyl group having 3 to 30 carbon atoms, that is, a monovalent group that is formed by removing one hydrogen atom from cycloalkane having 3 to 30 carbon atoms; such as a 2-cyclopentene-1-yl group, 2-cyclohexene-1-yl group), a bicycloalkenyl group (a substituted or unsubstituted bicycloalkenyl group, preferably a substituted or unsubstituted bicycloalkenyl group having 5 to 30 carbon atoms, that is, a monovalent group that is formed by removing one hydrogen atom from a bicycloalkene having one double bond; such as a bicyclo[2,2,1]pepto-2-ene-1-yl group, bicyclo[2,2,2]octo-2-ene-4-yl group), an alkynyl group (preferably a substituted or unsubstituted alkynyl group having 2 to 30 carbon atoms such as an ethynyl group, propargyl group), an aryl group (preferably a substituted or unsubstituted aryl group having 6 to 30 carbon atoms such as a phenyl group, p-tolyl group, naphthyl group), a heterocyclic group (preferably a monovalent group that is formed by removing one hydrogen atom from a 5-membered or 6-membered substituted or unsubstituted aromatic or nonaromatic heterocyclic compound or a combination thereof (including a condensed ring), further preferably a monovalent group that is formed by removing one hydrogen atom from a 5-membered or 6-membered heterocyclic compound having 3 to 30 carbon atoms or a combination thereof (including a condensed ring); such as a 2-furyl group, 2-thienyl group, 2-pyrimidinyl group, 2-benzothiazolyl group), a cyano group, a hydroxyl group, a nitro group, a carboxyl group, an alkoxy group (preferably a substituted or unsubstituted alkoxy group having 1 to 30 carbon atoms such as a methoxy group, ethoxy group, isopropoxy group, tert-butoxy group, n-octyloxy group, 2-methoxyethoxy group), an aryloxy group (preferably a substituted or unsubstituted aryloxy group having 6 to 30 carbon atoms such as a phenoxy group, 2-methylphenoxy group, 4-tert-butylphenoxy group, 3-nitrophenoxy group, 2-tetradecanoylaminophenoxy group), a silyloxy group (preferably a silyloxy group having 3 to 20 carbon atoms such as a trimethylsilyloxy group, tert-butyldimethylsilyloxy group), a heterocyclicoxy group (preferably a substituted or unsubstituted heterocyclicoxy group having 2 to 30 carbon atoms, 1-phenyltetrazole-5-oxy group, 2-tetrahydropyranyloxy group), an acyloxy group (preferably a formyloxy group, substituted or unsubstituted alkylcarbonyloxy group having 2 to 30 carbon atoms, substituted or unsubstituted arylcarbonyloxy group having 6 to 30 carbon atoms such as a formyloxy group, acetyloxy group, pivaloyloxy group, stearoyloxy group, benzoyloxy group, p-methoxyphenylcarbonyloxy group), a carbamoyloxy group (preferably a substituted or unsubstituted carbamoyloxy group having 1 to 30 carbon atoms such as a N,N-dimethylcarbamoyloxy group, N,N-diethylcarbamoyloxy group, morpholinocarbonyloxy group, N,N-di-n-octylaminocarbonyloxy group, N-n-octylcarbamoyloxy group), an alkoxycarbonyloxy group (preferably a substituted or unsubstituted alkoxycarbonyloxy group having 2 to 30 carbon atoms such as a methoxycarbonyloxy group, ethoxycarbonyloxy group, tert-butoxycarbonyloxy group, n-octylcarbonyloxy group), an aryloxycarbonyloxy group (preferably a substituted or unsubstituted aryloxycarbonyloxy group having 7 to 30 carbon atoms such as a phenoxycarbonyloxy group, p-methoxyphenoxycarbonyloxy group, p-n-hexadecyloxyphenoxycarbonyloxy group), an amino group (preferably an amino group, a substituted or unsubstituted alkylamino group having 1 to 30 carbon atoms, a substituted or unsubstituted anilino group having 6 to 30 carbon atoms such as an amino group, methylamino group, dimethylamino group, anilino group, N-methylanilino group, diphenylamino group), an acylamino group (preferably a formylamino group, substituted or unsubstituted alkylcarbonylamino group having 1 to 30 carbon atoms, substituted or unsubstituted arylcarbonylamino group having 6 to 30 carbon atoms such as a formylamino group, acetylamino group, pivaloylamino group, lauroylamino group, benzoylamino group), an aminocarbonylamino group (preferably a substituted or unsubstituted aminocarbonylamino group having 1 to 30 carbon atoms such as a carbamoylamino group, N,N-dimethylaminocarbonylamino group, N,N-diethylaminocarbonylamino group, morpholinocarbonylamino group), an alkoxy carbonylamino group (preferably a substituted or unsubstituted alkoxycarbonylamino group having 2 to 30 carbon atoms such as a methoxycarbonylamino group, ethoxycarbonylamino group, tert-butoxycarbonylamino group, n-octadecyloxycarbonylamino group, N-methylmethoxycarbonylamino group), an aryloxycarbonylamino group (preferably a substituted or unsubstituted aryloxycarbonylamino group having 7 to 30 carbon atoms such as a phenoxycarbonylamino group, p-chlorophenoxycarbonylamino group, m-n-octyloxyphenoxycarbonylamino group), a sulfamoylamino group (preferably a substituted or unsubstituted sulfamoylamino group having 0 to 30 carbon atoms such as a sulfamoylamino group, N,N-dimethylaminosulfonylamino group, N-n-octylaminosulfonylamino group), an alkylsulfonylamino group/arylsulfonylamino group (preferably a substituted or unsubstituted alkylsulfonylamino group having 1 to 30 carbon atoms, a substituted or unsubstituted arylsulfonylamino group having 6 to 30 carbon atoms such as a methylsulfonylamino group, butlysulfonylamino group, phenylsulfonylamino group, 2,3,5-trichlorophenylsulfonylamino group, p-methylphenylsulfonylamino group), a mercapto group, an alkylthio group (preferably a substituted or unsubstituted alkylthio group having 1 to 30 carbon atoms such as a methylthio group, ethylthio group, n-hexadecylthio group), an arylthio group (preferably a substituted or unsubstituted arylthio group having 6 to 30 carbon atoms such as a phenylthio group, p-chlorophenylthio group, m-methoxyphenylthio group), a heterocyclicthio group (preferably a substituted or unsubstituted heterocyclicthio group having 2 to 30 carbon atoms such as a 2-benzothiazolylthio group, 1-phenyltetrazole-5-ylthio group), a sulfamoyl group (preferably a substituted or unsubstituted sulfamoyl group having 0 to 30 carbon atoms such as a N-ethylsulfamoyl group, N-(3-dodecyloxypropyl)sulfamoyl group, N,N-dimethylsulfamoyl group, N-acetylsulfamoyl group, N-benzoylsulfamoyl group, N—(N′-phenylcarbamoyl)sulfamoyl group), a sulfo group, an alkylsulfinyl group/arylsulfinyl group (preferably a substituted or unsubstituted alkylsulfinyl group having 1 to 30 carbon atoms, a substituted or unsubstituted arylsulfinyl group having 6 to 30 carbon atoms such as a methylsulfinyl group, ethylsulfinyl group, phenylsulfinyl group, p-methylphenylsulfinyl group), an alkylsulfonyl group/arylsulfonyl group (preferably a substituted or unsubstituted alkylsulfonyl group having 1 to 30 carbon atoms, a substituted or unsubstituted arylsulfonyl group having 6 to 30 carbon atoms such as a methylsulfonyl group, ethylsulfonyl group, phenylsulfonyl group, p-methylphenylsulfonyl group), an acyl group (preferably a formyl group, a substituted or unsubstituted alkylcarbonyl group having 2 to 30 carbon atoms, a substituted or unsubstituted arylcarbonyl group having 7 to 30 carbon atoms such as an acetyl group, pivaloylbenzoyl group), an aryloxycarbonyl group (preferably a substituted or unsubstituted aryloxycarbonyl group having 7 to 30 carbon atoms such as a phenoxycarbonyl group, O-chlorophenoxycarbonyl group, m-nitrophenoxycarbonyl group, p-tert-butylphenoxycarbonyl group), an alkoxycarbonyl group (preferably a substituted or unsubstituted alkoxy carbonyl group having 2 to 30 carbon atoms such as a methoxycarbonyl group, ethoxycarbonyl group, tert-butoxycarbonyl group, n-octadecyloxycarbonyl group), a carbamoyl group (preferably a substituted or unsubstituted carbamoyl group having 1 to 30 carbon atoms such as a carbamoyl group, N-methylcarbamoyl group, N,N-dimethylcarbamoyl group, N,N-di-n-octylcarbamoyl group, N-(methylsulfonyl)carbamoyl group), an aryl and heterocyclic azo group (preferably a substituted or unsubstituted arylazo group having 6 to 30 carbon atoms, a substituted or unsubstituted heterocyclic azo group having 3 to 30 carbon atoms such as a phenylazo group, p-chlorophenylaxo group, 5-ethylthio-1,3,4-thiadiazole-2-ylazo group), an imido group (preferably a N-succinimido group, N-phthalimido group), a phosphino group (preferably a substituted or unsubstituted phosphino group having 2 to 30 carbon atoms such as a dimethylphosphino group, diphenylphosphino group, methylphenoxyphosphino group), a phosphinyl group (preferably a substituted or unsubstituted phosphinyl group having 2 to 30 carbon atoms such as a phosphinyl group, dioctyloxyphosphinyl group, diethoxyphosphinyl group), a phosphinyloxy group (preferably a substituted or unsubstituted phosphinyloxy group having 2 to 30 carbon atoms such as a diphenoxyphosphinyloxy group, dioctyloxyphosphinyloxy group), a phosphinylamino group (preferably a substituted or unsubstituted phosphinyl amino group having 2 to 30 carbon atoms such as a dimethoxyphosphinylamino group, dimethylaminophosphinylamino group), and a silyl group (preferably a substituted or unsubstituted silyl group having 3 to 30 carbon atoms such as a trimethylsilyl group, tert-butyldimethylsilyl group, phenyldimethylsilyl group).

Among these substituent, for those having a hydrogen atom, it may be removed to be substituted further with the above-described group. Examples of such functional groups include an alkylcarbonylaminosulfonyl group, an arylcarbonylaminosulfonyl group, an alkylsulfonylaminocarbonyl group and an arylsulfonylaminocarbonyl group. Examples of these groups include a methylsulfonylaminocarbonyl group, a p-methylphenylsulfonylaminocarbonyl group, an acetylaminosulfonyl group, and a benzoylaminosulfonyl group.

R¹ is preferably a halogen atom, an alkyl group, an alkenyl group, an aryl group, a heterocyclic group, a hydroxyl group, a carboxyl group, an alkoxy group, an aryloxy group, an acyloxy group, a cyano group, or an amino group, further preferably a halogen atom, an alkyl group, a cyano group or an alkoxy group.

R² and R³ each independently represents a substituent. Examples of the substituent include those described for R¹. It is preferably an alkyl group, an alkenyl group, an aryl group, a heterocyclic group or an aryloxy group, more preferably a substituted or unsubstituted benzene ring or a substituted or unsubstituted cyclohexane ring, further preferably a benzene ring having a substituent or a cyclohexane ring having a substituent, furthermore preferably a benzene ring having a substituent on 4-site or a cyclohexane ring having a substituent on 4-site. Especially preferred is a benzene ring having a benzoyloxy group on 4-site, the benzoyloxy group having a substituent on 4-site; a benzene ring having a cyclohexyl group on 4-site, the cyclohexyl group having a substituent on 4-site; a cyclohexane ring having a benzene ring on 4-site, the benzene ring having a substituent on 4-site; or a cyclohexane ring having a cyclohexyl group on 4-site, the cyclohexyl group having a substituent on 4-site. Here, a preferred substituent is an alkyl group.

There are such stereoisomers as a cis from and a trans form for a cyclohexane ring having a substituent on 4-site, and there is no limitation on the stereoisomer in the invention. A mixture thereof may be usable. Preferred is a trans-cyclohexane ring.

R⁴ and R⁵ each independently represents a substituent. The example of the substituent includes those described for R¹. It is preferably a carboxyl group, a halogen atom, an aryloxy group, a heterocyclic group or a cyano group, more preferably an electron-attracting substituent having the Hammett's substituent constant σₚ of greater than 0, further preferably an electron-attracting substituent having the σₚ of 0 to 1.5. Examples of such substituents include a trifluoromethyl group, a cyano group, a carbonyl group and a nitro group. R⁴ and R⁵ may be bonded to form a ring. About the Hammett's substituent constant σₚ, σₘ, there are detailed description in such books as Inamoto Naoki “Hammett Soku-Kozo to Hannosei (Hammett's Rule—Structure and Reactivity-)” (Maruzen); The Chemical Society of Japan Ed., “Shin Jikkenkagaku Koza 14, Yukikagobutsu no Gosei to Hannou V (New Course of Experimental Chemistry 14, Synthesis and Reaction of Organic Compound V)” p 2605 (Maruzen); and Nakaya Tadao “Riron Yukikagaku Kaisetsu (Interpretation of Theoretical Organic Chemistry)” p 217 (TOKYO KAGAKIJ DOJIN); and Chemical Review vol. 91, pp 165 to 195 (1991).

A¹ and A² each independently represents a group selected from the group consisting of —O—, —NR— (R is a hydrogen atom or a substituent), —S— or —CO—. Preferably they are —O—, —NR— (R represents a substituent, wherein the example thereof includes those for the above-described R¹) or —S—. Preferably at least one of A¹ and A² is —S—, more preferably both A¹ and A² are —S—.

X is preferably O, S, NR or C(R)R (R represents a substituent, wherein the example thereof includes those for the above-described R¹).

n is preferably 0 or 1.

Hereinafter, specific examples of the compounds that are represented by formula (V) or (VI) are shown. But the invention is not limited by the following specific examples in any way. For the following compounds, unless otherwise denoted, they are shown as the “exemplified compound (X)” by the numeral in the parentheses ( )

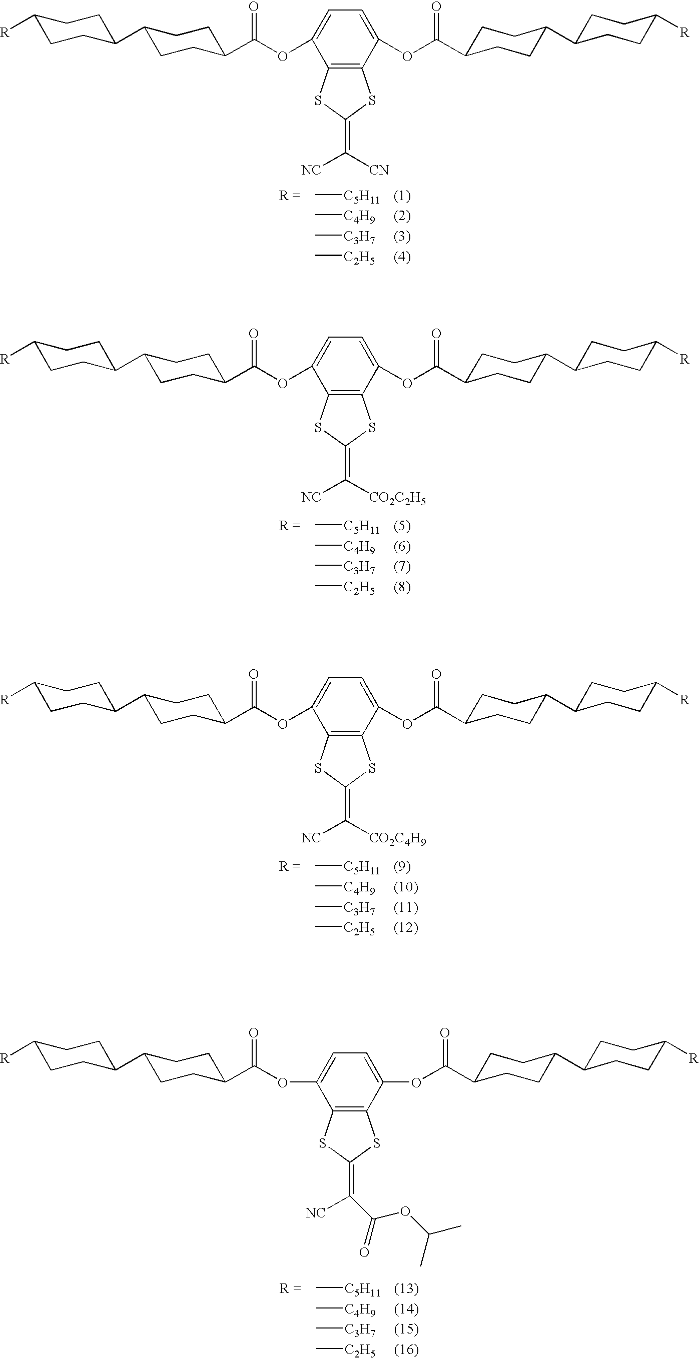

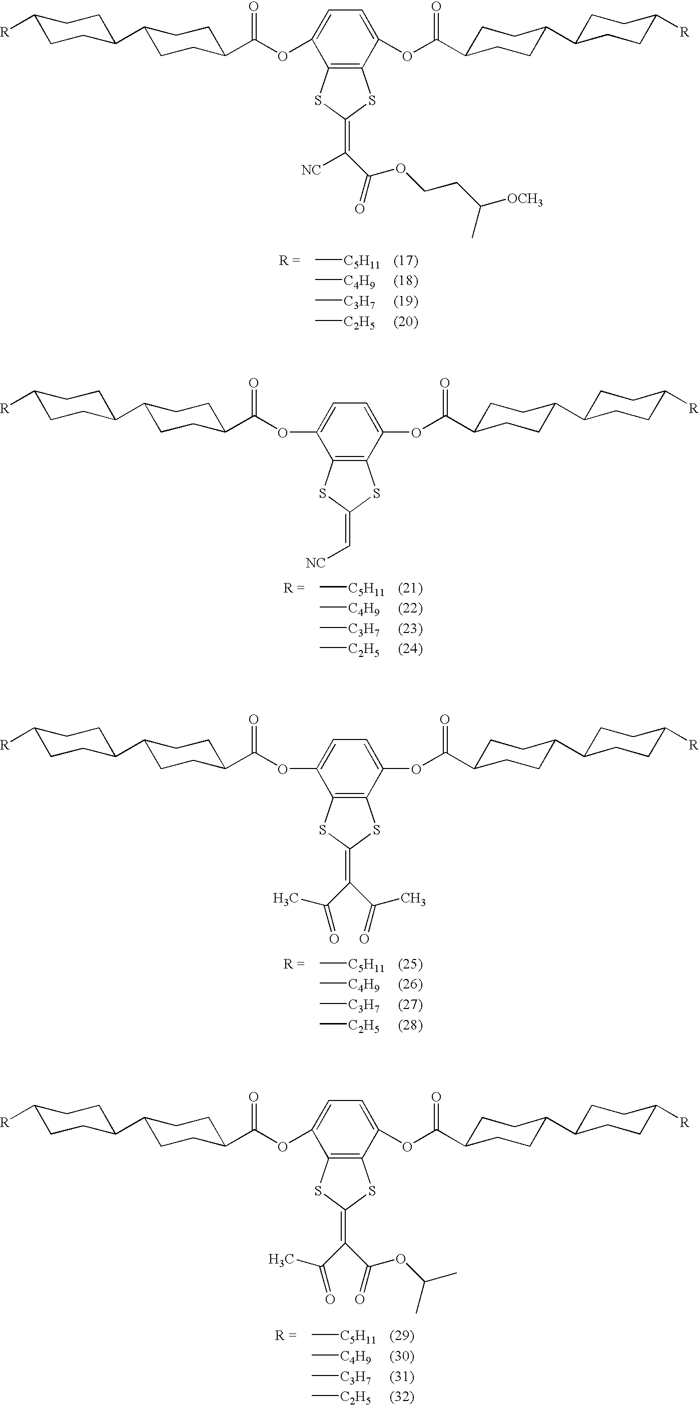

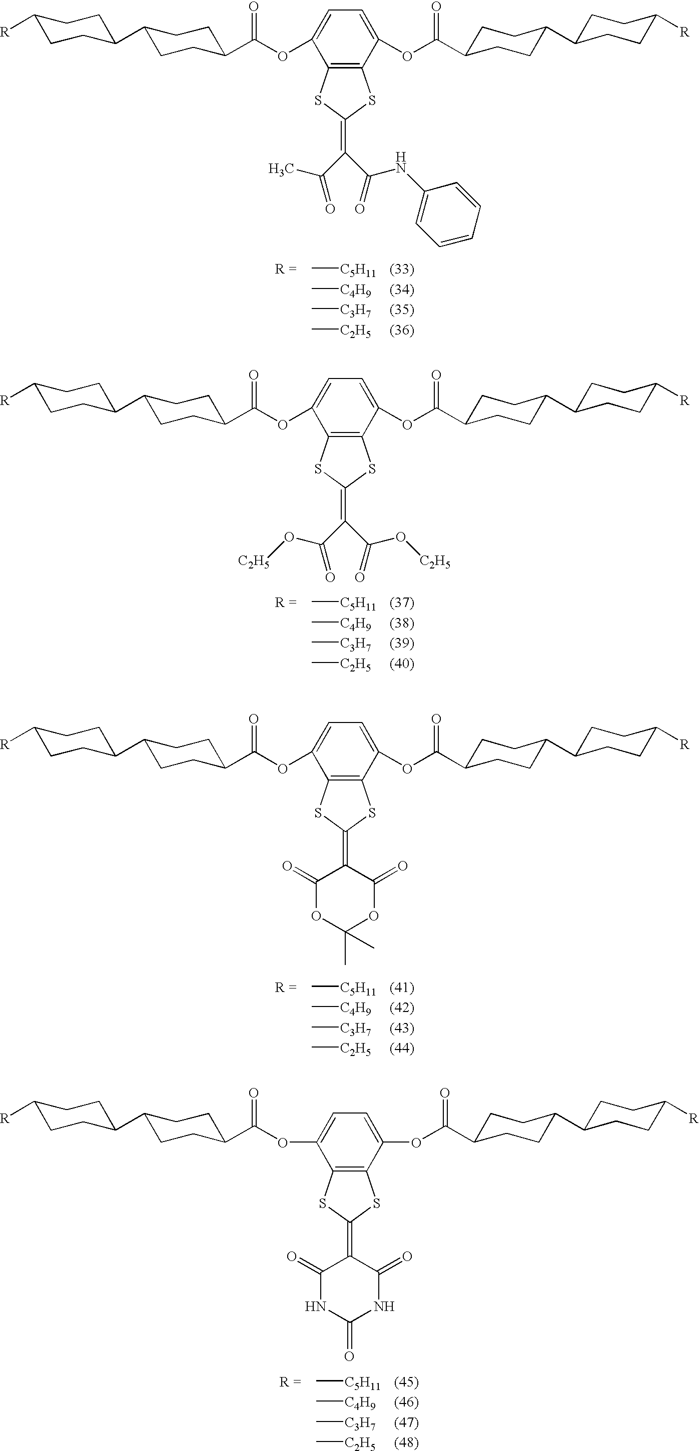

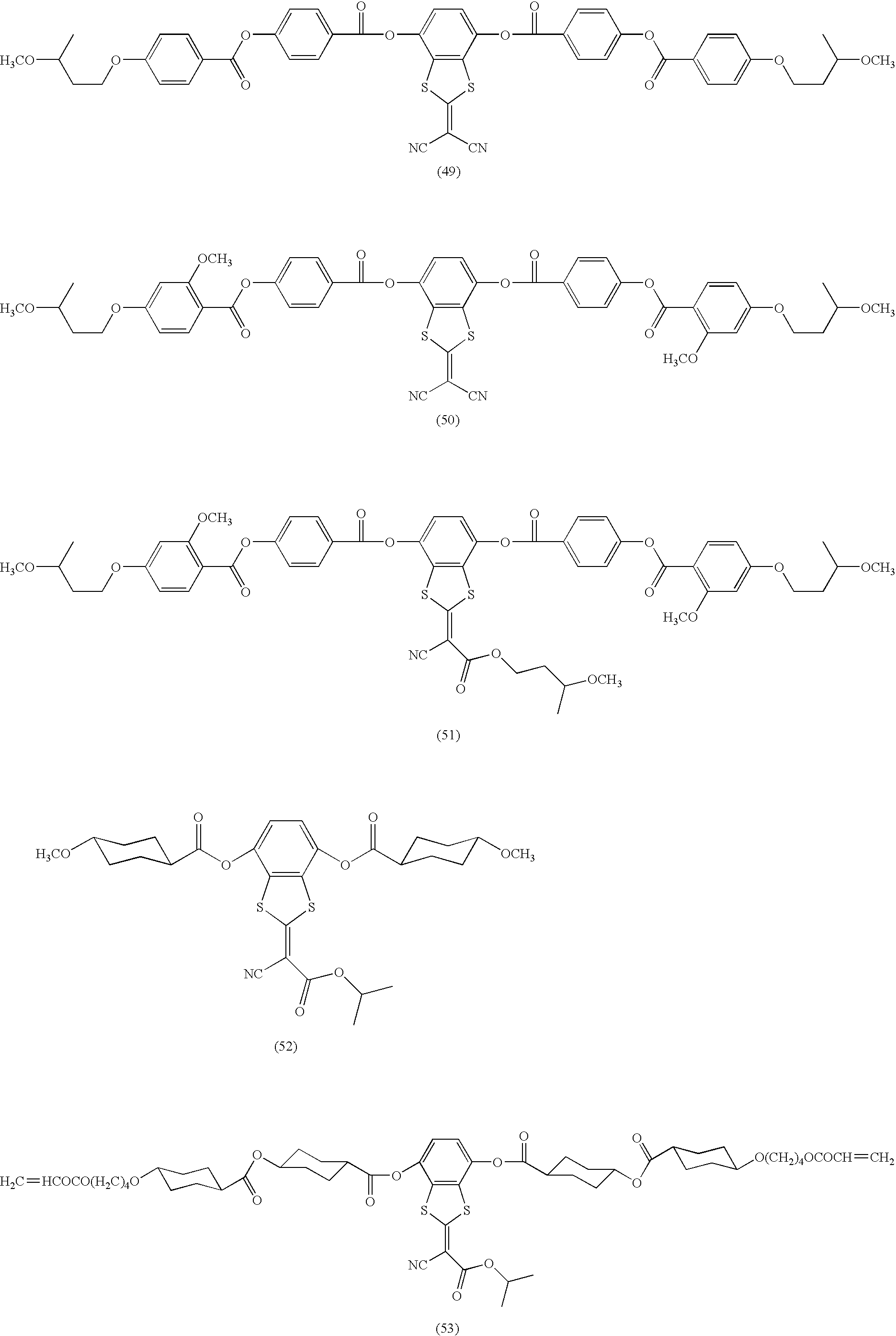

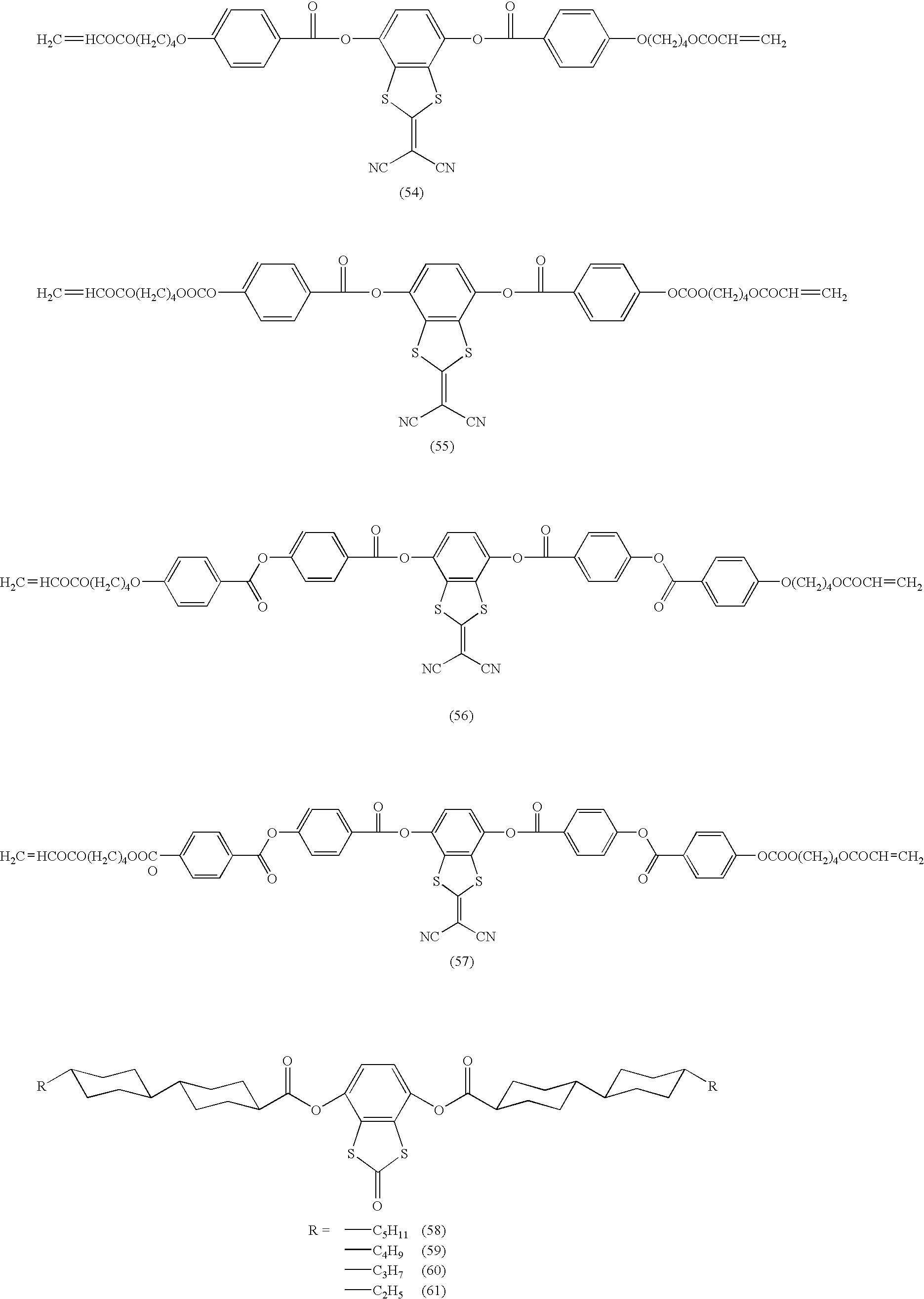

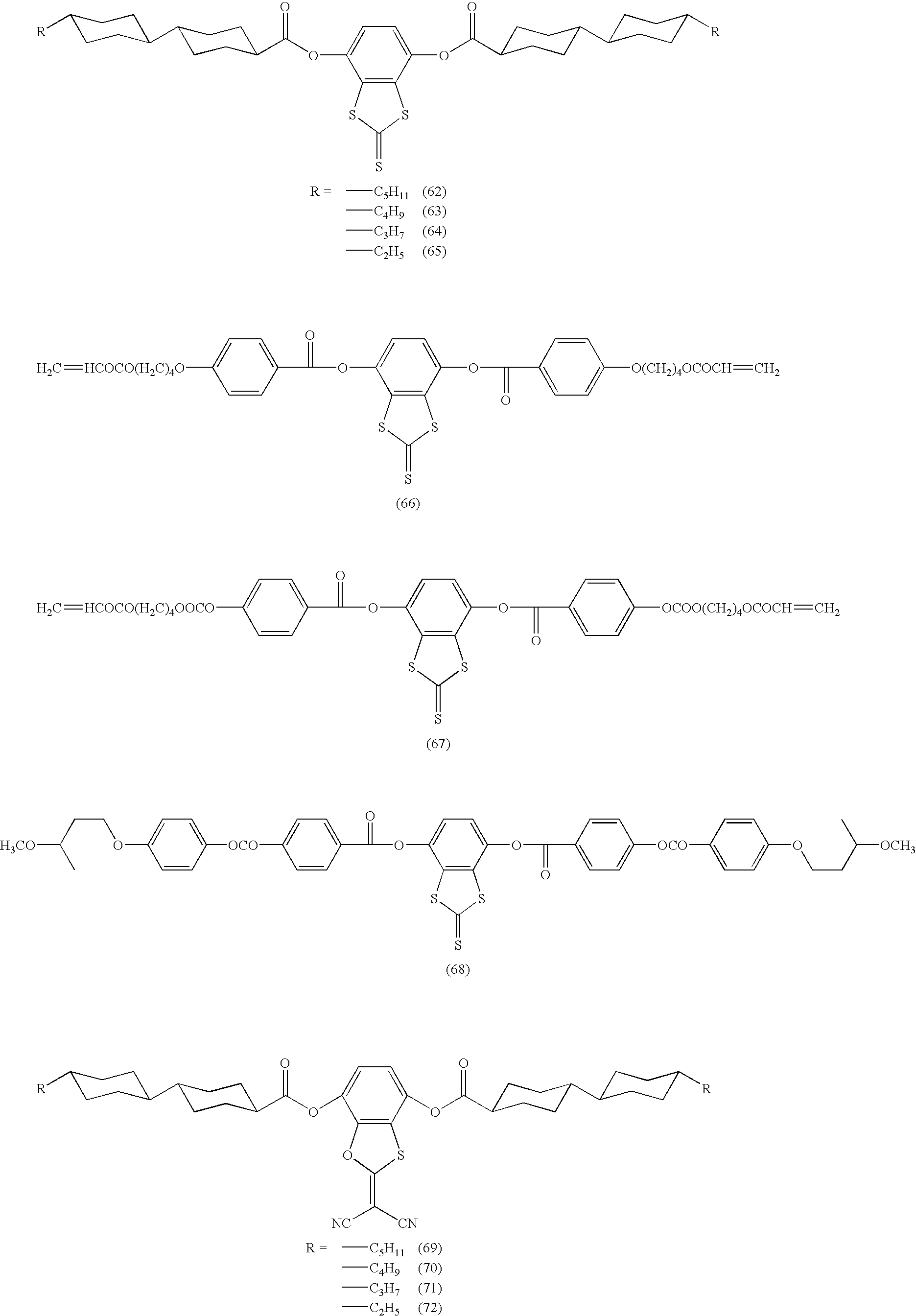

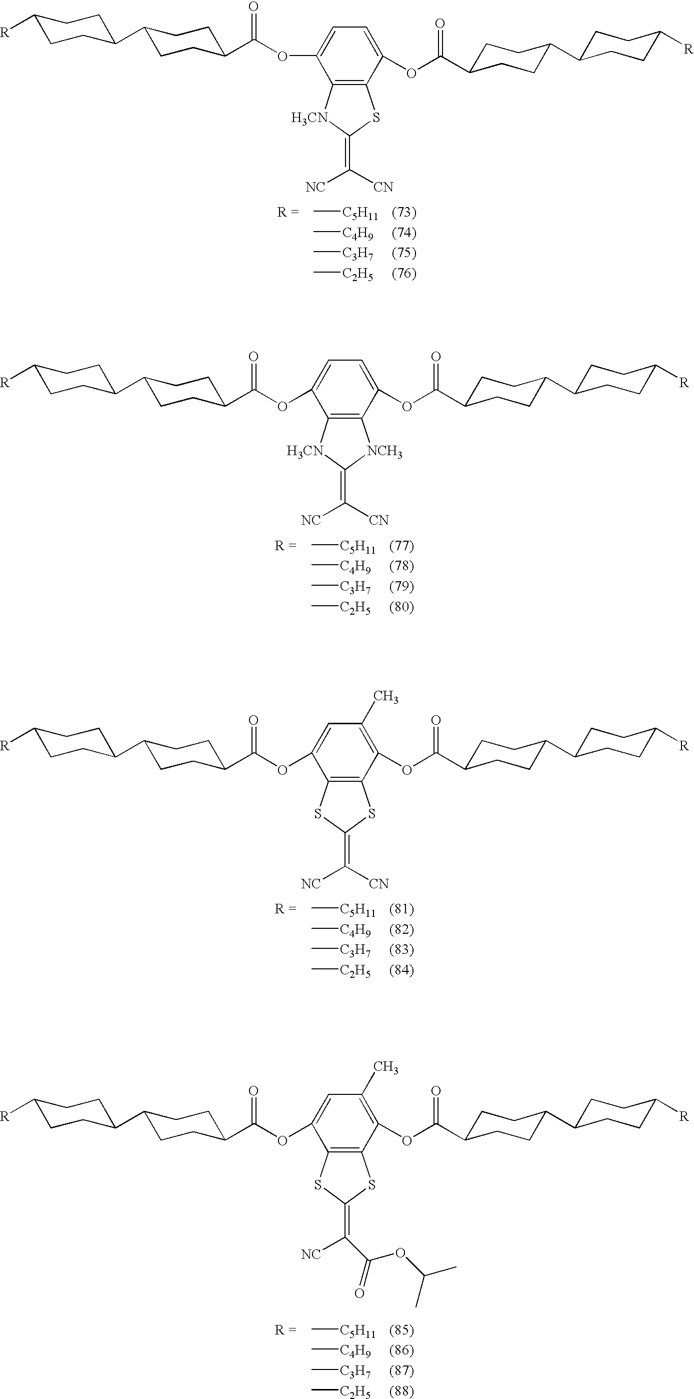

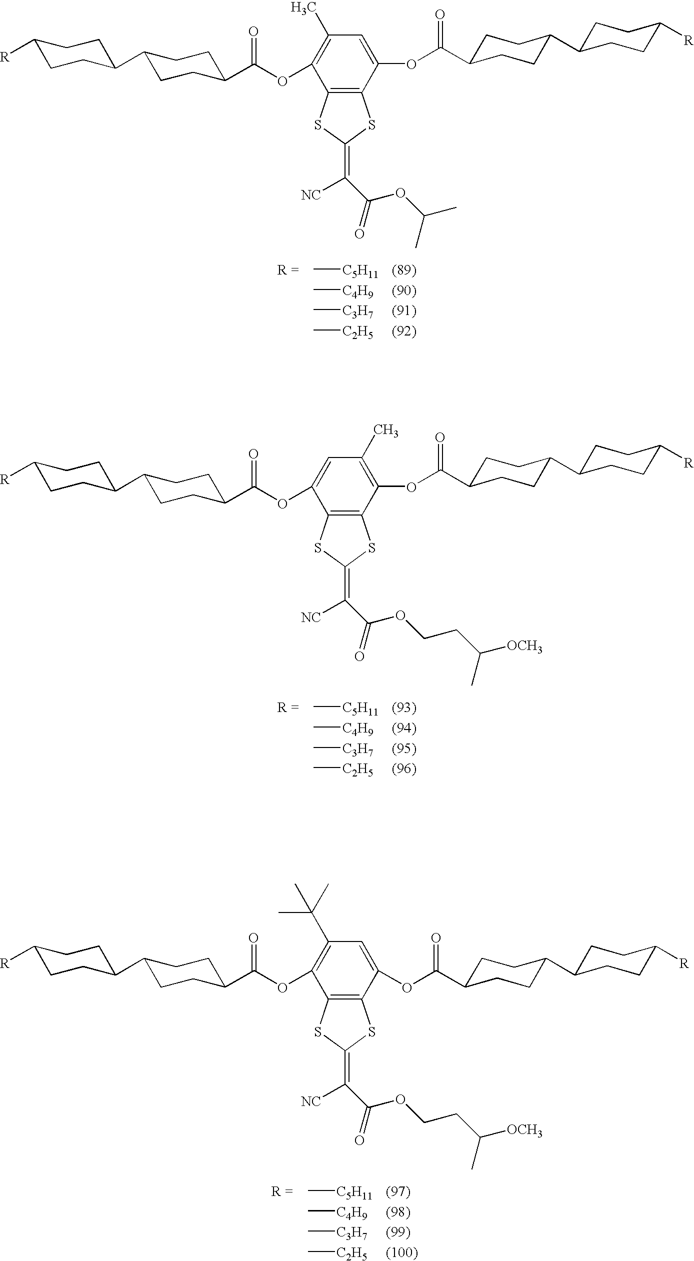

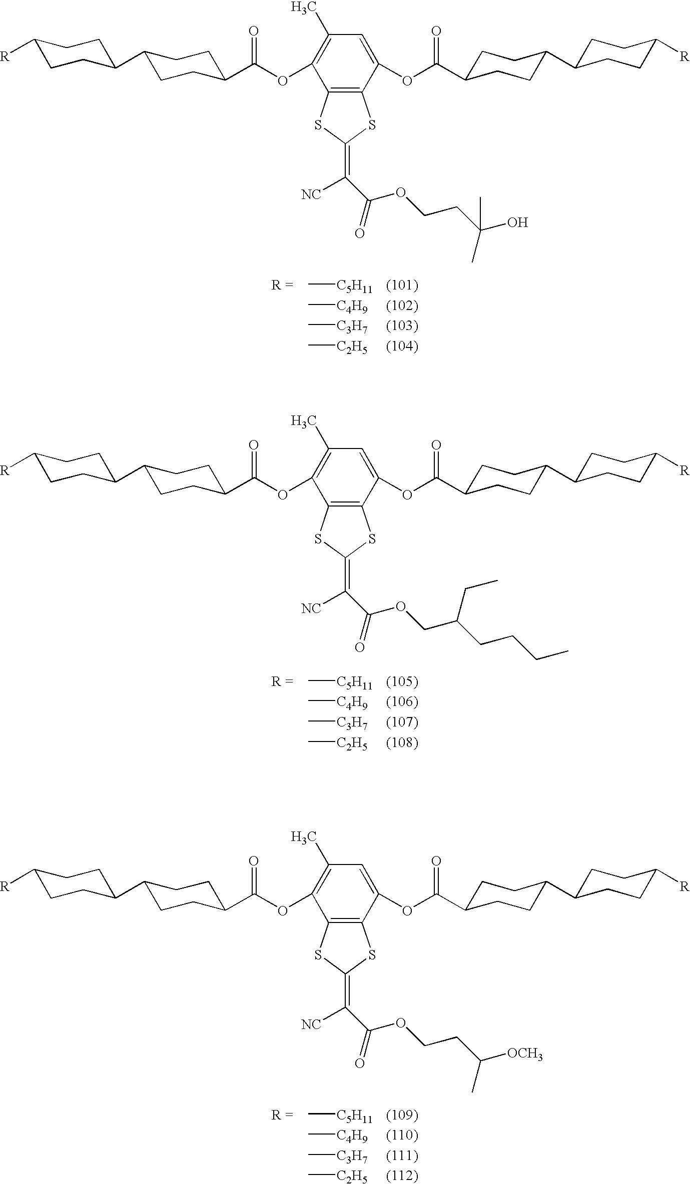

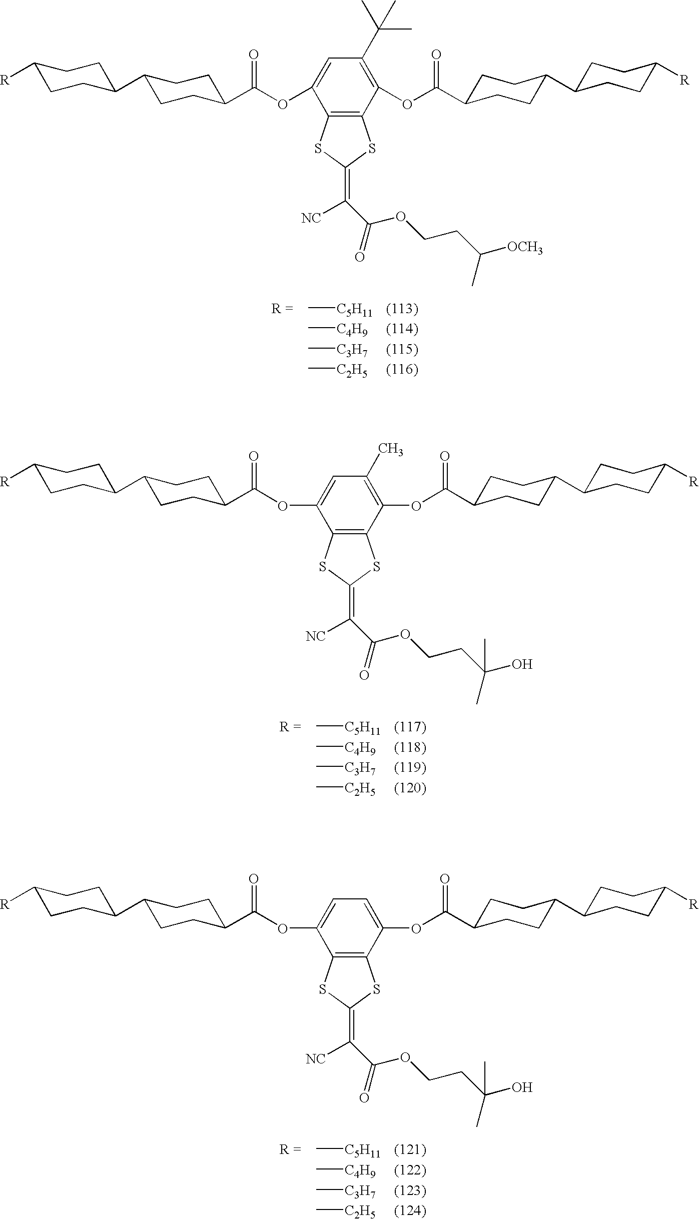

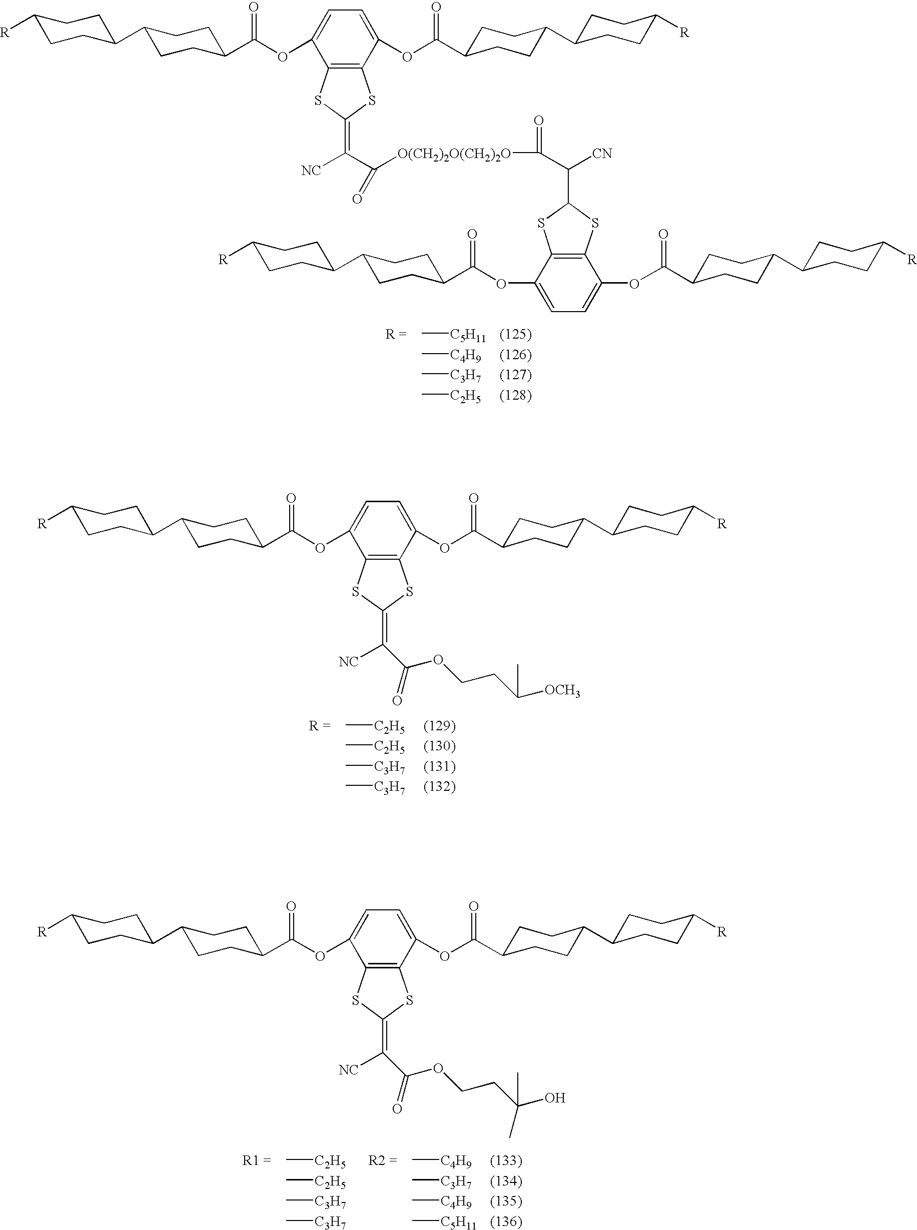

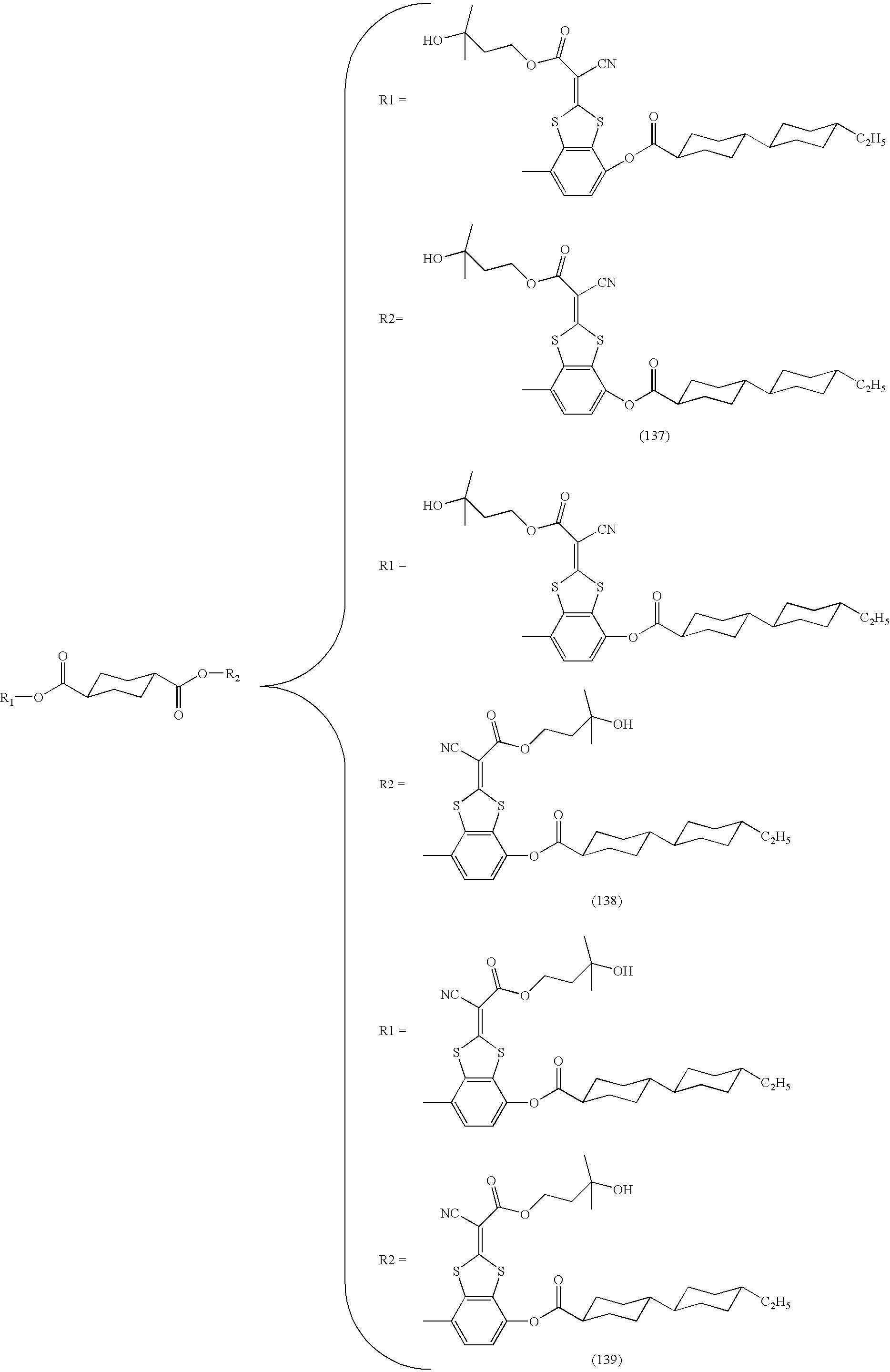

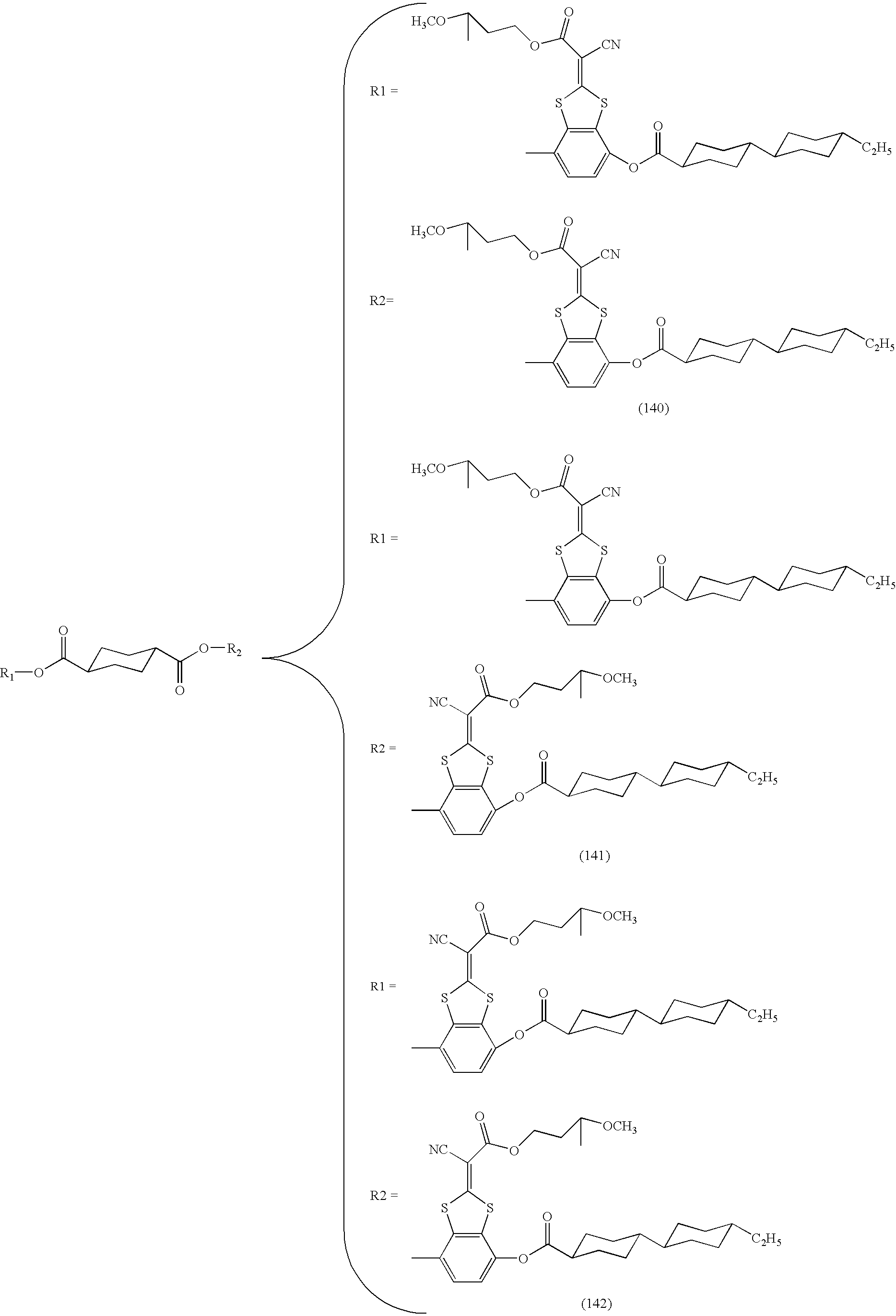

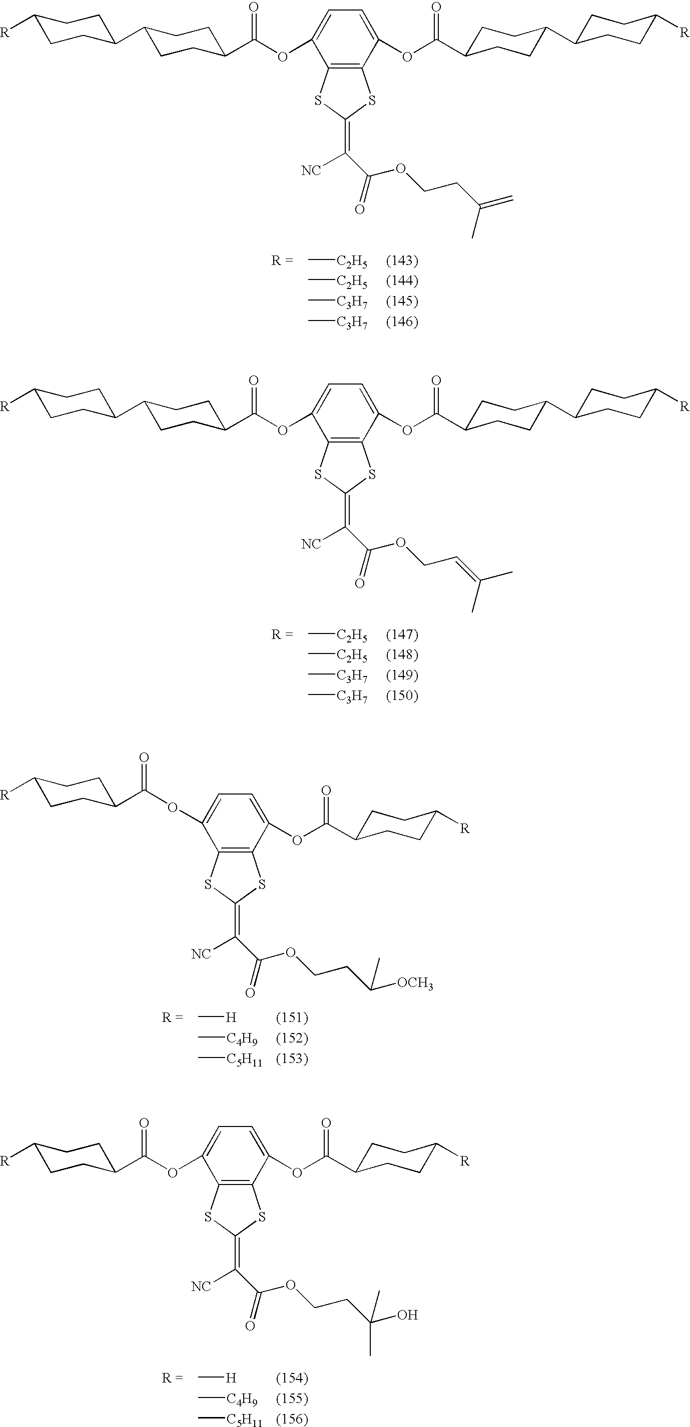

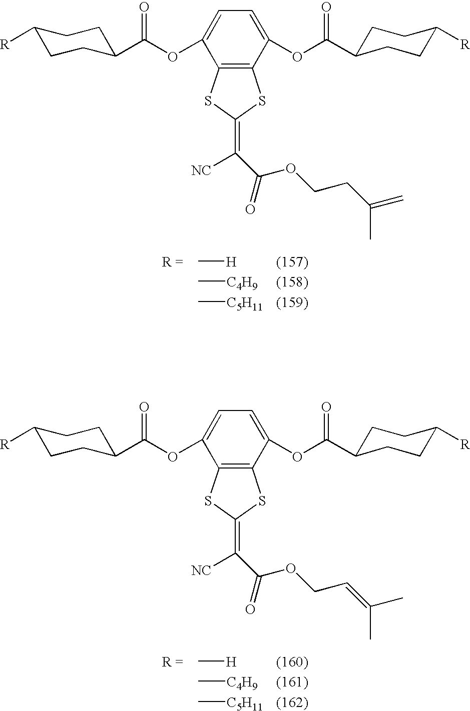

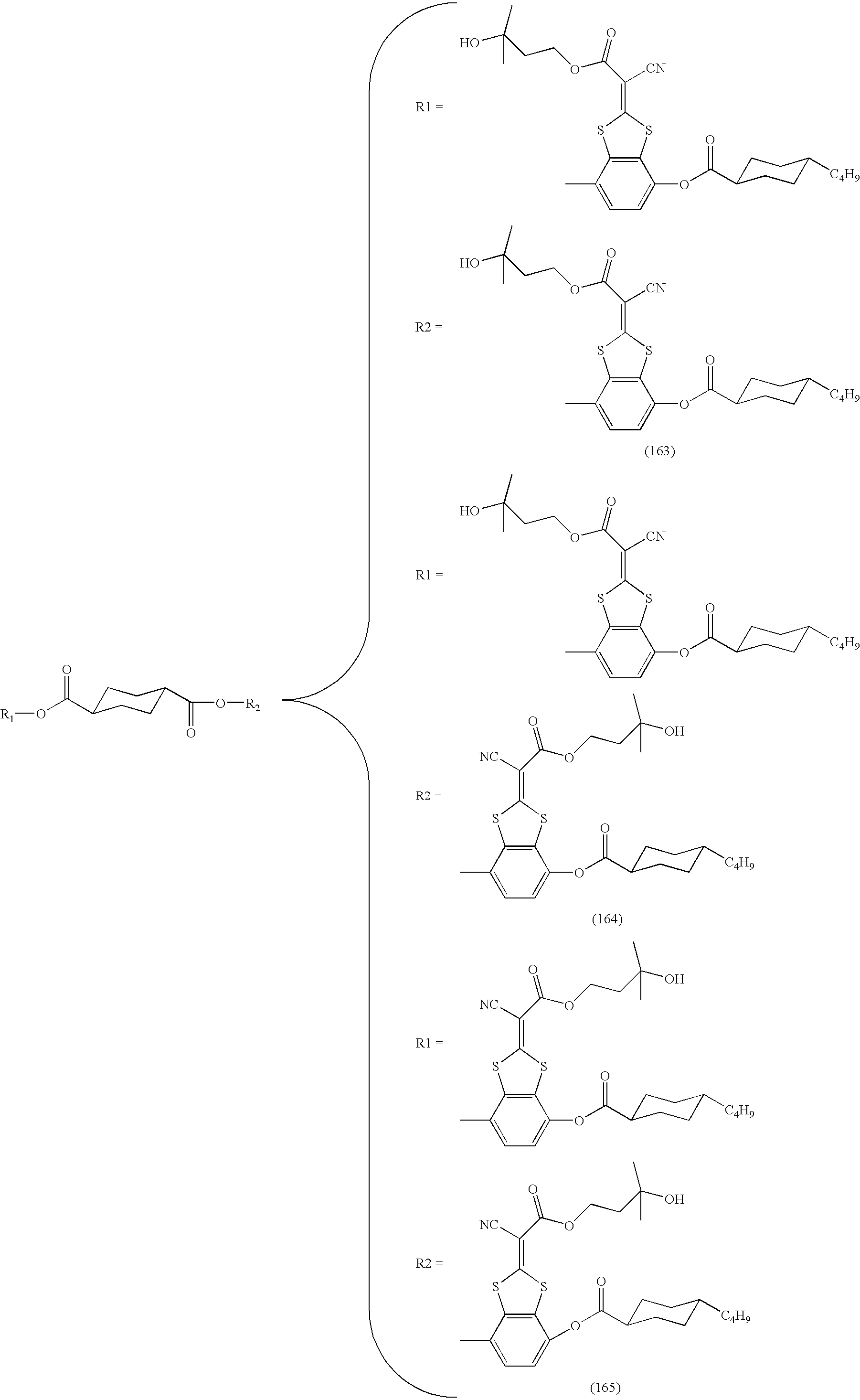

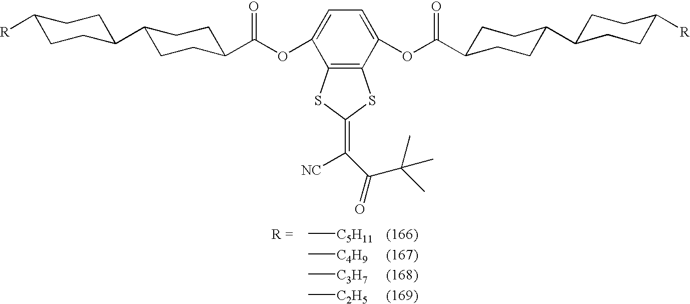

In the invention, the addition amount of the compound that is represented by formula (V) or (VI) is preferably 0.1 to 20% by mass relative to cellulose acylate, more preferably 1 to 15% by mass, further preferably 2 to 12% by mass, most preferably 3 to 10% by mass.

The compound that is represented by the formula (V) or (VI) can be synthesized with reference to known methods.

For example, the exemplified compound (I) can be synthesized according to the following scheme.

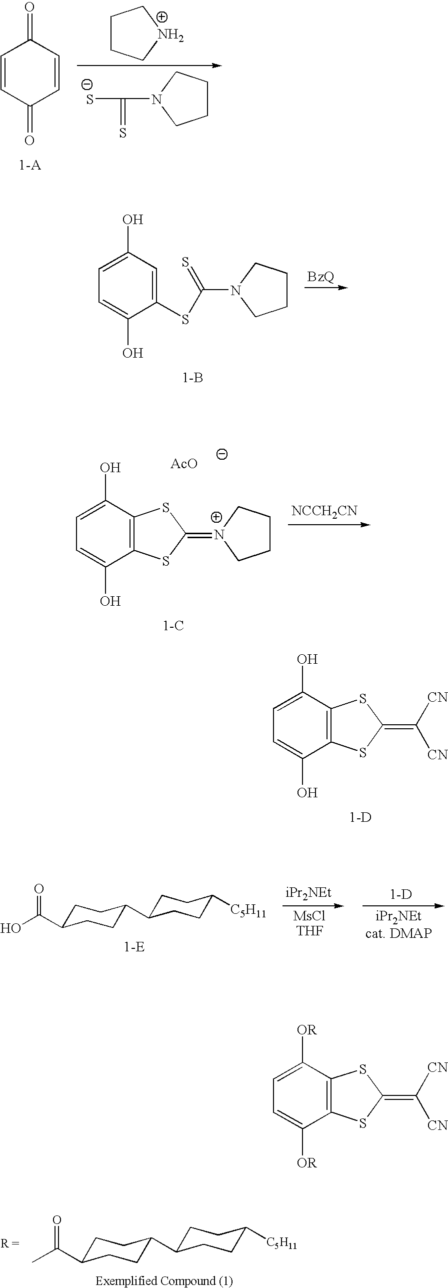

In the scheme, the compound (1-A) to compound (1-D) can be synthesized with reference to the method described in “Journal of Chemical Crystallography” (1997); 27(9); p. 515-526.

Further, as shown in the scheme, the exemplified compound (I) can be obtained by adding, to a tetrahydrofuran solution of compound (1-E), methane sulfonic acid chloride, dropping and stirring N,N-diisopropylethylamine, further adding N,N-diisopropylethylamine, dropping a tetrahydrofuran solution of compound (1-D), and then dropping a tetrahydrofuran solution of N,N-dimethylaminopyridine (DMAP).

The compound that is represented by the formula (V) or (VI) acts as a retardation-controlling agent (especially, a retardation-raising and wavelength dispersion-controlling agent) of an optical film. Especially it acts favorably as a retardation-controlling agent for obtaining a film that is excellent in Re-developing property and wavelength dispersion by stretching.

The molecular weight of the retardation-developing agent in the invention is preferably 200 to 1,000, more preferably 300 to 850. The molecular weight within this range allows both the solubility in a solvent and retention during film forming to be satisfied. The boiling point of the compound in the invention is preferably 260° C. or higher. The boiling point can be measured with a commercially available measuring apparatus (e.g., TG/DTA100, by Seiko Instruments).

The compounds that are represented by formulae (I) to (VI) may be used either singly or in a mixture of two or more types. In the invention, the use of compounds that are represented by formulae (I) to (VI) in combination is also preferred. The addition amount of the retardation-developing agent in the invention is 2 to 30% by mass relative to 100 parts by mass of cellulose acylate, preferably 3 to 25% by mass, more preferably 5 to 20% by mass. The retardation-developing agent in the invention may be added to the cellulose acylate solution (dope) after having been dissolved in such an organic solvent as alcohol, methylene chloride or dioxolan, or it may be added directly to the dope composition.

### [Production of Stretched Cellulose Acylate Film]

The stretched cellulose acylate film of the invention can be film-formed in the same method as that for film-forming the forward wavelength dispersion cellulose acylate film.

### [Stretching Treatment]

The stretching of the cellulose acylate film is carried out preferably in both width and longer directions. The method for stretching a film in the width direction is described in, for example, JP-A-62-115035, JP-A-4-152125, JPA-4-284211, JP-A-4-298310 and JP-A-11-48271.

A film is stretched under the condition of ordinary temperature or heating. The heating temperature is preferably the glass transition temperature of the film or lower. The film can be stretched by a treatment during drying, which is effective, in particular, when a solvent remains. In case of stretching in a longer direction, for example, a film is stretched while setting the winding rate of the film to greater than the peeling rate of the film by adjusting the rate of transfer rolls for the film. In case of the width direction stretching, a film can be stretched by transferring the film while keeping the width of the film with a tenter, and broadening gradually the width between tenters. It is also possible to stretch a film with a stretching machine (preferably a uniaxial stretching with a Long stretching machine) after drying a film.

The stretching ratio (stretched rate relative to a film before the stretching) is preferably 1% to 200%, further preferably 5% to 150%. In particular, the stretching in the width direction by 1% to 200% is preferred, and by 5% to 150% is more preferred. The stretching velocity is preferably 1%/min to 100%/min, further preferably 5%/min to 80%/min, most preferably 10%/min to 60%/min.

The stretched cellulose acylate film of the invention is produced, after being stretched to the maximum stretching ratio, preferably via a process of being held at a lower stretching ratio than the maximum stretching ratio for a certain period of time (hereinafter, a relaxation process). The stretching ratio in the relaxation process is preferably 50% to 99% of the maximum stretching ratio, further preferably 70% to 97%, most preferably 90% to 95%. The period of the relaxation process is preferably 1 sec to 120 sec, further preferably 5 sec to 100 sec.

The stretching ratio and the period in the relaxation process that are set within the above-described range make it possible to improve the alignment degree of the retardation developing agent, and to give a cellulose acylate film having a high retardation and a small retardation variation in the front and thickness direction.

### [Saponification Treatment]

The stretched cellulose acylate film of the invention is preferably subjected to saponification treatment in the same way as that for the forward wavelength dispersion cellulose acylate film and used as a polarizing plate protective film.

The optical compensatory film that satisfies the aforementioned formulae (4) to (5) and is used for the liquid crystal display device of the invention satisfies preferably the relation of the following formulae (6) to (7).

0.5<Re(446)/Re(548)<1.0 (6)

1.0<Re(628)/Re(548)<2.0 (7)

In the formula (6), Re(446)/Re(548) is further preferably 0.55 to 0.95, most preferably 0.6 to 0.90.

In the formula (7), Re(628)/Re(548) is further preferably 1.01 to 1.5, most preferably 1.02 to 1.3.

For the optical compensatory film that satisfies the formulae (4) to (7), a stretched film of polycarbonate resin as described in WO 2003/232060, a stretched film of cycloolefin-based resin as described in JP-A-2006-188671, a stretched film of polyvinyl acetal-based resin as described in JP-A-2006-234878, and a stretched polyimido film and cellulose acylate film as described in JP-A-2006-3715 can be used preferably.

A cellulose acylate film containing the retardation developing agent that is represented by the formula (II) is excellent in processability as a polarizing plate, and can be used especially preferably as the optical compensatory film satisfying the relation of the formulae (4) to (7).

### (VA Mode)

The liquid crystal cell of the liquid crystal display device of the invention is preferably of VA mode. Hereinafter, a VA mode liquid crystal display device is described using FIG. 1.

In a VA mode, liquid crystals having negative dielectric anisotropy and being approximately Δn=0.0813 and Δ∈=−4.6 are used so as to form about 89° of director showing the alignment direction of liquid crystal molecules, that is, a so-called tilt angle by rubbing alignment between upper and lower substrates. In FIG. 1, the thickness d of the liquid crystal layer 7 is set to 3.5 μm. Depending on the magnitude of the product Δn·d of the thickness d and refraction index anisotropy Δn, the brightness at the time of white level varies. Therefore, in order to obtain the maximum brightness, the thickness of the liquid crystal layer is so set that it falls within a range of 0.2 μm to 0.5 μm.

The upside polarizing plate 1 and the downside polarizing plate 12 of the liquid crystal cell are so laminated that the respective absorption axis 2 and absorption axis 13 cross with each other approximately perpendicularly. Inside the respective alignment films of the liquid crystal cell upper electrode substrate 5 and the liquid crystal cell lower electrode substrate 8, transparent electrodes (not shown) are formed. But, in an undriven state where a driving voltage is not applied to electrodes, liquid crystal molecules in the liquid crystal layer 7 are aligned approximately vertically relative to the substrate face, and, as the result, the polarization state of light that passes through the liquid crystal panel shows almost no change. In other words, the liquid crystal display device realizes the ideal black level at the undriven state. On the contrary, in a driven state, liquid crystal molecules are inclined in the direction parallel to the substrate face, and light that passes through the liquid crystal panel changes the polarization state thereof due to such inclined liquid crystal molecules. In other words, the liquid crystal display device gives white level in the driven state. In FIG. 1, numerals 6 and 9 represent the alignment controlling direction.

Here, since an electric field is applied between the upside and downside substrates, such liquid crystal material having negative permittivity anisotropy that the liquid crystal molecule responses in the direction perpendicular to the electric field is used. In case where electrodes are arranged on one of substrates and an electric field is applied in the lateral direction parallel to the substrate, a material having positive permittivity anisotropy is used as the liquid crystal.

In VA mode liquid crystal display devices, a chiral agent, which is used generally in TN mode liquid crystal display devices, is used not so often because it degrades the dynamic response properties, but it is added sometimes in order to reduce alignment failure.

The VA mode has such characteristics as high response and high contrast. However, there is such problem that, although the contrast is high when viewed from the front, it degrades when viewed from oblique directions. At the time of black level, liquid crystal molecules are aligned vertical to the substrate face. When observed from the front, the liquid crystal molecule shows almost no birefringence to give low transmittance and high contrast. However, when observed from an oblique direction, the liquid crystal molecule expresses birefringence. In addition, the crossing angle between the absorption axes of upside and downside polarizing plates is orthogonal, that is, 90° when viewed from the front, but is greater than 900 when viewed from oblique directions. These two factors result in light leakage in oblique directions to lower the contrast. In order to solve the problem, the optical compensatory sheet is arranged.

At the time of white level, liquid crystal molecules are inclined, and, in the inclined direction and the inverse direction, the magnitude of the birefringence of liquid crystal molecules are different from each other when observed from the oblique direction, to give the difference in the brightness and hue. For the purpose of solving the problem, a structure that is referred to as multidomain, in which one pixel of a liquid crystal display device is divided into plural portions, is adopted.

### [Multidomain]

In the VA system, for example, liquid crystal molecules are inclined in different plural portions in one pixel by the application of the electric field to average viewing angle properties. In order to divide the alignment in one pixel, the electrode is provided with a slit or protrusion to change the electric field direction or give deflection to the electric field density. Even viewing angles can be obtained in the all directions by increasing the number of the division, and division into 4, 8 or more can give approximately even viewing angles. In particular, in the case of division into 8, it is possible to set the polarizing plate absorption axis at an arbitrary angle, which is preferred.

On boundary portions of alignment divisions, liquid crystal molecules can not respond easily. Consequently, at the time of normally black display, black level is maintained to result in such trouble as brightness lowering. To solve the problem, it is possible to add a chiral agent to the liquid crystal material to reduce the boundary portions.

Hereinafter, the invention is described more specifically on the basis of Examples. Material, use quantity, percentage, treatment content, treatment procedure and the like that are shown in the following Examples can be arbitrarily changed within a range that does not result in deviation from the purpose of the invention. Accordingly, the scope of the invention should not be construed restrictively by undermentioned specific examples.

### EXAMPLE 1

### Formation of Forward Wavelength Dispersion Film 101

### <Preparation of Cellulose Acylate Solution>

The following composition was thrown into a mixing tank and stirred to dissolve respective ingredients, to prepare a cellulose acylate solution A.

Composition of Cellulose Acylate Solution A

| | |
|---|---|
| Cellulose acetate; acetyl | 100.0 parts by mass |
| substitution degree: 2.94, average | |
| polymerization degree: 310 | |
| Additive D-5 | 12.0 parts by mass |
| Methylene chloride (first solvent) | 402.0 parts by mass |
| Methanol (second solvent) | 60.0 parts by mass |

### <Preparation of Matting Agent Liquid>

The following composition was thrown into a dispersing machine and stirred to dissolve respective soluble ingredients, to prepare a matting agent liquid.

Composition of Matting Agent Liquid

| | |
|---|---|
| Silica particles having an average | 2.0 parts by mass |
| particulate size of 20 nm (AEROSIL | |
| R972, by AEROSIL) | |
| Methylene chloride (first solvent) | 75.0 parts by mass |
| Methanol (second solvent) | 12.7 parts by mass |
| Cellulose acylate solution A | 10.3 parts by mass |

### <Preparation of Wavelength Dispersion-controlling Agent Solution>

The following composition was thrown into a mixing tank and stirred with heating to dissolve respective ingredients, to prepare a wavelength dispersion-controlling agent solution.

Composition of Wavelength Dispersion-Controlling Agent
Solution

| | |
|---|---|
| Wavelength dispersion-controlling | 20.0 parts by mass |
| agent A | |
| Methylene chloride (first solvent) | 58.4 parts by mass |
| Methanol (second solvent) | 8.7 parts by mass |
| Cellulose acylate solution A | 12.8 parts by mass |

Wavelength dispersion-controlling agent A

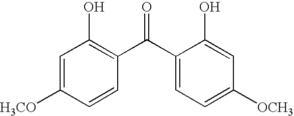

Wavelength dispersion-controlling agent B

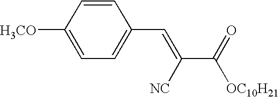

95.7 parts by mass of the cellulose acylate solution A, 1.3 parts by mass of the matting agent liquid, and 3.6 parts by mass of an ultraviolet absorber solution were mixed after filtration, then the mixture was cast with the width of 1600 mm using a band casting machine. The film was peeled off from the band at the residual solvent content of 50% by mass. The film was held with tenter clips and laterally stretched at the stretching ratio of 4% under the condition of 100° C., and dried till the residual solvent content became 5% by mass (drying 1). Further, the film was held at 100° C. for 30 seconds while keeping the width after the stretching. Then, the film was released from the tenter clips. After cutting off each 5% of the film from both ends in the width direction, the film was passed through a drying zone at 135° C. over 20 minutes in a free state (not held) in the width direction (drying 2). Then the film was wound in a roll. The obtained cellulose acylate film had a residual solvent content of 0.1% by mass and a thickness of 81 μm.

### EXAMPLE 2

### Formation of Forward Wavelength Dispersion Films 102 to 106

Forward wavelength dispersion films 102 to 106 were prepared in the same way as described above except for changing the type of cellulose acylate, the type and addition amount of the additive, and the film thickness to the content as listed in Table 1.

### COMPARATIVE EXAMPLE 1

### Formation of Polarizing Plate Protective Films 201 to 202

Polarizing plate protective films 201 to 202 were prepared in the same way as described above except for changing the type of cellulose acylate, the type and addition amount of the additive, and the film thickness to the content as listed in Table 1.

TABLE 1

| | | | | | | | | Wavelength | | | |
|---|---|---|---|---|---|---|---|---|---|---|---|
| | Substitution degree | | | | | | | dispersion- | | | |
| | of cellulose acylate | | | Additive 1 | | Additive 2 | | controlling agent | | | |
| Film | Acetyl | Propionyl | | | Addition | | Addition | | Addition | | |
| No. | group | group | Total | Type | amount^{a)} | Type | amount^{a)} | Type | amount^{a)} | Thickness | Remarks |
| 101 | 2.94 | 0.00 | 2.94 | D-5 | 12 | — | — | A | 3.6 | 80 | Invention |
| 102 | 2.94 | 0.00 | 2.94 | D-5 | 12 | — | — | A | 4.8 | 80 | Invention |
| 103 | 2.94 | 0.00 | 2.94 | D-5 | 12 | — | — | A | 5.6 | 61 | Invention |
| 104 | 1.95 | 0.85 | 2.80 | triphenyl | 8 | biphenyl | — | A | 6.4 | 42 | Invention |
| | | | | phosphate | | phosphate | | | | | |
| 105 | 2.86 | 0.00 | 2.86 | triphenyl | 8 | biphenyl | 4 | A | 2.4 | 72 | Invention |
| | | | | phosphate | | phosphate | | | | | |
| 106 | 2.95 | 0.00 | 2.95 | D-5 | 5.7 | — | — | B | 6.5 | 82 | Invention |
| 201 | 2.86 | 0.00 | 2.86 | triphenyl | 8 | biphenyl | 4 | A | 4.8 | 80 | Comp. |
| | | | | phosphate | | phosphate | | | | | Ex. |
| 202 | 2.86 | 0.00 | 2.86 | triphenyl | 8 | biphenyl | 4 | — | 0 | 82 | Comp. |
| | | | | phosphate | | phosphate | | | | | Ex. |

^{a)}% by mass relative to cellulose acylate

### (Measurement of Optical Properties)

For the forward wavelength dispersion films 102 to 106 of the invention and polarizing plate protective films 201 to 202 of the Comparative Example, measured were respective Re and Rth at 446 nm, 548 nm and 628 nm with “WR KOBRA” by Oji Scientific Instruments under a circumstance of 25° C. and 60% relative humidity. The results are listed in Table 2.

TABLE 2

| | Rth (nm) | | | | | |
|---|---|---|---|---|---|---|
| | Rth | Rth | Rth | Rth (446)/ | Rth (628)/ | |
| Film No. | (446) | (548) | (628) | Rth (548) | Rth (548) | Remarks |
| 101 | 51 | 37 | 36 | 1.35 | 0.97 | Invention |
| 102 | 80 | 58 | 55 | 1.37 | 0.94 | Invention |
| 103 | 75 | 55 | 51 | 1.38 | 0.93 | Invention |
| 104 | 48 | 31 | 28 | 1.54 | 0.89 | Invention |
| 105 | 100 | 88 | 87 | 1.14 | 0.99 | Invention |
| 106 | 110 | 86 | 79 | 1.28 | 0.93 | Invention |
| 201 | 140 | 118 | 115 | 1.18 | 0.97 | Comp. Ex. |
| 202 | 18 | 33 | 40 | 0.55 | 1.20 | Comp. Ex. |

### EXAMPLE 3

### Formation of Optical Compensatory Film 301

### <Preparation of Cellulose Acylate Solution 11>

The following composition was thrown into a mixing tank and stirred to dissolve respective ingredients, to prepare a cellulose acylate solution 11.

Composition of Cellulose Acylate Solution 11

| | |
|---|---|
| Cellulose acetate; acetyl | 100.0 parts by mass |
| substitution degree: 2.80, | |
| polymerization degree: 420 | |
| Triphenyl phosphate (plasticizer) | 6.0 parts by mass |
| Biphenyl phosphate (plasticizer) | 3.0 parts by mass |
| Methylene chloride (first solvent) | 402.0 parts by mass |
| Methanol (second solvent) | 60.0 parts by mass |

### <Preparation of Matting Agent Liquid 12>

The following composition was thrown into a dispersing machine and stirred to dissolve respective soluble ingredients, to prepare a matting agent liquid 12.

Composition of Matting Agent Liquid 12

| | |
|---|---|
| Silica particles having an average | 2.0 parts by mass |
| particulate size of 20 nm (AEROSIL | |
| R972, by Nippon Aerosil Co., Ltd.) | |
| Methylene chloride (first solvent) | 75.0 parts by mass |
| Methanol (second solvent) | 12.7 parts by mass |
| Cellulose acylate solution 11 | 10.3 parts by mass |

### <Preparation of Retardation Developing Agent 13 Solution>

The following composition was thrown into a mixing tank and stirred with heating to dissolve respective ingredients, to prepare a retardation developing agent solution 13.

Composition of Retardation Developing Agent Solution 13

| | |
|---|---|
| Retardation developing agent (I-(2)) | 20.0 parts by mass |
| Methylene chloride (first solvent) | 67.2 parts by mass |
| Methanol (second solvent) | 10.0 parts by mass |
| Cellulose acylate solution 11 | 12.8 parts by mass |

1.3 parts by mass of the matting agent liquid 12 and 6.0 parts by mass of the retardation developing agent solution 13 were mixed using an in-line mixer after the filtration thereof, to which 92.7 parts by mass of the cellulose acylate solution 11 was added further and mixed using the in-line mixer. Then, the mixed liquid was cast using a band casting machine, dried to the residual solvent content of 40% at 100° C. and then the film was peeled off. The film having a residual solvent content of 15% was laterally stretched at a stretching ratio of 25% with a tenter at an atmospheric temperature of 140° C., which was then held at 140° C. for 30 seconds. The residual solvent content was 10% at the start of the stretching. After that, clips were released and the film was dried at 130° C. for 40 minutes to produce an optical compensatory film 301. The produced optical compensatory film 301 had a residual solvent content of 0.1% and a thickness of 82 μm. Re(548) was 55 nm, and Rth(548) was 198 nm when being measured with WR KOBRA.

### EXAMPLE 4

### Formation of Optical Compensatory Film 302

A commercially available ZEONOR film (by Zeon Corp.) was stretched in the lengthwise direction by 15% and in the lateral direction by 35% at 140° C. to give an optical compensatory film 302 having a thickness of 69 μm. Re(548) was 62 nm, and Rth(548) was 220 nm when being measured with WR KOBRA.

### EXAMPLE 5

### Formation of Optical Compensatory Film 303

A solution that was prepared by dissolving polyimide, which had been synthesized from 2,2′-bis(3,4-dicarboxyphenyl)hexafluoropropane (generally corresponds to 6FDA) and 2,2′-bis(trifluoromethyl)-4,4′-diaminobiphenyl (generally corresponds to PFMB, TFMB), in cyclohexanone as a solvent in 15% by mass was coated on a triacetyl cellulose film having a thickness of 80 μm. After that, by carrying out drying treatment at 100° C. for 10 minutes, a thin film having a residual solvent content of 7% and a thickness of 5 μm was obtained. Then, the thin film having been formed on a triacetyl cellulose film was subjected to longitudinal uniaxial stretching by 6% along with the base material at 160° C. to form an optical compensatory film 303. Re(548) was 68 nm and Rth(548) was 250 nm when being measured with WR KOBRA.

### EXAMPLE 6

### Formation of Optical Compensatory Film 304

A commercially available ARTON film by JSR was stretched in the lengthwise direction by 20% and in the lateral direction by 30% at 170° C. to give an optical compensatory film 304 having a thickness of 81 μm. Re(548) was 59 nm, and Rth(548) was 210 nm when being measured with WR KOBRA.

### EXAMPLE 7

### Formation of Optical Compensatory Film 305

A dope prepared by dissolving APPEAR 3000 by PROMERUS in a mixed solvent of methylene chloride/methanol (weight ratio: 92/8) was cast on a support. The obtained film was stretched in the lateral direction by 15% at 150° C. to give an optical compensatory film 305 having a thickness of 50 μm. Re(548) was 53 nm, and Rth(548) was 225 nm when being measured with WR KOBRA.

### EXAMPLE 8

### Formation of Optical Compensatory Film 306

### <Preparation of Cellulose Acylate Solution 21>

The following composition was thrown into a mixing tank and stirred to dissolve respective ingredients, to prepare a cellulose acylate solution 21.

Composition of Cellulose Acylate Solution 21

| | |
|---|---|
| Cellulose acetate; | 100.0 parts by mass |
| acetyl substitution degree: 2.90, | |
| polymerization degree: 390 | |
| Triphenyl phosphate (plasticizer) | 8.0 parts by mass |
| Biphenyl phosphate (plasticizer) | 4.0 parts by mass |
| Methylene chloride (first solvent) | 402.0 parts by mass |
| Methanol (second solvent) | 60.0 parts by mass |

### <Preparation of Matting Agent Liquid 22>

The following composition was thrown into a dispersing machine and stirrer to dissolve soluble ingredients, to prepare a matting agent liquid 22.

Composition of Matting Agent Liquid 22

| | |
|---|---|
| Silica particles having an average | 2.0 parts by mass |
| particulate size of 20 nm (AEROSIL | |
| R972, by Nippon Aerosil Co., Ltd.) | |
| Methylene chloride (first solvent) | 76.3 parts by mass |
| Methanol (second solvent) | 11.4 parts by mass |
| Cellulose acylate solution 21 | 10.3 parts by mass |

### <Preparation of Retardation Developing Agent 23 Solution>

The following composition was thrown into a mixing tank and stirred with heating to dissolve respective ingredients, to prepare a retardation developing agent solution 23.

Composition of Retardation Developing Agent Solution 23

| | |
|---|---|
| Retardation developing agent (I-(2)) | 4.0 parts by mass |
| Retardation developing agent (124) | 16.0 parts by mass |
| Methylene chloride (first solvent) | 67.2 parts by mass |
| Methanol (second solvent) | 10.0 parts by mass |
| Cellulose acylate solution 21 | 12.8 parts by mass |

1.3 parts by mass of the matting agent liquid 22 and 8.1 parts by mass of the retardation developing agent solution 23 were mixed using an in-line mixer after the filtration thereof, to which 90.6 parts by mass of the cellulose acylate solution 11 was added further and mixed using the in-line mixer. Then, the mixed liquid was cast using a band casting machine, dried to the residual solvent content of 35% at 100° C. and then the film was peeled off. The film was laterally stretched at a stretching ratio of 25% with a tenter at an atmospheric temperature of 150° C., which was then held at 150° C. for 30 seconds. The residual solvent content was 10% at the start of the stretching. After that, clips were released and the film was dried at 130° C. for 40 minutes to produce an optical compensatory film 306. The produced optical compensatory film 306 had a residual solvent content of 0.1% and a thickness of 80 μm. Re(548) was 100 nm, and Rth(548) was 120 nm when being measured with WR KOBRA.

Re and Rth that are measured for the optical compensatory films 301 to 306 at wavelengths of 446 nm, 548 nm, 628 nm are listed in Table 3.

TABLE 3

| | Re (nm) | | | | | Rth (nm) | | | | |
|---|---|---|---|---|---|---|---|---|---|---|
| Film | | | | Re (446)/ | Re (628)/ | | | | Rth (446)/ | Rth (628)/ |
| No. | Re (446) | Re (548) | Re (628) | Re (548) | Re (548) | Rth (446) | Rth (548) | Rth (628) | Rth (548) | Rth (548) |
| 301 | 72 | 68 | 67 | 1.06 | 0.99 | 258 | 250 | 247 | 1.03 | 0.99 |
| 302 | 62 | 62 | 62 | 1.00 | 1.00 | 221 | 220 | 220 | 1.00 | 1.00 |
| 303 | 74 | 68 | 66 | 1.09 | 0.97 | 256 | 250 | 249 | 1.02 | 1.00 |
| 304 | 60 | 59 | 59 | 1.02 | 1.00 | 211 | 210 | 210 | 1.00 | 1.00 |
| 305 | 54 | 53 | 53 | 1.02 | 1.00 | 226 | 225 | 225 | 1.00 | 1.00 |
| 306 | 86 | 100 | 106 | 0.86 | 1.06 | 96 | 120 | 128 | 0.80 | 1.07 |

### EXAMPLE 6

### Saponification Treatment of Forward Wavelength Dispersion Film 101

The formed forward wavelength dispersion film 101 was dipped in a 2.3 mol/L aqueous solution of sodium hydroxide at 55° C. for 3 minutes, which was washed in a water washing bath at room temperature and then neutralized with 0.05 mol/L sulfuric acid at 30° C. It was washed again in a water washing bath at room temperature and dried with hot air at 100° C. Thus, the surface of the forward wavelength dispersion film 101 was saponified.

### (Saponification Treatment of Forward Wavelength Dispersion Films 102 to 105, Optical Compensatory Films 301, 303, 306)

In the same was as described for the forward wavelength dispersion film 101, each of the surface of cellulose acylate of forward wavelength dispersion films 102 to 106, optical compensatory films 301, 303, and 306 was saponified.

### EXAMPLE 7

### Formation of Polarizing Plate 101

### (Saponification Treatment of Polarizing Plate Protective Film)

A commercially available cellulose acetate film (FUJITAC TD80, by Fuji Film) was dipped in a 1.5 mol/L aqueous solution of sodium hydroxide at 55° C. for 1 minute, which was washed in a water washing bath at room temperature and then neutralized with 0.05 mol/L sulfuric acid at 30° C. It was washed again in a water washing bath at room temperature and dried with hot air at 100° C.

### (Formation of Polarizer)

To a stretched polyvinyl alcohol film, iodine was adsorbed to form a polarizer. On one side of the polarizer, the forward wavelength dispersion film 101 that had been saponified as described above was adhered with a polyvinyl alcohol-based adhesive. The absorption axis of the polarizer and the slow axis of the cellulose acylate film were so arranged that they were parallel to each other.

Further, the commercially available cellulose triacetate film that had been saponified as described above was adhered on the other side with a polyvinyl alcohol-based adhesive to form a polarizing plate 101.

### EXAMPLE 8

### Formation of Polarizing Plates 102 to 106

Forward wavelength dispersion films 102 to 106 were treated in the same way as in Example 7 to form polarizing plates 102 to 106.

### <Formation of Polarizing Plate 301, 303, 306>

Polarizing plates 301, 303 and 306 were also formed using optical compensatory films 301, 303 and 306 in the same way as in Example 7 except for so arranging that the slow axis of the optical compensatory film and the transmission axis of the polarizer was parallel to each other. Here, for the polarizing plate 303, it was so adhered that the cellulose acetate film side thereof faced to the polarizer.

### EXAMPLE 9

### Surface Treatment of Optical Compensatory Film 302

The surface of the optical compensatory film 302 was subjected to corona discharge treatment under a condition of 12 W·min/m² with a machine by KASUGA ELECTRIC WORKS to be made hydrophilic. Optical compensatory films 304 and 305 were also subjected to the same treatment as that for the optical compensatory film 302 to be made hydrophilic.

### (Preparation of Adhesive)

10 parts of polyester-based urethane (TAKELAC XW-74-C154, by MITSUI TAKEDA CHEMICALS INC.) and 1 part of isocyanate-based linking agent (TAKENATE WD-725, by MITSUI TAKEDA CHEMICALS INC.) were dissolved in water to prepare a solution having an adjusted solid content of 20%. The solution was used as an adhesive.

On the optical compensatory film 302 having been surface treated as described above, the adhesive solution was coated, to which the saponified commercially available cellulose triacetate film (FUJITAC TD80, by FUJJI FILM) having been formed in Example 7 was stuck so as to interpose the polarizer between these, which was dry-cured in an oven at 40° C. for 72 hours, to form a polarizing plate 302.

Optical compensatory films 304 and 305 were subjected to the same treatment to form polarizing plates 304 and 305.

### COMPARATIVE EXAMPLE 2

### Formation of Polarizing Plates 201 and 202

Polarizing plate protective films 201 and 202 having been formed in Comparative Example 1 were treated in the same was as in Example 7 to form polarizing plates 201 and 202.

### (Formation of Liquid Crystal Display Device)

In FIG. 1, to a VA mode liquid crystal cell, the polarizing plate 101 was stuck as the upside polarizing plate 1 in FIG. 1 so that the forward wavelength dispersion film 101 in the invention lay on the liquid crystal cell side, and the polarizing plate 301 was stuck as the downside polarizing plate 12 so that the optical compensatory film 301 lay on the liquid crystal cell side via an adhesive, each one on the viewer side and the backlight side. They were arrange in crossed Nichols so that the transmission axis of the viewer side polarizing plate lay in the vertical direction and the transmission axis of the backlight side polarizing plate lay in the horizontal direction. Thus, a liquid crystal display device (A) was formed.

Further, the upside polarizing plate and the downside polarizing plate were changed according to the content in the following Table 4 to form liquid crystal display devices (A) to (G), (J) to (O) of the invention and liquid crystal display devices (H) to (I) of Comparative Examples. (Change in Hue Depending on Viewing Angle)

For liquid crystal display devices (A) to (O) that were formed as above, at a polar angle of 60°, the hue at azimuthal angle of 0° and at an azimuthal angle of 80° was measured by Ezcontrast by ELDIM, and the absolute value Δx, Δy of the hue change on the xy chromaticity diagram was obtained. The evaluation results on the basis of the following standard is listed in Table 4.

OO: the difference between values at the azimuthal angle of 0° and the azimuthal angle of 80° is less than 0.015 for both u′, v′
O: the difference between values at the azimuthal angle of 0° and the azimuthal angle of 80° is less than 0.020 for both u′, v′
Δ: the difference between values at the azimuthal angle of 0° and the azimuthal angle of 80° is less than 0.025 for both u′, v′
x: the difference between values at the azimuthal angle of 0° and the azimuthal angle of 80° is 0.25 or more for at least one of u′, v′

TABLE 4

| Liquid | | | | |
|---|---|---|---|---|
| crystal | Upperside | Lowerside | | |
| display | polarizing | polarizing | Hue | |
| device | plate | plate | change | Remarks |
| A | 101 | 301 | ◯ | Invention |
| B | 102 | 301 | ◯ | Invention |
| C | 103 | 301 | ◯ | Invention |
| D | 104 | 301 | ◯ | Invention |
| E | 105 | 301 | Δ | Invention |
| F | 102 | 302 | ◯ | Invention |
| G | 102 | 303 | ◯ | Invention |
| H | 201 | 301 | X | Comp. Ex. |
| I | 202 | 301 | X | Comp. Ex. |
| J | 106 | 301 | ◯ | Invention |
| K | 106 | 302 | ◯ | Invention |
| L | 106 | 303 | ◯ | Invention |
| M | 106 | 304 | ◯ | Invention |
| N | 106 | 305 | ◯ | Invention |
| O | 106 | 306 | ◯◯ | Invention |

From the result listed in Table 4, it is recognized that liquid crystal display devices (A) to (G), (J) to (O) of the invention have less hue change that depends on the viewing angle and are preferred compared with the liquid crystal display devices (H), (I) of the comparative examples.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 092082/2006 filed on Mar. 29, 2006 and Japanese Patent Application No. 341723/2006 filed on Dec. 19, 2006, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A polymer film having Rth that satisfies the following formulae (1) to (3):
20 nm≦Rth(548)<100 nm (1)
1.0<Rth(446)/Rth(548)<4.0 (2)
0.5<Rth(628)/Rth(548)<1.0 (3)
wherein Rth(λ) represents the value of Rth that is measured at a wavelength of λ nm.

2. The polymer film according to claim 1, comprising mainly cellulose acylate.

3. The polymer film according to claim 1, comprising a wavelength dispersion-controlling agent having the absorption maximum within a wavelength range of 250 nm to 400 nm in 1% by mass to 30% by mass.

4. The polymer film according to claim 1, comprising at least one compound represented by the following formula (B): 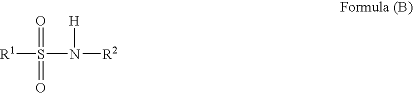
wherein R¹ and R² each independently represents an alkyl group or an aryl group.

5. The polymer film according to claim 2, comprising mainly cellulose acylate having an acetyl substitution degree of 2.90 to 3.00.

6. The polymer film according to claim 1, comprising mainly mixed aliphatic acid ester having a total acyl substitution degree of 2.70 to 3.00.

7. A polarizing plate protective film comprising the polymer film according to claim 1.

8. A polarizing plate comprising a polarizer and a protective film that is disposed on at least one side of the polarizer, wherein the protective film is the polarizing plate protective film according to claim 7.

9. A liquid crystal display device comprising a liquid crystal cell and the polarizing plate according to claim 8.

10. The liquid crystal display device according to claim 9, comprising a liquid crystal cell, two polarizing plates that are disposed on both sides of the liquid crystal cell and an optical compensatory film that is interposed at least one of the interfaces between the polarizing plate and the liquid crystal cell, wherein:
the polarizing plate is composed of a polarizer and two protective films that are disposed on both sides thereof; at least one of the protective films lying on the nearer side to the liquid crystal cell is the polymer film satisfying the formulae (1) to (3); and the optical compensatory film satisfies following formulae (4) and (5):
20 nm≦Re(548)≦150 nm (4)
100 nm≦Rth(548)≦400 nm (5).

11. The liquid crystal display device according to claim 10, wherein the optical compensatory film that satisfies the above formulae (4) and (5) satisfies the following formulae (6) and (7):
0.5<Re(446)/Re(548)<1.0 (6)
1.0<Re(628)/Re(548)<2.0 (7)

12. The liquid crystal display device according to claim 10, wherein the optical compensatory film that satisfies above formulae (4) and (5) comprises at least one of cellulose acylate-based resin, polycarbonate-based resin, polyimide-based resin, polyether ketone-based resin, polycycloolefin-based resin and polyvinyl acetal-based resin.

13. The liquid crystal display device according to claim 9, wherein the liquid crystal cell is of the VA mode.
